(19) United States
(12) Patent Application Publication
(10) Pub. No.: US 2014/0311356 A1
(43) Pub. Date: Oct. 23, 2014

(54) Multi-Configurable Outdoor Cooking Grill

(71) Applicant: John James Daniels, Madison, CT (US)

(72) Inventor: John James Daniels, Madison, CT (US)

(21) Appl. No.: 14/130,907

(22) PCT Filed: Jul. 7, 2012
(86) PCT No.: PCT/US2012/045877

§ 371 Date: Jan. 3, 2014

Related U.S. Application Data
(60) Provisional application No. 61/505,333, filed on Jul. 7, 2011.

(51) Int. Cl. A47J 37/07

(52) U.S. Cl. CPC A47J 37/0786
USPC 99/340

(57) ABSTRACT

A multi-configurable cooking grill is provided comprising a burner assembly, an interchangeable cooking surface, a top, an accessory engagement structure associated with the top, and an accessory for engaging with the accessory engagement surface to configure the grill to change the cooking functionality of the interchangeable cooking surface. The accessory engagement structure may comprise a first accessory engaging structure for engaging with a first accessory and a second accessory engaging structure for engaging with a second accessory. As examples of the multi-configurations available from the inventive outdoor cooking grill, the first accessory may be the cooking surface configured as one of a grill, a griddle and a baking stone, and the second accessory may be a heat spreader/sear plate having vents configured and dimensioned to assist in spreading and evening out the heat from the burner unit reaching the interchangeable cooking surface. The first accessory may include an accessory retention structure, and the heat spreader/sear plate includes an accessory retention mating structure. The accessory may be a heat spreader/sear plate having a searing surface and configured and dimensioned to act as a sear plate for receiving food directly on the searing surface, with the searing surface having heat concentrating elements for creating a predefined sear pattern on the food. The predefined sear pattern can be at least one of an image and a letter, and can be customizable by digitally cutting the heat spreader/sear plate using one of a plasma, torch, water-jet, laser, or other computer-numeric-controlled cutting tool.

### CROSS REFERENCE TO RELATED APPLICATION

This Patent Application claims the priority of U.S. Provisional Patent Application No. 61/505,333, filed Jul. 7, 2011.

### BACKGROUND OF THE INVENTION

The present invention pertains to outdoor cooking grills. More particularly, the present invention pertains to an outdoor cooking grill capable of being reconfigured for a wide range of cooking techniques, using unique and common cooking surfaces including grills, griddles, woks, sauté pans, cast iron pans, Dutch ovens, baking stones, smoke racks, sloped griddles, split grills, heat spreader/sear plates, tall pots, turkey fryer pots, stock pots, lobster pots, and the like.

### SUMMARY OF THE INVENTION

The present invention is intended to provide a remedy. In accordance with the present invention, a multi-configurable cooking grill is provided comprising a burner assembly, an interchangeable cooking surface, a top, an accessory engagement structure associated with the top, and an accessory for engaging with the accessory engagement surface to configure the grill to change the cooking functionality of the cooking surface. The accessory engagement structure may comprise a first accessory engaging structure for engaging with a first accessory and a second accessory engaging structure for engaging with a second accessory. As examples of the multi-configurations available from the inventive outdoor cooking grill, the first accessory may be the cooking surface configured as one of a grill, a griddle and a baking stone, and the second accessory may be a heat spreader/sear plate having vents configured and dimensioned to assist in spreading and evening out the heat from the burner unit reaching the interchangeable cooking surface.

The first accessory may include an accessory retention structure, and the heat spreader/sear plate includes an accessory retention mating structure. The accessory may be a heat spreader/sear plate having a searing surface and configured and dimensioned to act as a sear plate for receiving food directly on the searing surface, with the searing surface having heat concentrating elements for creating a predefined sear pattern on the food. The predefined sear pattern can be at least one of an image and a letter, and can be customizable by digitally cutting the heat spreader/sear plate using one of a plasma, torch, water-jet, laser, or other computer-numeric-controlled cutting tool.

The accessory engagement structure can be formed as a drip catch channel comprising a top engagement surface for engaging with the top, an accessory engagement surface for engaging with and supporting the accessory, and a drip catch channel structure defined by the top engagement surface and the accessory engagement surface. A drip catch receptacle may be provided wherein the drip catch channel is configured and dimensioned to receive liquids flowing from the cooking surface or the top so that the received fluids are drained away through the drip catch channel and into the drip catch receptacle. Also, the accessory can be a griddle cooking surface having a scrap hole, and the top may include a scrap cutout that corresponds to the scrap hole.

The burner assembly can include a first burner for combusting a compressed flammable gas for providing a concentrated source of heat energy to an area of the cooking surface, and a second burner for combusting a compressed flammable gas for providing a distributed source of heat energy to a different area of the cooking surface. A heat containment structure contains the heat energy from the first and the second burner and directs the heat energy towards the cooking surface. The heat containment structure includes an airflow ventilation system configured and dimensioned so that airflow needed for combusting the compressed flammable gas is effective for each cooking configuration of the cooking grill. The airflow ventilation system includes controllable airflow restriction structures for controlling the airflow depending on the cooking configuration to improve the effectiveness of the combusting of the compressed flammable gas.

The accessory can be a heat spreader/sear plate in thermal communication with the first burner and the second burner for distributing the heat energy from the respective first and second burner into a predetermined pattern.

In accordance with another aspect of the present invention, a sloped griddle cooking implement is provided. An inner side portion includes a central bowl area having a relatively steep sloped grade. An outer side portion circumferentially encompasses the central bowl. The outer side portion includes a sloped side area encompassing at least a portion of the central bowl area and having a relatively shallow slope grade effective to enable solid foods placed on the sloped side area to remain on the sloped side area during cooking and liquids in contact with the sloped side area to flow towards and into the central bowl area through the action of gravity.

A channel structure can be provided between the inner side and an outside edge of the outer side for conveying liquid from the central bowl area to outside the sloped griddle cooking implement. The inventive sloped griddle can include a flat horizontal side area encompassing another portion of the central bowl area.

The sloped griddle has a bottom that is heated by a heat source, such as the two or three-burner assembly of the embodiments of the inventive multi-configurable outdoor cooking grill. A heat baffle can be provided as a thermal barrier between the inner side portion and the outsider side portion.

In accordance with the present invention, a cooking grill is provided comprising a burner assembly, an interchangeable cooking surface, a top for supporting the interchangeable cooking surface, and an accessory engagement structure associated with the top. The accessory engagement structure includes a drip catch channel having a top engagement surface for engaging with the top and accessory engagement surface for removably supporting the interchangeable cooking surface. The drip catch channel is configured and dimensioned so that a liquid spilling off from the interchangeable cooking surface is received in the drip catch channel and conveyed away from the interchangeable cooking surface. A cooking accessory is removably engaged with the accessory engagement surface to change the cooking functionality of the cooking grill.

The cooking accessory may comprise a structure that is separate from the interchangeable cooking surface and can be used with different interchangeable cooking surfaces to change the cooking functionality of the cooking grill.

As examples of the cooking configurations and cooking techniques available using the inventive multi-configurable outdoor cooking grill, the cooking accessory may comprise a wok stand supporting plate configured and dimensioned for supporting a separate wok stand, and the interchangeable cooking surface comprise a wok pan. The cooking accessory may comprise a heat spreader/sear plate, and the interchangeable cooking surface comprise a grill. The cooking accessory may comprise a griddle plate that can be removably engaged with the drip catch channel for configuring the cooking grill as a griddle.

The cooking accessory may further comprise a heat spread/sear plate located beneath the griddle plate so that heat from the burner assembly is more evenly distributed to the griddle plate. The cooking accessory may comprise a riser ring, and the interchangeable cooking surface comprise a baking stone. A lid may be supported by the riser ring to form a cooking oven enclosing the baking stone.

Demonstrating the multi-tasking aspects of the components of the present invention, a wok turned upside down can be used as the oven lid. The cooking accessory may also comprise a dedicated, insulated oven enclosure.

The cooking accessory can be integrally formed with the interchangeable cooking surface. For example, the cooking accessory/cooking surface may comprise a griddle plate that can be removably engaged with the drip catch channel for configuring the cooking grill as a griddle. The cooking accessory may comprise a grill structure that can be removably engaged with the drip catch channel for configuring the cooking grill as a grill. The cooking accessory may comprise an oven enclosure that can be removably engaged with the drip catch channel or the top for configuring the cooking grill as an oven.

In accordance with the present invention, a multi-burner unit is provided that works in conjunction with the accessories and cooking surfaces to make a myriad of cooking techniques available from the inventive outdoor cooking grill. Examples of cooking techniques made available include grill, griddle, wok, discata, sauté, bake, sear, toast, deep fry, shallow fry, boil, steam, hot smoker, cold smoker, rotisserie, shish kabob, roast, and simultaneous combinations of these techniques, such as searing and steaming simultaneously using the inventive sloped griddle. In one embodiment, the burner unit comprises a relatively high BTU central burner for providing concentrated high heat to the cooking surface and a relatively low BTU outer burner for providing distributed heat to the cooking surface. The burner unit may also comprise additional burners, or the burners may be split into separately controllable burners. The burners can be electric or gas burners. Examples of burner types include tube burners, jet burners, cast burners, IR burners, electric resistance burners, naturally aspirated gas burners, quartz burners, coiled resistance wire burners, duck burners, impinged jet burners, etc. Also included are embodiments of the inventive multi-configurable cooking grill that utilize solid fuel, such as wood, charcoal or coal. The burner unit may a high BTU central burner for providing concentrated high heat to the cooking surface, a relatively low BTU central burner for providing low heat to the cooking surface, and a relatively low BTU outer burner for providing distributed heat to the cooking surface. This burner configuration enables the outdoor cook to employ the high BTUs necessary for properly doing many cooking techniques, such as wok and searing, while having the controllability to use the same outdoor grill for gentler cooking methods such as smoking and simmering.

Also, the inventive multi-configurable outdoor cooking grill can include the proper safety and convenience features to make it usable as an indoor cooking range. These safety and convenience features may also be employed for outdoor cooking Examples of these safety and convenience features include down draft ventilation for using the flow of air to pull cooking smoke and heat away from the cooking surface and venting it to another location (such as outside). Automatic flame detection can be employed to automatically shut down the flow of gas if the burner flame inadvertently goes out.

### BRIEF DESCRIPTION OF THE DRAWINGS

FIG. 1 is a perspective view of a concentric burner gas fired embodiment of the inventive outdoor cooking grill showing a propane or natural gas fire unit having a top with an accessory engagement structure;

FIG. 2 is a perspective view of the embodiment of the inventive outdoor cooking grill configured with a wok ring accessory holding a wok stand with a wok;

FIG. 3 is an exploded perspective view of the embodiment of the inventive outdoor cooking grill showing the wok ring accessory, the wok rest and the wok;

FIG. 4 is a perspective view of the embodiment of the inventive outdoor cooking grill showing the wok ring accessory supporting a Dutch oven;

FIG. 5 is an exploded perspective view of the embodiment of the inventive outdoor cooking grill showing the wok ring accessory, the Dutch oven and a lid;

FIG. 6 is an exploded view of the inventive outdoor cooking grill configured with a version of the inventive heat spreader accessory;

FIG. 7 is an exploded perspective view of the embodiment of the inventive outdoor cooking grill showing the heat spreader accessory;

FIG. 8 is a perspective view of the heat spreader accessory showing air diversion flaps;

FIG. 9 is a top view of the heat spreader accessory;

FIG. 10 is a perspective view of the heat spreader accessory showing the air diversion flaps;

FIG. 11 is a bottom perspective view of the heat spreader accessory;

FIG. 12 is a perspective view of the embodiment of the inventive outdoor cooking grill showing a grill accessory;

FIG. 13 is an exploded perspective view of the embodiment of the inventive outdoor cooking grill showing the grill accessory;

FIG. 14 is an exploded perspective view of the embodiment of the inventive outdoor cooking grill showing alternative heat spreaders in the form of sizzle/smoke bars and a ceramic rock grate;

FIG. 15 is a perspective view of the embodiment of the inventive outdoor cooking grill configured with a round griddle;

FIG. 16 is an exploded perspective view of the embodiment of the inventive outdoor cooking grill showing the round griddle and griddle ring;

FIG. 17 is a perspective view of the embodiment of the inventive outdoor cooking grill configured with an inventive sloped griddle;

FIG. 18 is an exploded perspective view of the embodiment of the inventive outdoor cooking grill showing the inventive sloped griddle;

FIG. 19 is a bottom perspective view of the inventive sloped griddle showing the riser rim and central heat baffle;

FIG. 20 is a top perspective view of the inventive sloped griddle showing the collection bowl and sloped sides;

FIG. 21 is a perspective view of the inventive sloped griddle;

FIG. 22 is a bottom view of the inventive sloped griddle;

FIG. 23(a) is top view of the inventive sloped griddle;

FIG. 23(b) is a cross section along sight line 23(b) showing in FIG. 23(a);

FIG. 24 is a perspective view of the embodiment of the inventive outdoor cooking grill configured with the wok accessory used to retain a tall turkey fryer pot;

FIG. 25 is an exploded perspective view of the embodiment of the inventive outdoor cooking grill showing the tall turkey fryer pot, wok ring accessory and upside heat spreader providing a support for the tall turkey fryer pot;

FIG. 26 is a perspective view of the embodiment of the inventive outdoor cooking grill configured with an extra-wide stockpot;

FIG. 27 is an exploded perspective view of the embodiment of the inventive outdoor cooking grill showing the extra-wide stockpot and upside heat spreader providing a support for the extra-wide stockpot;

FIG. 28 is an exploded view of the inventive fire unit;

FIG. 29 is an assembled view of the inventive fire unit;

FIG. 30 is an exploded view of an inventive two-burner assembly;

FIG. 31 is an assembled view of the inventive two-burner assembly;

FIG. 32 is an exploded view of a stand configuration for the inventive outdoor cooking grill;

FIG. 33 is an assembled view of the stand configuration for the inventive outdoor cooking grill;

FIG. 34 is a perspective view of the inventive outdoor cooking grill configured as a multiple heat zone grill with the inventive two-burner assembly creating a central searing zone and an outer warming zone;

FIG. 35 is an exploded perspective view of the inventive outdoor cooking grill configured as a multiple heat zone grill and having a smoke ring provided for retaining wood chips in contact with the heat spreader;

FIG. 36 is an exploded view of the inventive outdoor cooking grill configured as a multiple heat zone grill and using the extra-wide stockpot as a smoker/baking oven lid;

FIG. 37 is a perspective view of the inventive outdoor cooking grill showing a large wok supported directly on the wok ring accessory;

FIG. 38 is an exploded perspective view of the inventive outdoor cooking grill showing the large wok and the wok ring accessory;

FIG. 39 is a perspective view of the inventive outdoor cooking grill configured as a smoker/baking oven with an inventive riser ring and using the large wok as a lid;

FIG. 40 is an exploded perspective view of the inventive outdoor cooking grill configured as a steamer with the inventive sloped griddle and the large wok as a lid;

FIG. 41 is an exploded perspective view of the inventive outdoor cooking grill configured as a baking oven showing an inventive riser ring for supporting a baking stone;

FIG. 42 is an exploded perspective view of the inventive outdoor cooking grill configured as a baking oven with the extra-wide stockpot as a lid;

FIG. 43 is a perspective view of the inventive outdoor cooking grill configured as a shish kabob cooker using the inventive riser ring;

FIG. 44 is a perspective view of the fire unit with a steam/smoker/baking rack and using the extra-wide stockpot as a lid;

FIG. 45 is an isolated view showing the large wok with an inventive telescoping lid-clamping mechanism;

FIG. 46 is a perspective view of the inventive outdoor cooking grill configured with the inventive telescoping lid-clamping mechanism holding a large wok as a lid;

FIG. 47 is a perspective view of the inventive outdoor cooking grill showing the large wok supported by the inventive telescoping lid-clamping mechanism;

FIG. 48 is an isolated view of the fire unit with the large wok supported by the inventive telescoping lid-clamping mechanism raised to accommodate the inventive sloped griddle;

FIG. 49 is an isolated view of the fire unit with the large wok supported by the inventive telescoping lid-clamping mechanism in a raised position to reduce flare -ups on the grill;

FIG. 50 is an isolated view of the fire unit with the large wok supported by the inventive telescoping lid-clamping mechanism in a lowered position to cover the grill surface;

FIG. 51 is a perspective view of the inventive outdoor cooking grill showing the large wok supported by the inventive telescoping lid-clamping mechanism raised to accommodate the inventive sloped griddle configured with the grill as a steamer;

FIG. 52 is an exploded view of an embodiment of the inventive telescoping lid-clamping mechanism;

FIG. 53 is an assembled view of the inner fast burner;

FIG. 54 is an isolated exploded perspective view of an inventive ceramic IR conversion insert for use with an inner fast burner;

FIG. 55 is an exploded view of an inner fast burner showing ceramic IR inserts and cast metal gas diffuser;

FIG. 56 is an isolated assembled view of the inventive ceramic IR conversion insert assembled with the inner fast burner;

FIG. 57 is an exploded perspective view of the inventive outdoor cooking grill showing the inventive IR conversion insert;

FIG. 58 is a perspective view of a solid fuel fired embodiment of the inventive outdoor cooking grill having a charcoal or wood burning fire unit;

FIG. 59 is an isolated view of the charcoal or wood burning fire unit showing a fuel basket inserted in a fire chamber tube;

FIG. 60 is an exploded view of the charcoal or wood burning fire unit showing the fuel basket, fire chamber tube with integrated fire chamber flange, bottom plate, fire chamber cap, air intake pipe and air intake controller;

FIG. 61 is an isolated view showing the fire chamber flange;

FIG. 62 is an isolated view showing the fire chamber tube;

FIG. 63 is an isolated view showing the air intake pipe and air intake controller;

FIG. 64 is a bottom perspective view showing the air intake pipe assembled with the fire chamber tube;

FIG. 65 is a top perspective view showing the air intake pipe assembled with the fire chamber tube;

FIG. 66 is an isolated view of a dual-wall fire tube;

FIG. 67 shows the outer wall of the dual-wall fire tube;

FIG. 68 shows the inner wall of the dual-wall fire tube;

FIG. 69 is a perspective view of the embodiment of the inventive outdoor cooking grill configured for wok-style cooking;

FIG. 70 is a perspective view of the embodiment of the inventive outdoor cooking grill configured for Dutch oven-style cooking;

FIG. 71 is a perspective view of the inventive outdoor cooking grill configured for shish kabob-style cooking;

FIG. 72 is a perspective view of another embodiment of the inventive outdoor cooking grill having a wood or charcoal burning fire unit and a ceramic fire box;

FIG. 73 is a perspective view of the embodiment of the inventive outdoor cooking grill showing the frame, wok ring accessory and metal frame;

FIG. 74 is a perspective view of the embodiment of the inventive outdoor cooking grill showing a griddle accessory;

FIG. 75 is an isolated perspective view of a soapstone top;

FIG. 76 is an isolated perspective view of the metal frame;

FIG. 77 is an exploded perspective view of the top support frame of the embodiment of the inventive outdoor cooking grill;

FIG. 78 is an exploded perspective view of the handles of the embodiment of the inventive outdoor cooking grill;

FIG. 79 is an exploded perspective view of the sheet metal panels of the embodiment of the inventive outdoor cooking grill;

FIG. 80 is a perspective view of an inventive drip-catch accessory engagement structure;

FIG. 81 is a perspective view of a wok ring accessory insert and fuel chute block for the embodiment of the inventive outdoor cooking grill;

FIG. 82 is a perspective view of a griddle accessory insert and fuel chute block for the embodiment of the inventive outdoor cooking grill;

FIG. 83 is a perspective view of a top for the embodiment of the inventive outdoor cooking grill;

FIG. 84 is an exploded view of an alternative solid fuel fire unit showing the fuel chute, ash guide, fire chamber, air vane, intake pipe, pipe flange and bottom plate of the embodiment of the inventive outdoor cooking grill;

FIG. 85 is a perspective view of the embodiment of the inventive outdoor cooking grill configured for wok cooking and showing the frame, fire unit, bottom plate, top, wok ring accessory and work rest;

FIG. 86 is a perspective view of a multi-zoned embodiment of the inventive cooking grill;

FIG. 87 is an isolated perspective view of a soapstone top for the multi-zoned embodiment of the inventive cooking grill;

FIG. 88 is an isolated perspective view of the metal stand for the multi-zoned embodiment of the inventive cooking grill;

FIG. 89 is an isolated perspective view of individual zone cooking grates for the multi-zoned embodiment of the inventive cooking grill;

FIG. 90 is an isolated perspective view of a top rim for the multi-zoned embodiment of the inventive cooking grill;

FIG. 91 is an isolated perspective view of a metal top for the multi-zoned embodiment of the inventive cooking grill;

FIG. 92 is a block representation of cooking burners, such as IR, gas or electric burners for the multi-zoned embodiment of the inventive cooking grill;

FIG. 93 is an assembled perspective view of the multi-zoned embodiment of the inventive cooking grill with one of the burner zones configured for wok cooking and the other two-burner zones configured with the individual zone cooking grates;

FIG. 94 is an assembled perspective view of the multi-zoned embodiment of the inventive cooking grill with two of the burner zones configured for a two-zone griddle;

FIG. 95 is an isolated perspective view of the two-zone griddle accessory;

FIG. 96 is an isolated bottom perspective view of the two-zone griddle accessory;

FIG. 97 is an isolated view of the soapstone and metal cook top configured for simultaneous wok cooking, rotisserie and sear grilling;

FIG. 98 shows a heat/wind deflector attachment for the rotisserie;

FIG. 99 is a perspective view of another concentric burner gas fired embodiment of the inventive outdoor cooking grill showing an outer edge drip tray;

FIG. 100 is an isolated exploded perspective view of the outer edge drip tray and the assembled fire unit;

FIG. 101 is an isolated perspective view of the outer edge drip tray;

FIG. 102 is an isolated bottom perspective view of the outer edge drip tray;

FIG. 103 is an isolated top view of the outer edge drip tray;

FIG. 104 is an isolated bottom view of the outer edge drip tray;

FIG. 105 is a perspective view of the concentric burner gas fired embodiment of the outdoor cooking grill with outer edge drip tray and configured as a large circular griddle;

FIG. 106 is a perspective view of the concentric burner gas fired embodiment of the outdoor cooking grill with outer edge drip tray and configured as a large sloped griddle;

FIG. 107 is a perspective view of the concentric burner gas fired embodiment of the outdoor cooking grill with outer edge drip tray and configured as a large grill;

FIG. 108 is a perspective view of the concentric burner gas fired embodiment of the outdoor cooking grill with outer edge drip tray and configured as a wok cooker;

FIG. 109 is a perspective view of the concentric burner gas fired embodiment of the outdoor cooking grill with outer edge drip tray with a large riser ring accessory engagement structure;

FIG. 110 is an isolated exploded view of the riser ring, a baking stone, and a grill for configuring the concentric burner gas fired outdoor cooking grill as a baking oven;

FIG. 111 is a perspective view of the concentric burner gas fired embodiment of the outdoor cooking grill with outer edge drip tray and configured as a baking oven using the large wok as a lid;

FIG. 112 is an exploded isolated perspective view showing the fire unit with outer edge drip tray, the riser ring with a rotisserie skewer and the large wok as a lid for configuring the concentric burner gas fired outdoor cooking grill for rotisserie cooking;

FIG. 113 is an isolated perspective view showing the assembled fire unit, outer edge drip tray, riser ring, grill and baking stone for configuring the concentric burner gas fired outdoor cooking grill as a pizza or bread oven;

FIG. 114 is a perspective view showing the concentric burner gas fired outdoor cooking grill configured as a large wok cooker;

FIG. 115 is a perspective view showing the concentric burner gas fired outdoor cooking grill configured as an oven;

FIG. 116 is a perspective view of a solid fuel fired oven and grill/stove/griddle embodiment of the inventive outdoor cooking grill;

FIG. 117 is a perspective view of the solid fuel fired oven embodiment of the inventive outdoor cooking grill showing the oven chamber and top opening;

FIG. 118 is a perspective view of the embodiment of the inventive outdoor cooking grill showing the metal frame and dual solid fuel fire units;

FIG. 119 is a perspective view showing the embodiment of the inventive outdoor cooking grill showing the griddle accessory;

FIG. 120 is a side view of the embodiment of the inventive outdoor cooking grill;

FIG. 121 is a perspective view of the embodiment of the inventive outdoor cooking grill showing the oven chamber and racks;

FIG. 122 is an isolated view of the solid fuel fire unit showing an air intake control damper;

FIG. 123 is an isolated view of the solid fuel fire unit showing a fan of a controllable forced air intake system;

FIG. 124 is a block diagram showing the controllable forced air intake system;

FIG. 125 is a flowchart showing a control scheme for the controllable forced air intake system;

FIG. 126 is an isolated view of a bubbler system for the controllable forced air intake system;

FIG. 127 is a perspective view of a riser ring for use with the various embodiment of the inventive outdoor cooking grill;

FIG. 128 is a perspective view of a heat spreader/sear plate for use with the various embodiments of the inventive outdoor cooking grill;

FIG. 129 is a perspective view of an embodiment of the inventive sloped griddle showing a bowl drainage channel;

FIG. 130 is a perspective view of an embodiment of the inventive sloped griddle showing a flat griddle portion, sloped griddle portion, central bowl and retaining wall;

FIG. 131 is a bottom perspective view of the embodiment of the inventive sloped griddle shown in FIG. 130;

FIG. 132 is a perspective view of an outer ring burner having naturally aspirated burner tips;

FIG. 133 is a perspective view of a split outer ring burner;

FIG. 134 is a perspective view of an outer ring tube burner;

FIG. 135 is a perspective view of an embodiment of the gas fired outdoor cooking grill with a campfire accessory;

FIG. 136 is an isolated view of the fast burner with the campfire accessory;

FIG. 137 is an isolated exploded view of the campfire accessory showing the fire stones of the campfire accessory;

FIG. 137 is an isolated exploded view of the campfire accessory showing the grate of the campfire accessory;

FIG. 137 is an isolated exploded view of the campfire accessory showing the housing of the campfire accessory;

FIG. 140 is a perspective view showing a gas fired embodiment of the inventive outdoor cooking grill showing a dual wall fire tube;

FIG. 141 is a perspective view showing the inventive heat spreader/sear plate in combination with the fast burner and outer ring burner of an embodiment of the inventive outdoor cooking grill;

FIG. 142 is a top view of the inventive heat spreader/sear plate;

FIG. 143 is an isolated perspective view of the inventive heat spreader/sear plate;

FIG. 144 is an example of a customizable food branding image cut into an embodiment of the inventive heat spreader/sear plate wherein the image is a football;

FIG. 145 is another example of a customizable food branding image cut into an embodiment of the inventive heat spreader/sear plate wherein the image is a baseball player;

FIG. 146 is another example of a customizable food branding image cut into an embodiment of the inventive heat spreader/sear plate wherein the image is a shamrock;

FIG. 147 is another example of a customizable food branding image cut into an embodiment of the inventive heat spreader/sear plate wherein the image is a series of typically food items;

FIG. 148 is another example of a customizable food branding image cut into an embodiment of the inventive heat spreader/sear plate wherein the image is a music staff;

FIG. 149 is another example of a customizable food branding image cut into an embodiment of the inventive heat spreader/sear plate wherein the image is a series of checkered flags;

FIG. 150 is a perspective view showing an embodiment of the inventive outdoor cooking grill having a three-burner system and a circumferential drip tray;

FIG. 151 is a perspective view of the embodiment of the inventive outdoor cooking grill showing the circumferential drip tray;

FIG. 152 is an exploded view of components of an embodiment of the inventive outdoor cooking grill showing tubular legs welded directly to the fire unit; a griddle accessory, a grill, a heat spreader/sear plate, a wok stand and a wok ring accessory;

FIG. 153 shows the layout for cutting various parts of the flat stock pieces that make up the embodiment of the inventive outdoor cooking grill;

FIG. 154 is an exploded perspective view showing the various tubular and pipe section or rolled parts that make up the embodiment of the inventive outdoor cooking grill;

FIG. 155 is a perspective view of the inventive outdoor cooking grill showing a large wok used as a lid to cover the grill;

FIG. 156 is a perspective view of the inventive outdoor cooking grill showing the large wok held in a tipped up position by a wok lid brace;

FIG. 157 is a perspective view of the embodiment of the inventive cooking grill showing a half grill covering half of the cooking surface of an inventive heat spreader/sear plate;

FIG. 158 is a perspective view of a two ring burner showing an inner ring and an outer ring;

FIG. 159 is a perspective view of a three-burner system comprising a fast burner, an inner ring burner and an outer ring burner;

FIG. 160(a) is a perspective view of a single burner square grill embodiment of the inventive outdoor cooking grill;

FIG. 160(b) is an isolated view of the frame of the single burner square grill embodiment of the inventive outdoor cooking grill;

FIG. 160(c) is an isolated cross sectional view of the drip catch channel 168;

FIG. 161 is an exploded perspective view of the components that make up the single burner square grill embodiment;

FIG. 162 is a perspective view showing the single burner square grill embodiment configure for direct flame grilling;

FIG. 163 is a perspective view showing the single burner square grill embodiment configured for heat spread/sear plate, grilling;

FIG. 164 is a perspective view showing the single burner square grill embodiment configured for wok cooking;

FIG. 165 is a perspective view showing the single burner square grill embodiment configured for wok cooking and showing a large wok;

FIG. 166 is a perspective view showing the single burner square grill embodiment configured for griddle cooking;

FIG. 167 is a perspective view showing the single burner square grill embodiment configured for griddle cooking using an enlarged griddle surface;

FIG. 168 is a perspective view of the single burner square grill embodiment configured with a wok stand, heat spreader/sear plate and baking stone;

FIG. 169 is a perspective view of the single burner square grill embodiment configured with a ring riser and wok as lid forming a baking oven;

FIG. 170 is a bottom isolated perspective view showing the component of a set up for configuring the inventive outdoor cooking grill as a baking oven;

FIG. 171 is a bottom perspective view of a griddle accessory showing anti-warping braces;

FIG. 172 is a bottom perspective view of an enlarged griddle accessory showing retaining structures;

FIG. 173 is a perspective view of a heat spreader/sear plate configured with engaging surfaces for mating with the retaining structures of the griddle accessory;

FIG. 174 is a perspective view showing the single burner square grill embodiment on an accessory housing stand;

FIG. 175 is a perspective view showing the single burner square grill embodiment with an inventive oven enclosure;

FIG. 176 is a perspective view of a single fast gas burner grill embodiment with a removable grill fire engine;

FIG. 177 is an isolated view of the removable fire engine of the single fast gas burner grill embodiment;

FIG. 178 is an isolated view of the removable fire engine with a split grill accessory; and

FIG. 179 is a perspective view showing the single fast gas burner grill embodiment configured for griddle cooking

### DETAILED DESCRIPTION OF THE INVENTION:

For purposes of promoting an understanding of the principles of the invention, reference will now be made to the embodiments illustrated in the drawings and specific language will be used to describe the same. It will nevertheless be understood that no limitation of the scope of the invention is thereby intended, there being contemplated such alterations and modifications of the illustrated device, and such further applications of the principles of the invention as disclosed herein, as would normally occur to one skilled in the art to which the invention pertains.

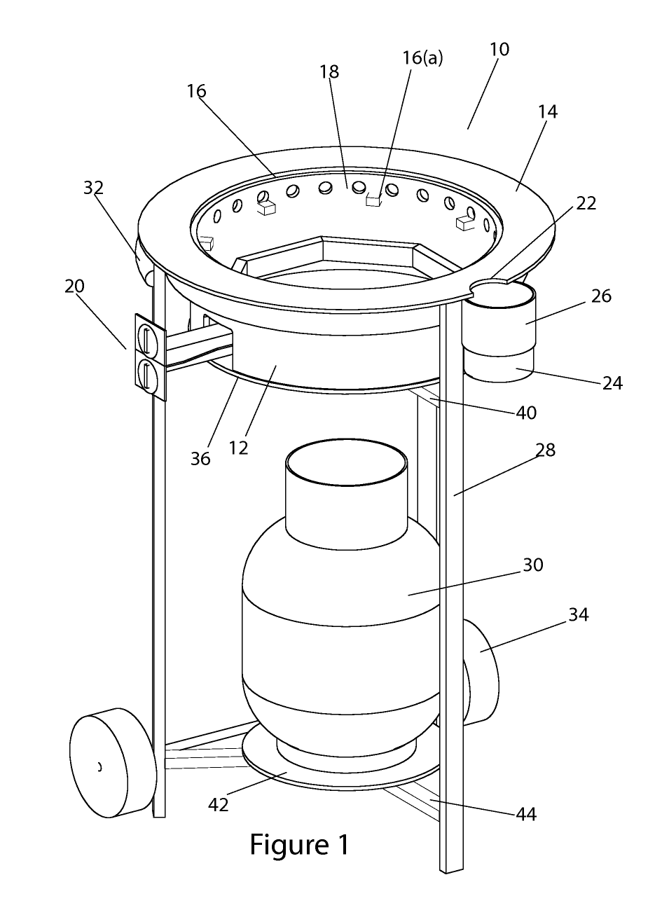

FIG. 1 is a perspective view of a concentric burner gas fired embodiment of the inventive multi-configurable outdoor cooking grill showing a propane or natural gas fire unit 12 having a top 14 with an accessory engagement structure 16. At least one additional accessory engagement structure 16(a) may be provided. This embodiment of the multi-configurable cooking grill includes a fire unit 12 that can be made from a section of a pipe 18 or from a rolled piece of flat stock. For example, an 18 inch schedule 10s stainless steel pipe section 18 can be used to form a fire unit 12. This fire unit 12 contains the burner assembly 20. The fire unit 12 can be welded to the top 14. The top 14 can be made, for example, from 10 gauge stainless steel plate that is plasma, torch or laser cut using a computer-numeric-controlled (CNC) cutting table. The top 14 may include a scrap cutout 22 that allows food scraps and fluids to be disposed of into a receptacle, such as a drip cup 24 that is removably held by a receptacle holder 26. The fire unit 12 sits in a stand frame 28 that also holds a propane tank 30. The stand frame 28 may also include a handle 32 and wheels 34. A bottom plate 36 is provided for catching drips and food scraps that fall from the food during cooking. The bottom plate 36 sits on an upper support 38 (not shown in this view) that is fixed to upper support braces 40 that may be welded or otherwise fixed to the stand frame 28. The propane tank 30 sits on a lower support 42 that is fixed to lower support braces 44 that may also be welded or otherwise fixed to the stand frame 28.

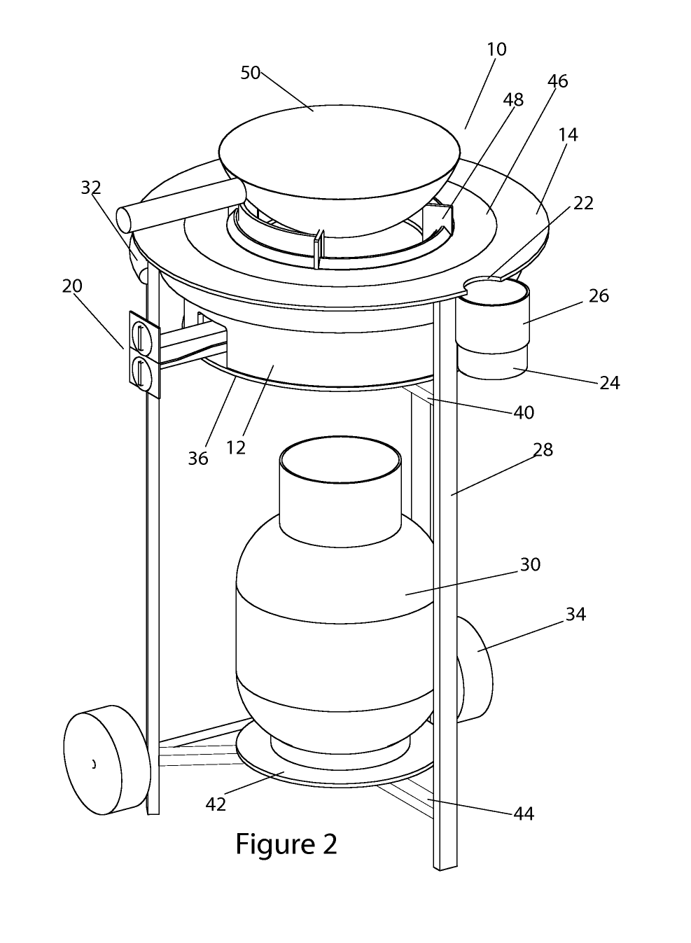

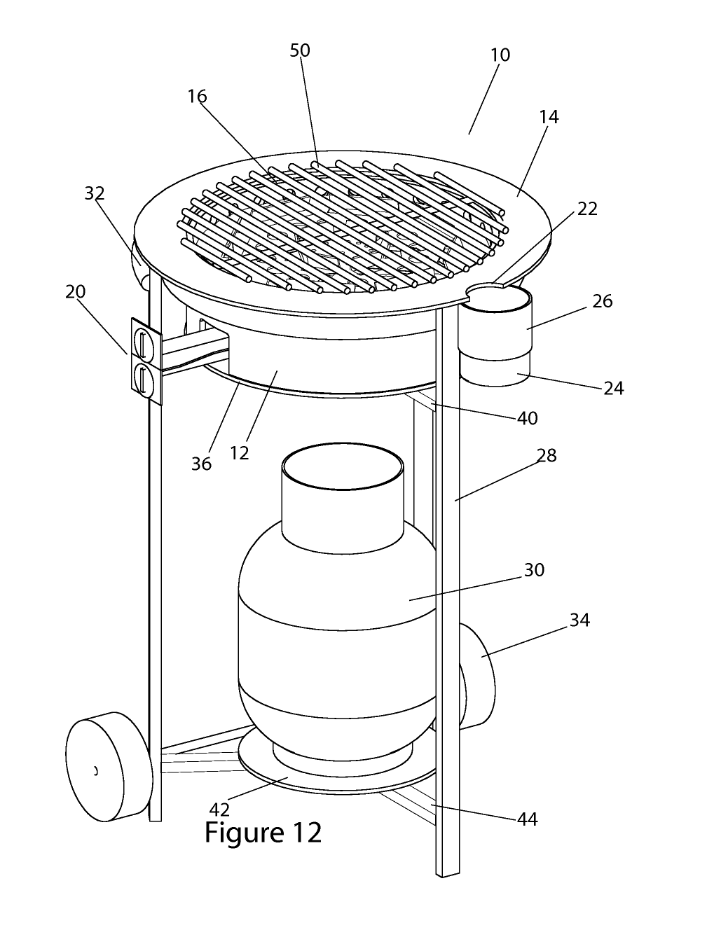

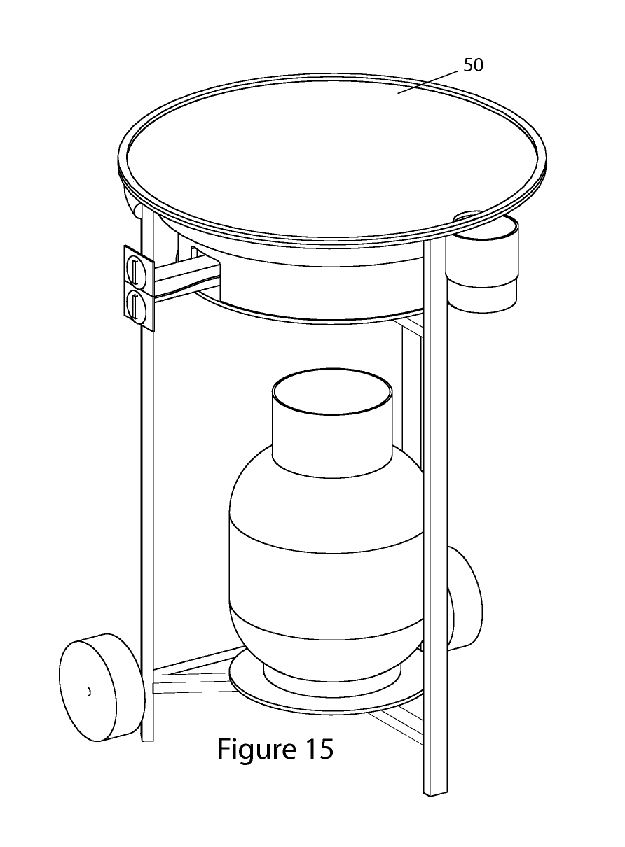

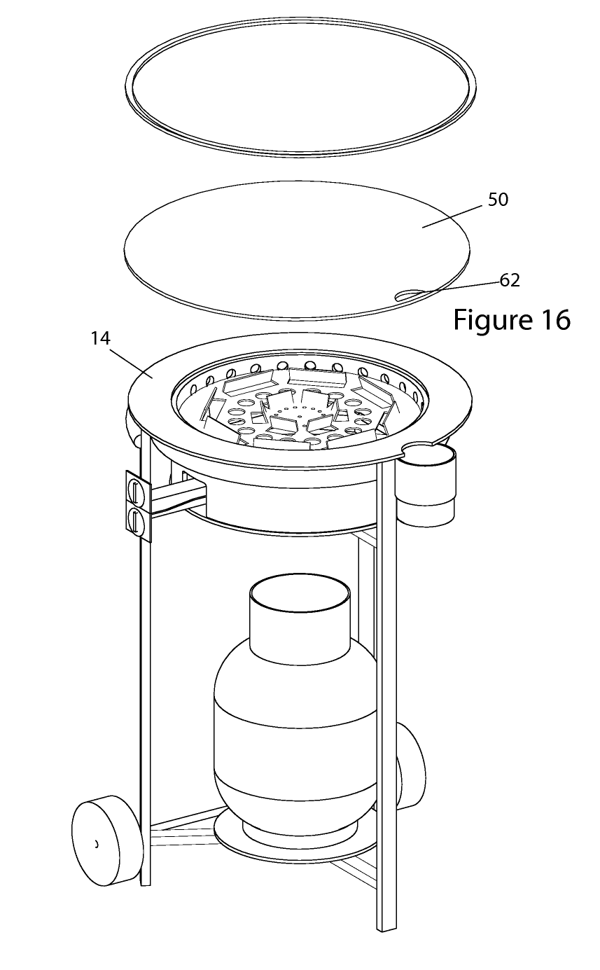

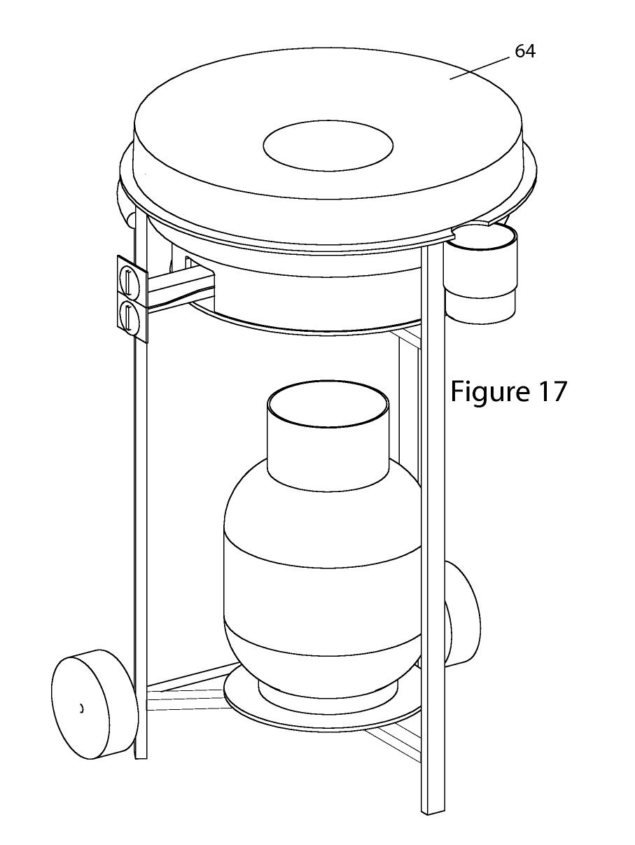

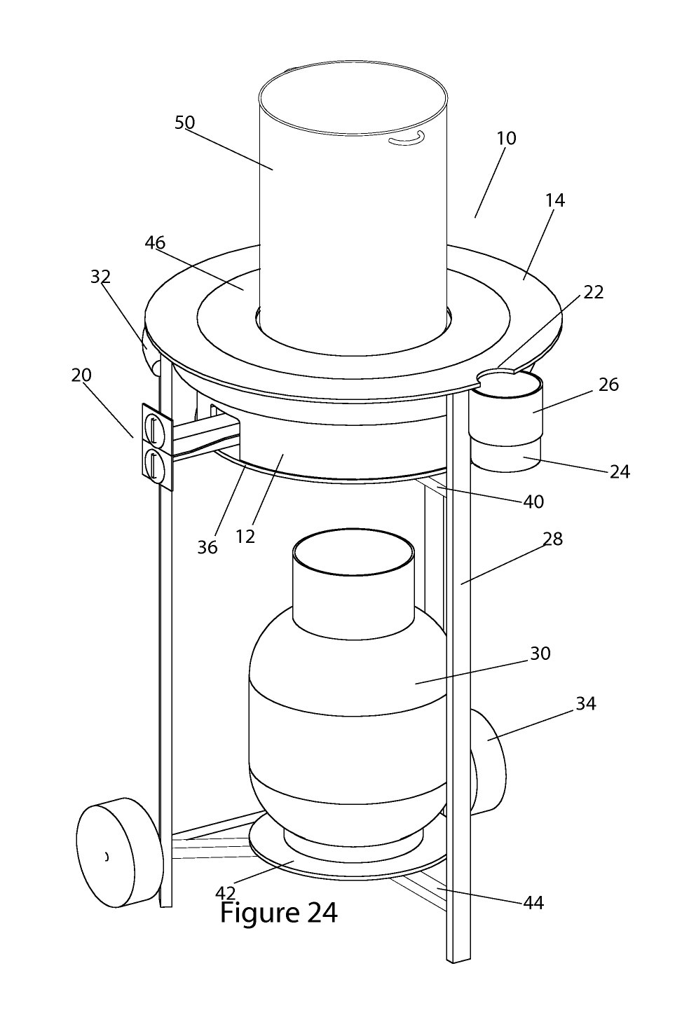

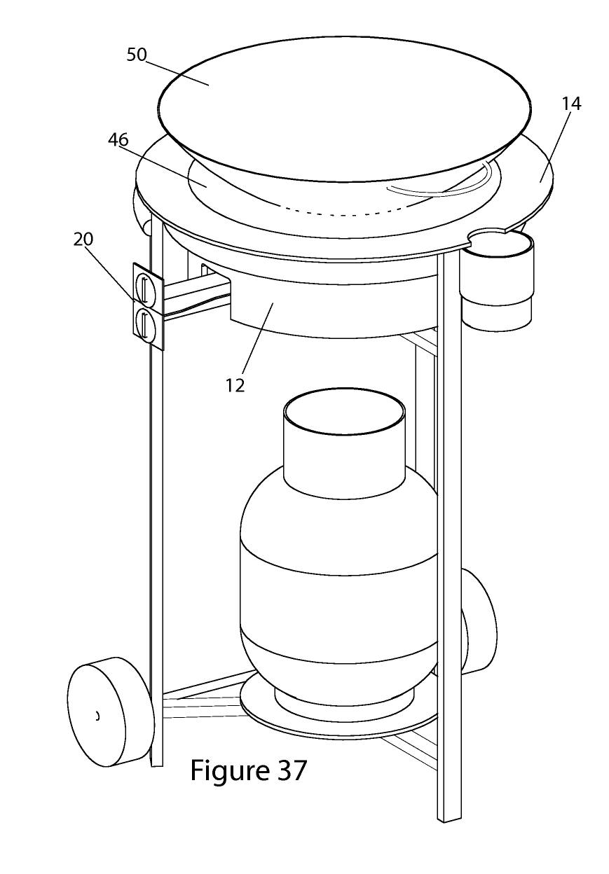

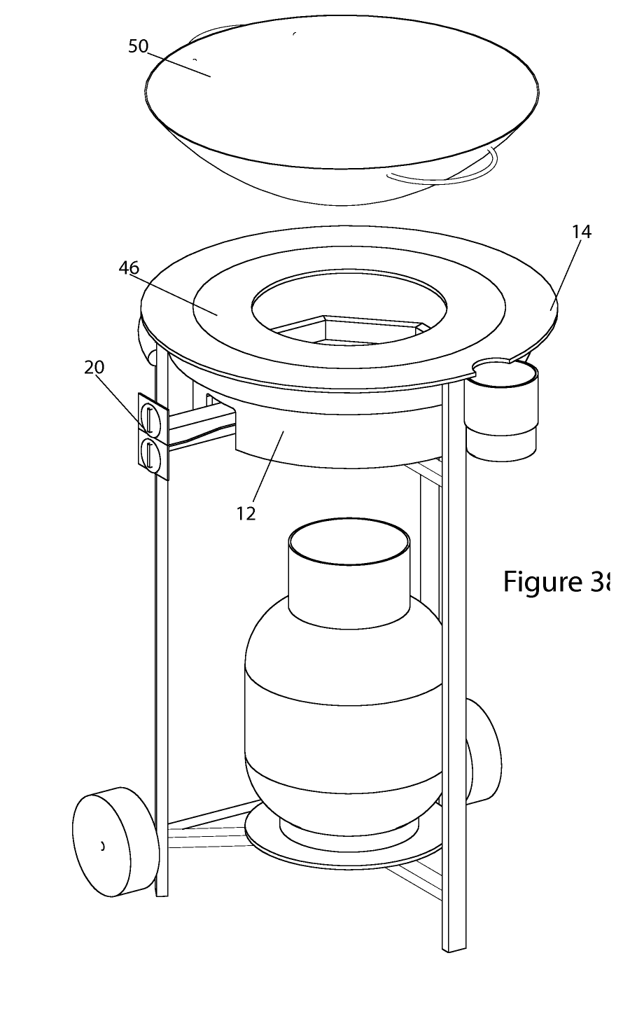

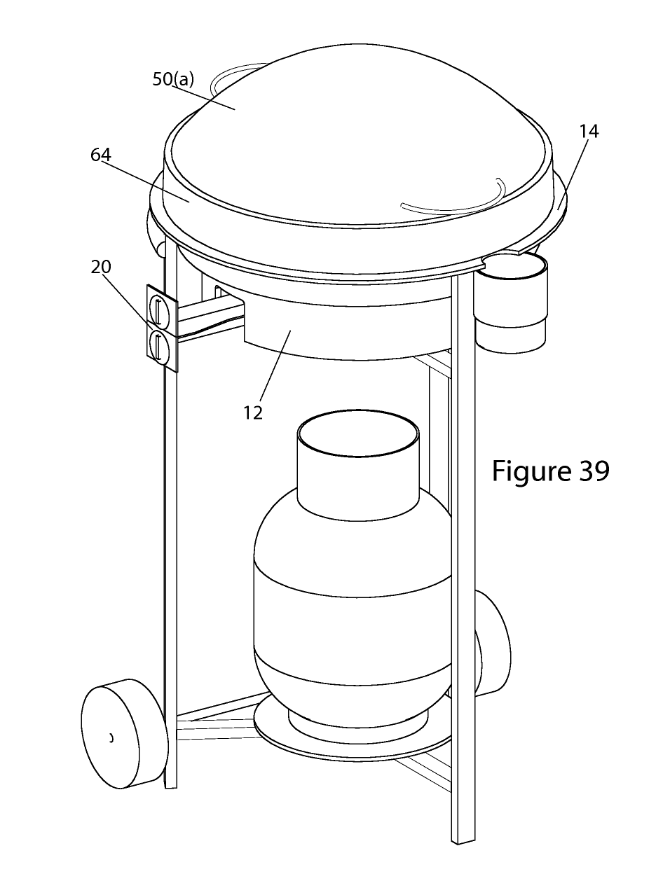

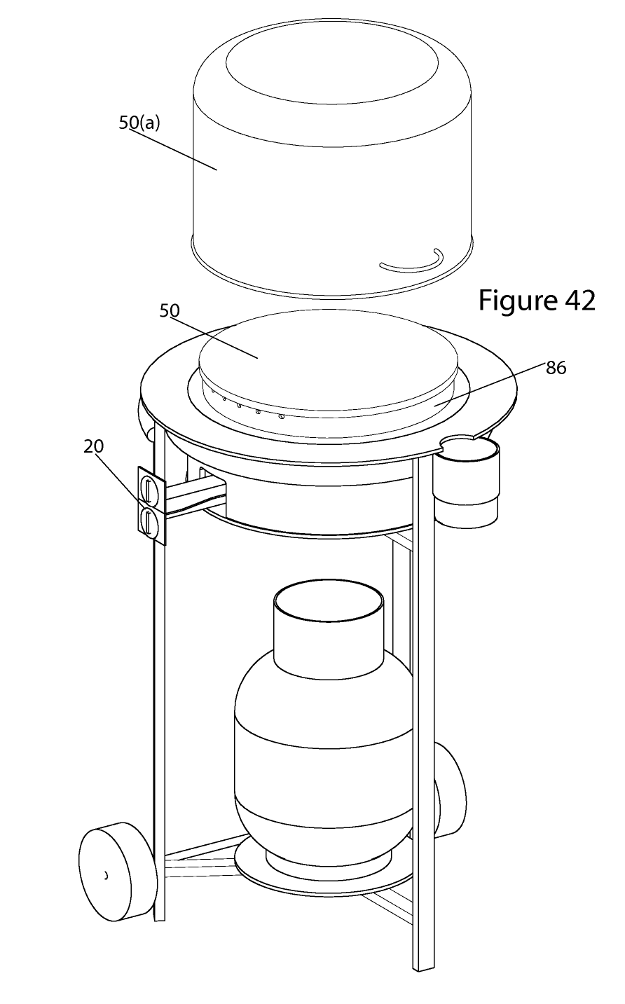

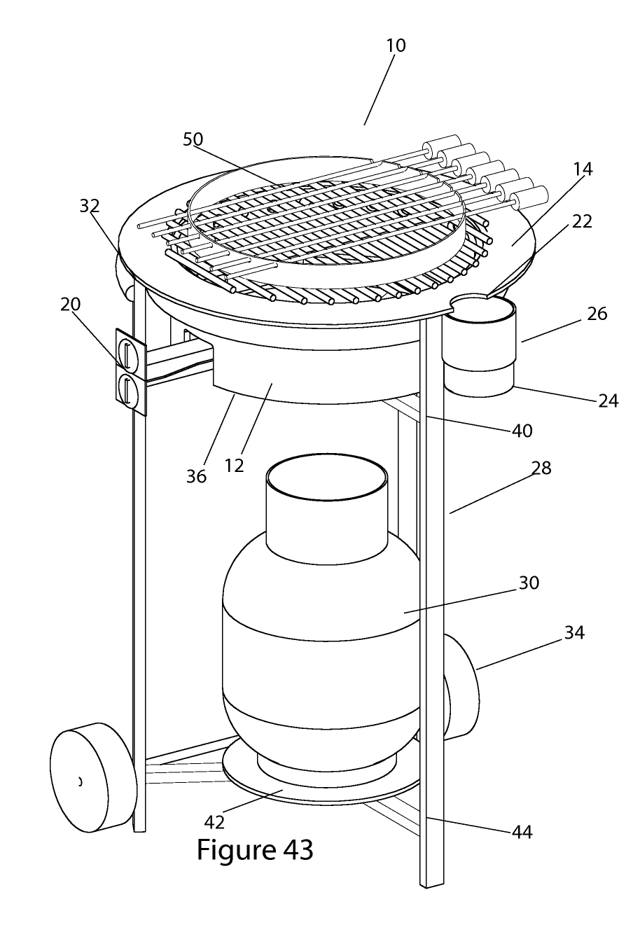

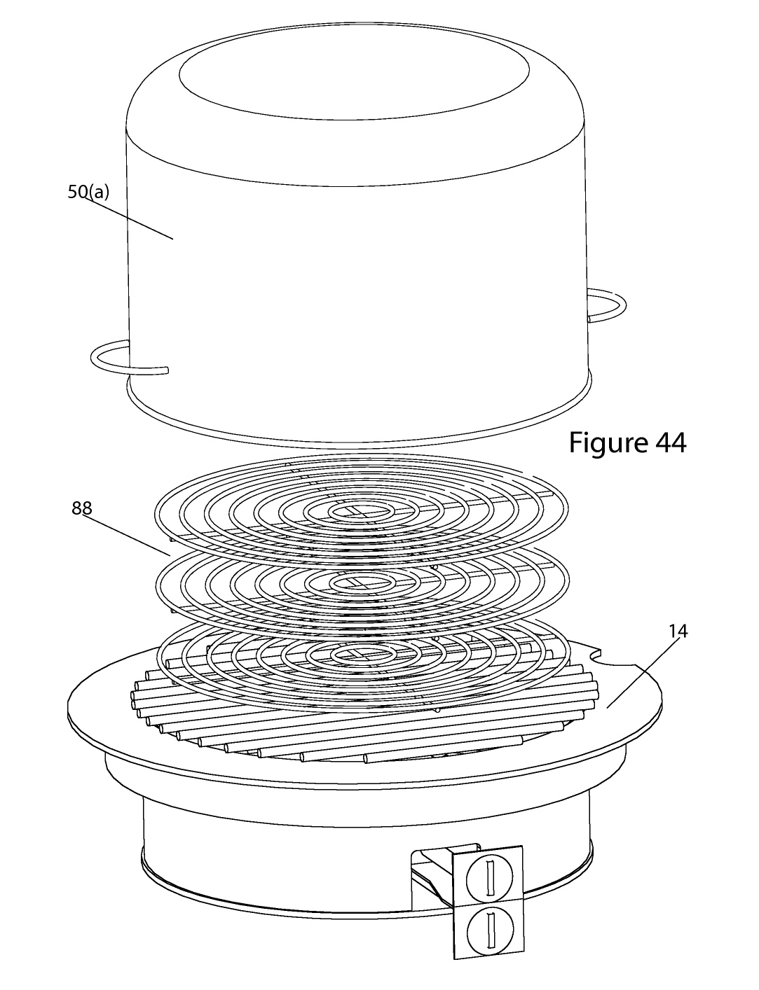

FIG. 2 is a perspective view of the embodiment of the inventive outdoor cooking grill configured with a wok ring accessory 46 holding a wok stand 48 with a wok. The inventive cooking grill 10 includes an interchangeable cooking surface 50, such as the wok shown in FIG. 2, the Dutch oven shown in FIG. 4, the grill shown in FIG. 12, the griddle shown in FIG. 15, the sloped griddle 64 shown in FIG. 17, the retained tall pot shown in FIG. 24, the retained large stockpot shown in FIG. 26, the large wok shown in FIG. 37, the steamer shown in FIG. 39, the baking oven shown in FIG. 42, the shish kabob cooker shown in FIG. 43, and the smoker shown in FIG. 44. In some configurations of the inventive outdoor cooking grill, the accessory 46 is also the cooking surface 50. In other configurations, one or more accessories 46 are included in addition to the cooking surface 50.

The inventive grill also includes a top 14 with an accessory engagement structure 16 associated with the top 14. As shown in FIG. 1, the accessory engagement structure 16 may be formed from the top edge of the pipe 18 forming the fire unit 12. Alternatively, the accessory engagement structure 16 may be a flange or lip portion welded, fixed, or formed with the top 14. As another alternative, the accessory engagement structure 16 may form a drip catch channel that provides a mechanism for fluid, such as melted fats and oils, water, food juices or marinades to be collected and flow cleanly away from the cooking surface 50. A variety of accessories are provided for engaging with the accessory engagement structure to configure the grill to change the cooking functionality of the cooking surface 50.

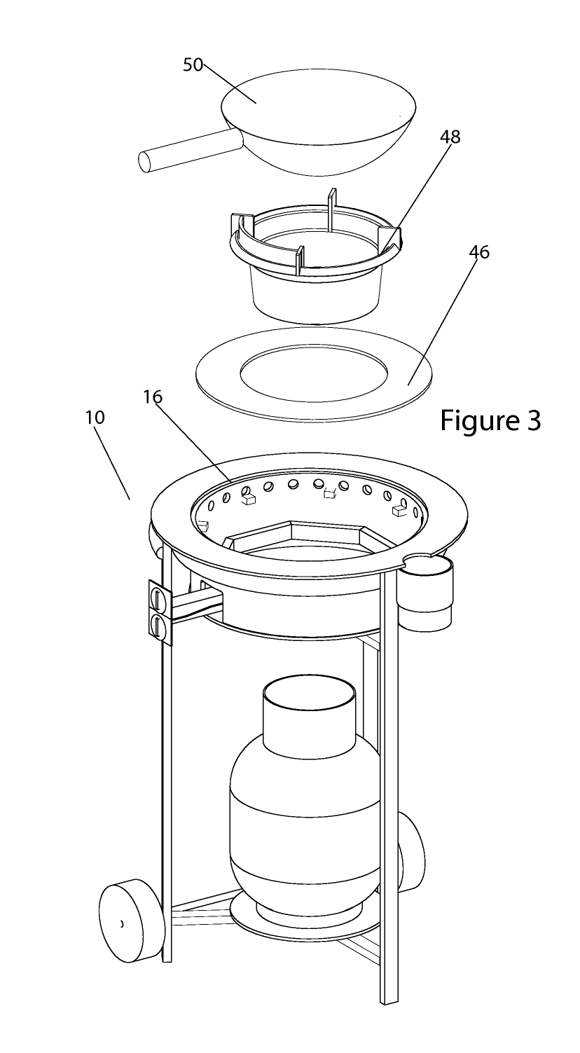

FIG. 3 is an exploded perspective view of the embodiment of the inventive outdoor cooking grill showing the wok ring accessory 46, the wok stand 48 and the wok. As an example, the accessory 46 shown in FIG. 3 is a wok ring that supports a wok stand 48 . In this case, the interchangeable cooking surface 50 can be a wok pan. The wok stand 48 can also be used to support other interchangeable cooking surfaces 50, such as a sauté pan, baking stone, griddle plate, grill or other cooking surfaces 50.

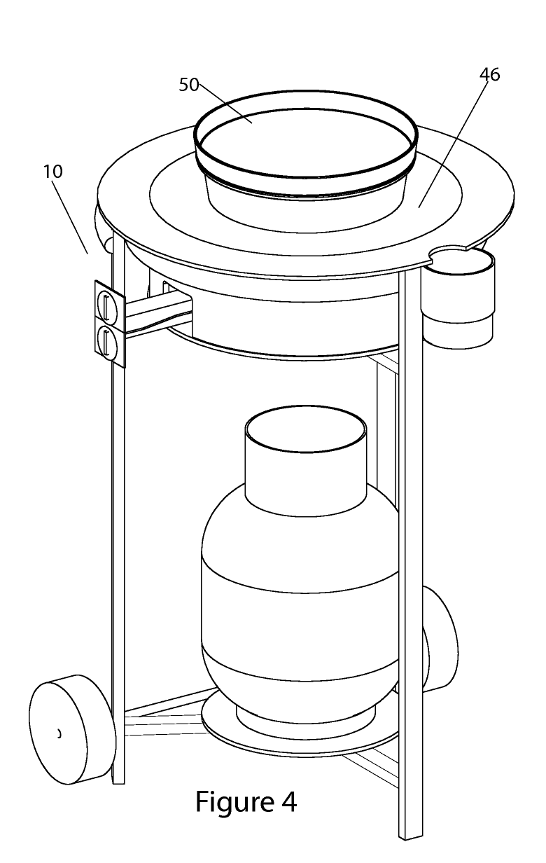

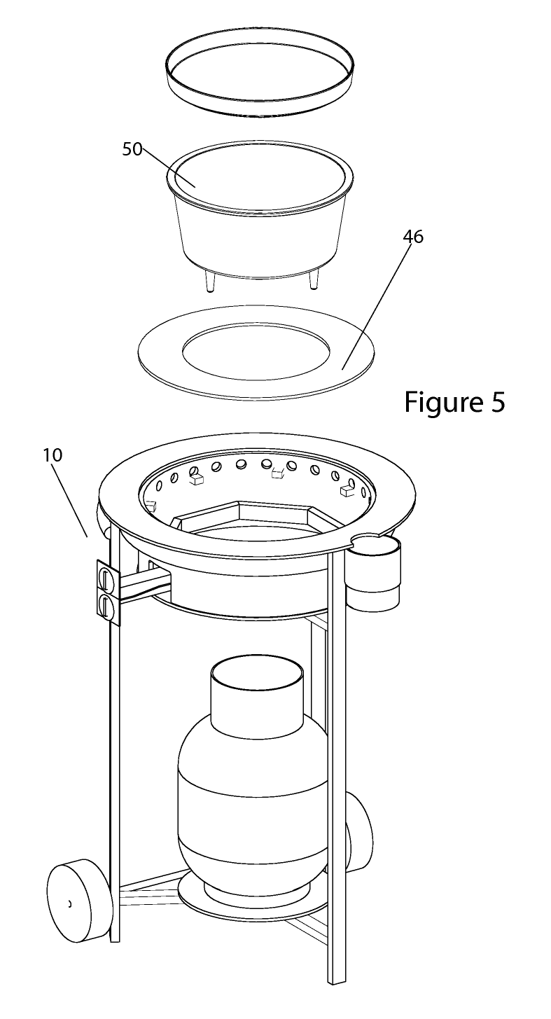

Also, the wok ring accessory 46 can be used to reconfigure the inventive multi-configurable outdoor cooking grill for a variety of cooking techniques. For example, FIG. 4 is a perspective view of the embodiment of the inventive outdoor cooking grill showing the wok ring accessory 46 supporting a Dutch oven cooking surface 50. FIG. 5 is an exploded perspective new of the embodiment of the inventive outdoor cooking grill showing the wok ring accessory 46, the Dutch oven and a lid.

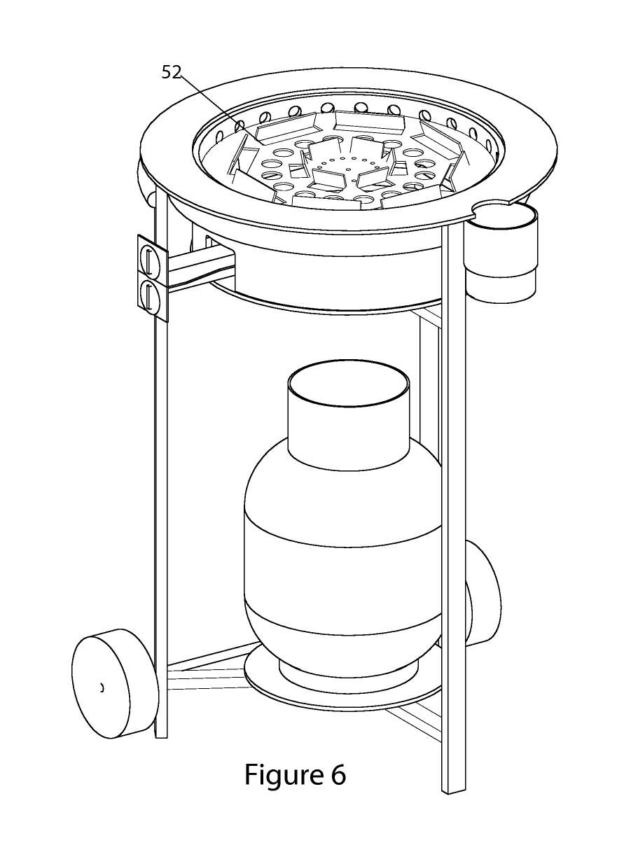

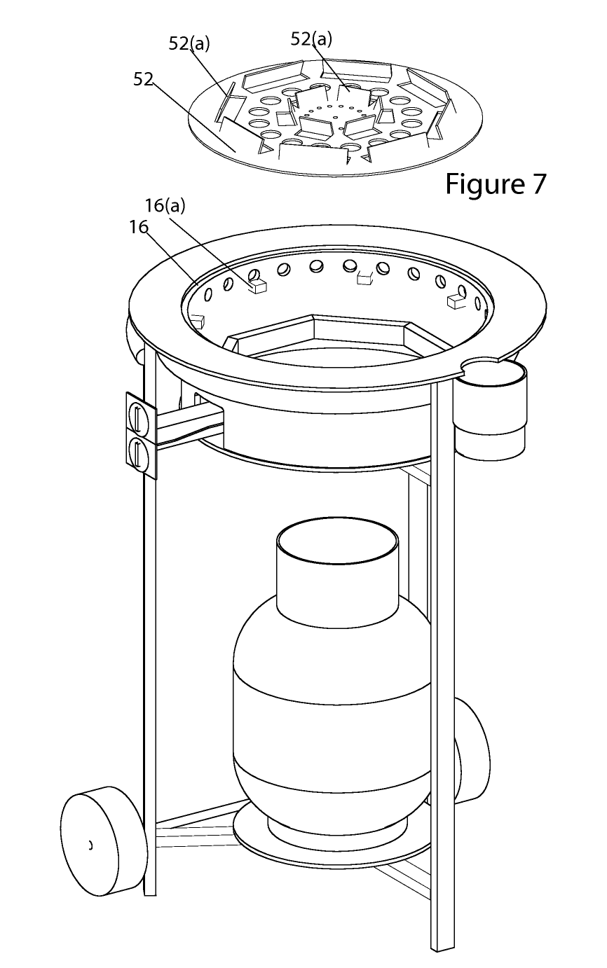

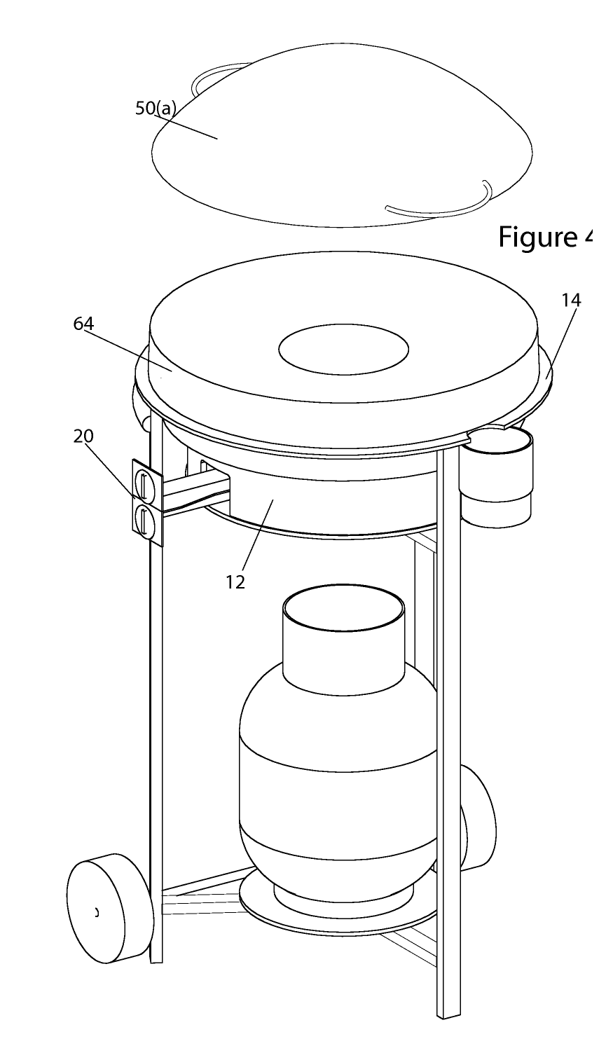

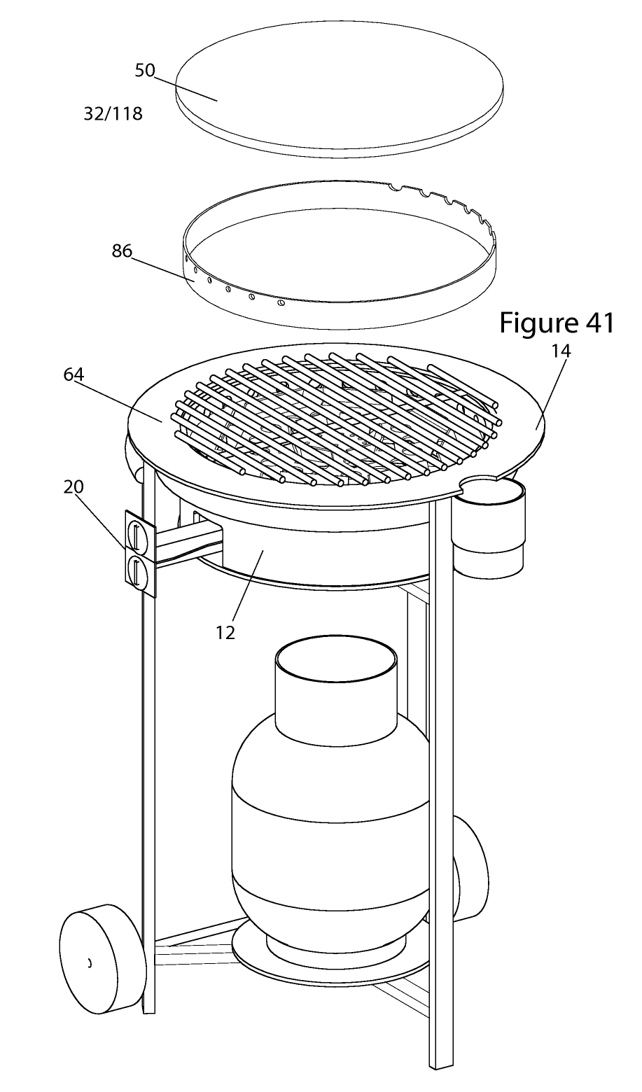

FIG. 6 is an exploded view of the inventive outdoor cooking grill configured with a version of the inventive heat spreader/sear plate accessory 52. FIG. 7 is an exploded perspective view of the embodiment of the inventive outdoor cooking grill showing the heat spreader/sear plate accessory 52. The accessory engagement structure 16 may comprise a first accessory engagement structure for engaging with a first accessory 46 and a second accessory engagement structure 16(a) for engaging with a second accessory 46. As shown in FIGS. 6 and 7, the inventive heat spreader/sear plate accessory 52 is engaged and retained by the second accessory engagement structure 16(a). The heat spreader/sear plate accessory 52 may have vents or flaps 52(a) configured and dimensioned to assist in spreading and evening out the heat from the burner unit reaching the interchangeable cooking surface 50. The first accessory 46 may the cooking surface 50 configured as one of a grill (FIG. 12), a griddle (FIG. 16) and a baking stone (FIG. 41). These are just a few examples of how the accessories and accessory engagement structures are utilized to reconfigure the inventive multi-configure outdoor cooking grill for many different cooking techniques, many of which are not traditionally done on a conventional outdoor cooking grill. The cooking techniques that are available from the multi-configurable outdoor cooking grill include, but are not limited to; bake, barbecue, blanch, boil, braise, brew, broil, brown, coddle, curry, decoct, deep fry, escallop, fricassee, fry, griddle, grill, panfry, parboil, reduce, roast, sauté, scald, scorch, sear, simmer, sizzle, steam, steep, stew, and toast.

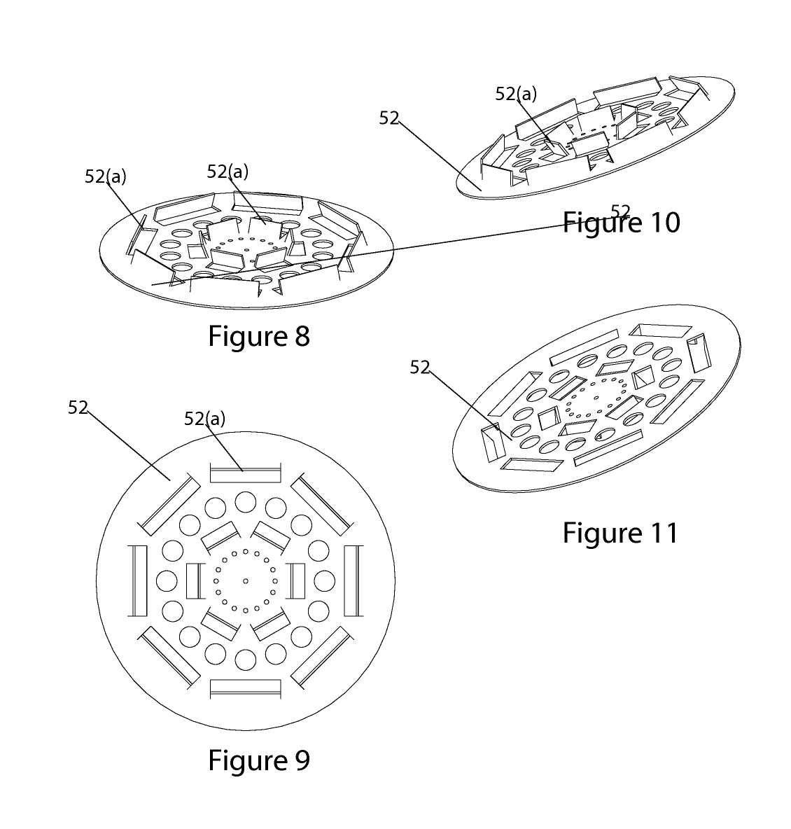

FIG. 8 is a perspective view of the heat spreader/sear plate accessory 52 showing air diversion flaps 52(a). FIG. 9 is a perspective view of the heat spreader accessory 46 showing the air diversion flaps 52(a). FIG. 10 is a top 14 view of the heat spreader accessory 46. FIG. 11 is a bottom perspective view of the heat spreader accessory 46. The heat spreader/sear plate 52 is in thermal communication with the first burner 54 and the second burner 56 for distributing the heat energy from the respective first and second burner 54,56 into a predetermined pattern.

FIG. 12 is a perspective view of the embodiment of the inventive outdoor cooking grill showing a grill accessory 46. In this case, the grill accessory 46 is also the grill cooking surface 50. The heat spreader accessory 46 may be used to create a more uniform heat at the grill cooking surface 50. Alternatively, the heat spreader may be removed to create a zoned heat at the grill cooking surface, with the heat of each of the burners 54, 56 independently controlled to create a desired cooking temperature and technique. For example, the inner burner 54 can be adjusted to high flame for fast outside searing of a steak, and the outer burner 56 adjusted to low flame for slow cooking of the steak. With this controllable cooking zone configuration of the grill, a medium rare steak can be cooked by first searing the steak on one side in the center of the grill surface, then searing the steak on the other side in the center of the grill surface, then moving the steak to the outer portions of the grill surface for slow, even cooking through out the thickness of the steak. After allowing the steak to rest for a few minutes off the grill, an excellently grilled medium rare steak is obtained.

An important aspect of the inventive grill is the utilization of the top 14 in the cooking and/or in keeping foods warm that are cooked on the interchangeable cooking surface 50. By the inventive construction described herein and shown in the drawings, the top 14 is thermally separated from the accessory 46 and/or the cooking surface 50. For example, the top 14 may not be directly hit by the flame (or at least not as strongly hit) as the cooking surface 50. Also, since the cooking surface 50 is not integral with the top 14, there is always some level of thermal isolation between the top 14 and the cooking surface 50. Thus, the top 14 is heated to a lower temperature than the cooking surface 50 and is suitable for performing its intended function of providing a relatively cooler surface to keep foods warm, facilitate carry-over cooking, or gently warm a food item such as a hamburger roll. The top 14 completely (as shown, for example in FIG. 12) or partially (not shown) encompasses the interchangeable cooking surface 50. When heat is applied to the interchangeable cooking surface 50 the top 14 achieves a relatively lower temperature than the interchangeable cooking surface 50 so that foods cooked on the interchangeable cooking surface 50 at a relatively higher temperature can be moved to the top 14 to be kept warm or continue cooking at the relatively lower temperature. For example, as shown in FIG. 12, a steak cooked on the grill can be removed from the grill cooking surface 50 and allowed to rest on the top 14. The top 14 provides a convenient location to allow the steak to rest to complete the carry-over cooking of the steak to perfection. Also, since the top achieves a relatively warm temperature, while the grill achieves a relatively hot cooking temperature, the top can be used to warm rolls, or keep food items cooked on the grill warm so that an entire meal can be kept at a suitable serving temperature.

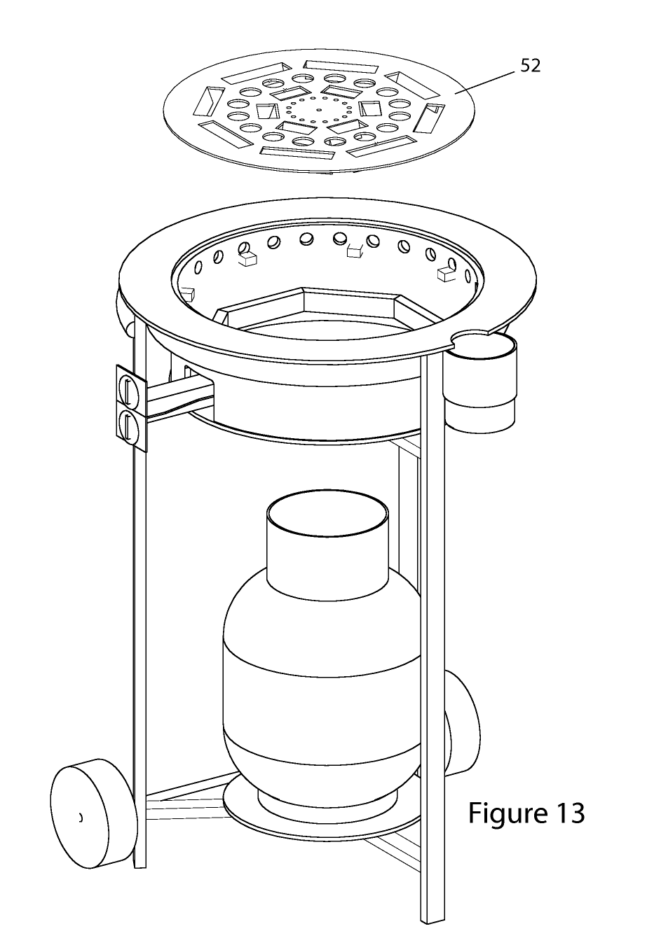

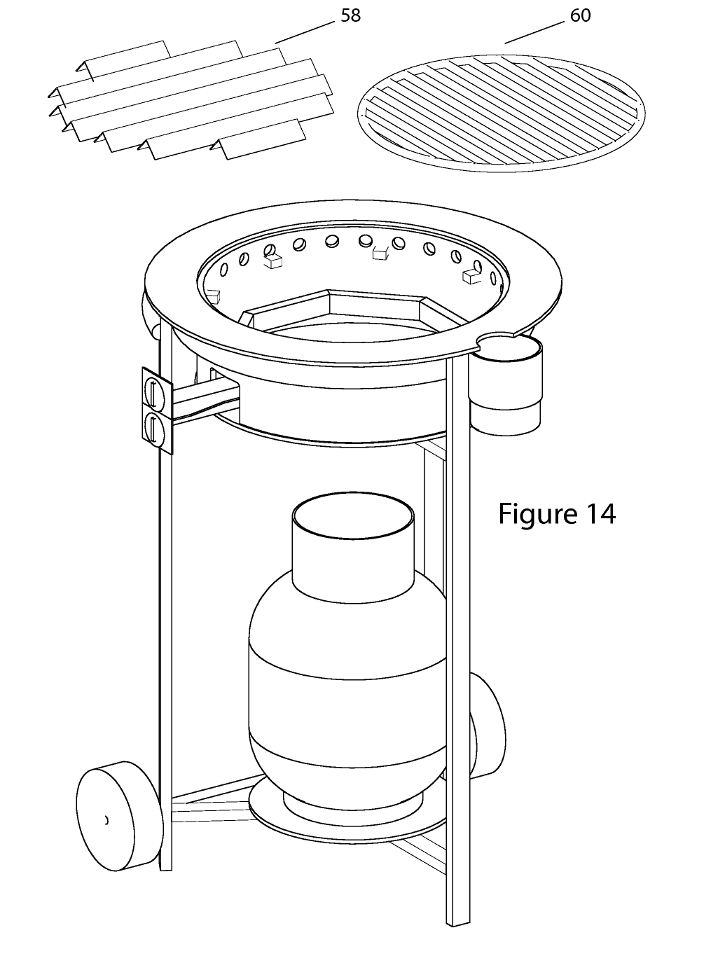

FIG. 13 is an exploded perspective view of the embodiment of the inventive outdoor cooking grill showing the cooking surface as a grill accessory 46. FIG. 14 is an exploded perspective view of the embodiment of the inventive outdoor cooking grill showing alternative heat spreaders in the form of sizzle/smoke bars 58 and a ceramic rock grate 60.

FIG. 15 is a perspective view of the embodiment of the inventive outdoor cooking grill configured with a round griddle. FIG. 16 is an exploded perspective view of the embodiment of the inventive outdoor cooking grill showing the round griddle and griddle ring. This configuration illustrates an embodiment wherein the accessory 46 comprises a griddle cooking surface 50 having a scrap hole 62, and wherein the top 14 includes a scrap cutout 22 that corresponds to the scrap hole 62.

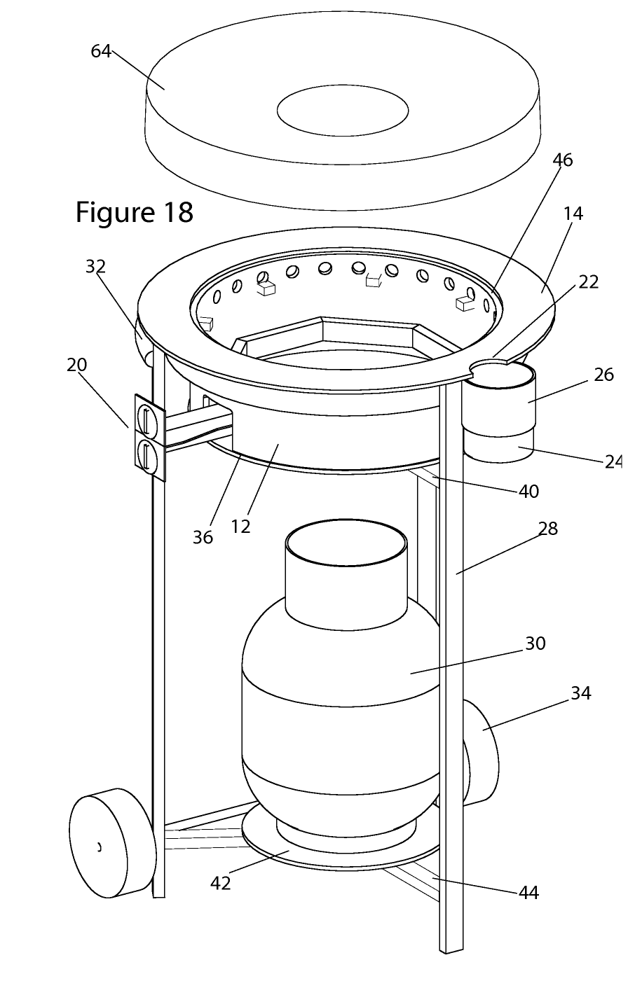

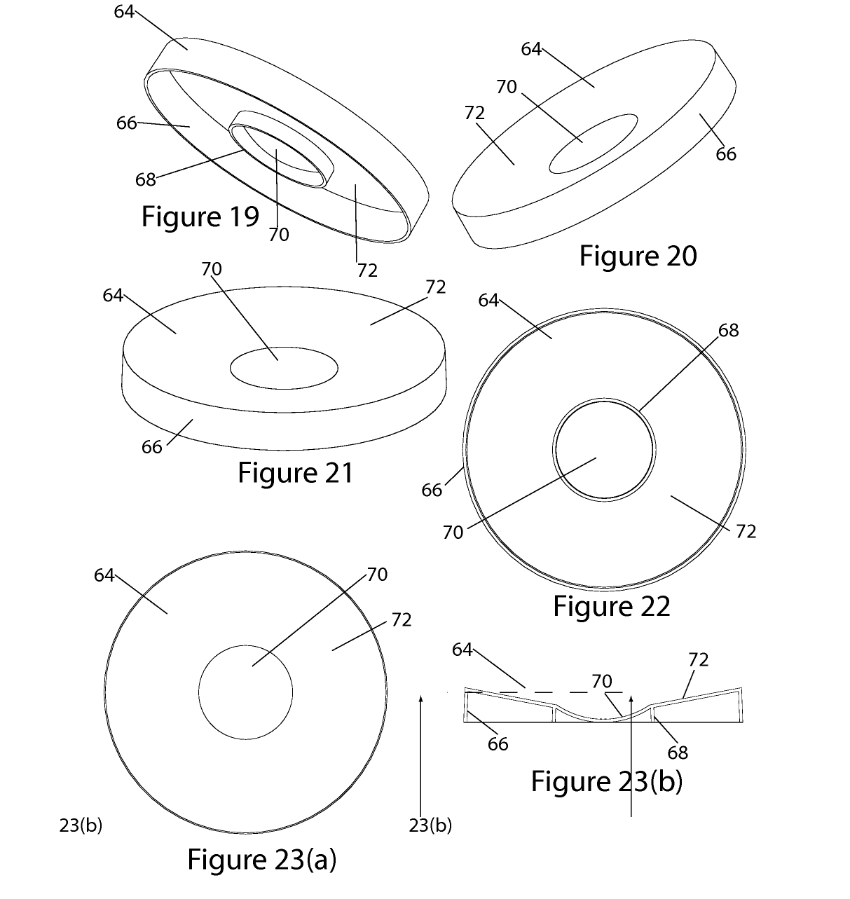

FIG. 17 is a perspective view of the embodiment of the inventive outdoor cooking grill configured with an inventive sloped griddle 64. FIG. 18 is an exploded perspective view of the embodiment of the inventive outdoor cooking grill showing the inventive sloped griddle 64. FIG. 19 is a bottom perspective view of the inventive sloped griddle 64 showing the riser rim 66 and central heat baffle 68. FIG. 20 is a top perspective view of the inventive sloped griddle 64 showing the collection bowl 70 and sloped sides 72. FIG. 21 is a perspective view of the inventive sloped griddle 64. FIG. 22 is a bottom view of the inventive sloped griddle 64. FIG. 23(a) is a top 14 view of the inventive sloped griddle 64. FIG. 23(b) is a cross section along sight line 23(b) showing in FIG. 23(a).

In accordance with the inventive sloped griddle 64 cooking implement, a cooking implement is provided that includes an inner side portion with a central bowl area 70 having a relatively steep sloped grade. An outer side portion circumferentially encompasses the central bowl. The outer side portion includes a sloped side area 72 encompassing at least a portion of the central bowl area and having a relatively shallow slope grade effective to enable solid foods placed on the sloped side area 72 to remain on the sloped side area 72 during cooking and liquids in contact with the sloped side area 72 to flow towards and into the central bowl area 70 through the action of gravity.

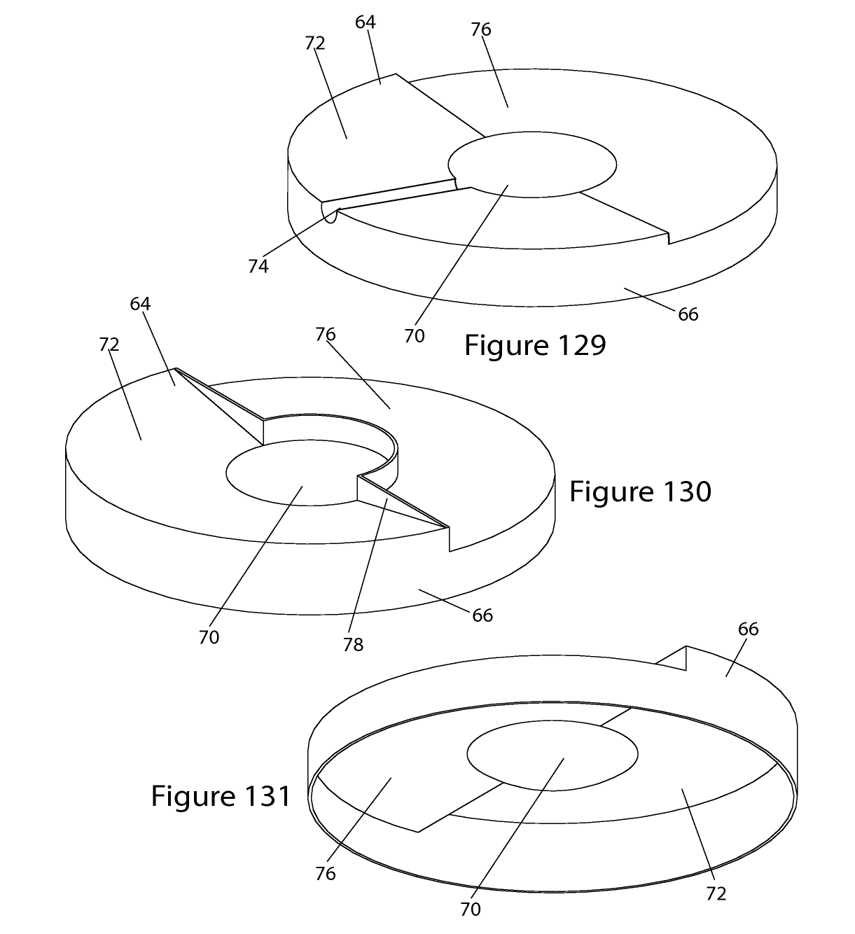

FIG. 129 is a perspective view of an embodiment of the inventive sloped griddle 64 showing a bowl drainage channel 74. FIG. 130 is a perspective view of an embodiment of the inventive sloped griddle 64 showing a flat griddle portion 76, sloped griddle portion 72, central bowl 70 and retaining wall 78. FIG. 131 is a bottom perspective view of the embodiment of the inventive sloped griddle 64 shown in FIG. 130.

In accordance with an embodiment of the inventive sloped griddle 64, the channel structure 74 is provided between the inner side and an outside edge of the outer side for conveying liquid from the central bowl area 70 to outside the sloped griddle cooking implement 64.

In accordance with another aspect of the inventive sloped griddle 64, the sloped side 72 encompasses a portion of the central bowl area 70 and a flat horizontal side area 76 provided encompassing another portion of the central bowl area 70. This configuration of the inventive sloped griddle 64 enables cooking items, such as pancakes, eggs, and other foods that would flow too much if cooked on the sloped side area 72.

Also, as shown in FIG. 19, the sloped griddle 64 has a bottom that is heated by a heat source, such as the burner assembly 20 shown in the embodiments of the inventive outdoor cooking grill. A heat baffle 68 is provided providing a thermal barrier between the inner side portion (e.g., bowl area 70) and the outsider side portion (e.g., sloped side 72). This heat baffle 68 enables the central bowl area 70 to be more effectively kept at a separate temperature than the outer side portion (sloped side 72) of the sloped griddle 64 when heat is applied, for example, by the center fast burner 54 to the inner side portion and by the outer ring burner 56 to the outer side portion. This controlled heating of the sloped griddle 64 areas enables, for example, meats to be seared on the outer side portion (sloped side 72) with relatively high heat applied by the outer ring burner, while the meat drippings that collect in the central bowl area 70 to be heated more gently by the center fast burner 54, then, the seared meat can be brought to the relatively cooler outer edges of the sloped griddle 64 to rest with the outer ring burner 56 turned off, while the heat from the center fast burner 54 is brought up to reduce, for example, wine or other liquid added to the collected meat drippings to make a sauce or gravy.

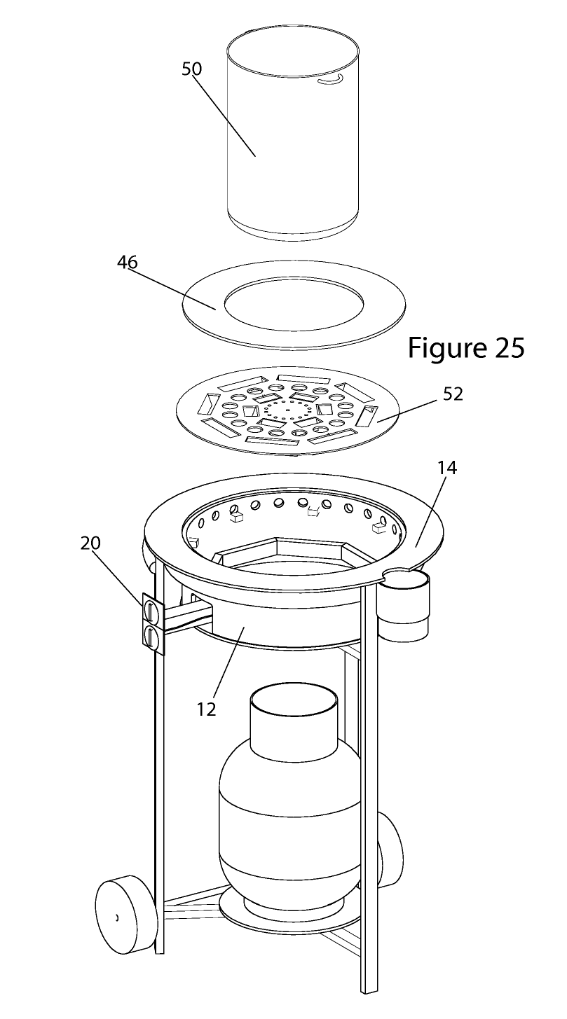

The inventive multi-configurable outdoor cooking grill can be configured for many cooking techniques using existing cookware already owned by a user. For example, FIG. 24 is a perspective view of the embodiment of the inventive outdoor cooking grill configured with the wok accessory ring 46 used to retain a tall turkey fryer pot cooking surface 50. FIG. 25 is an exploded perspective view of the embodiment of the inventive outdoor cooking grill showing the tall turkey fryer pot 50, wok ring accessory 46 and upside heat spreader/sear plate 52 providing a support for the tall turkey fryer pot 50.

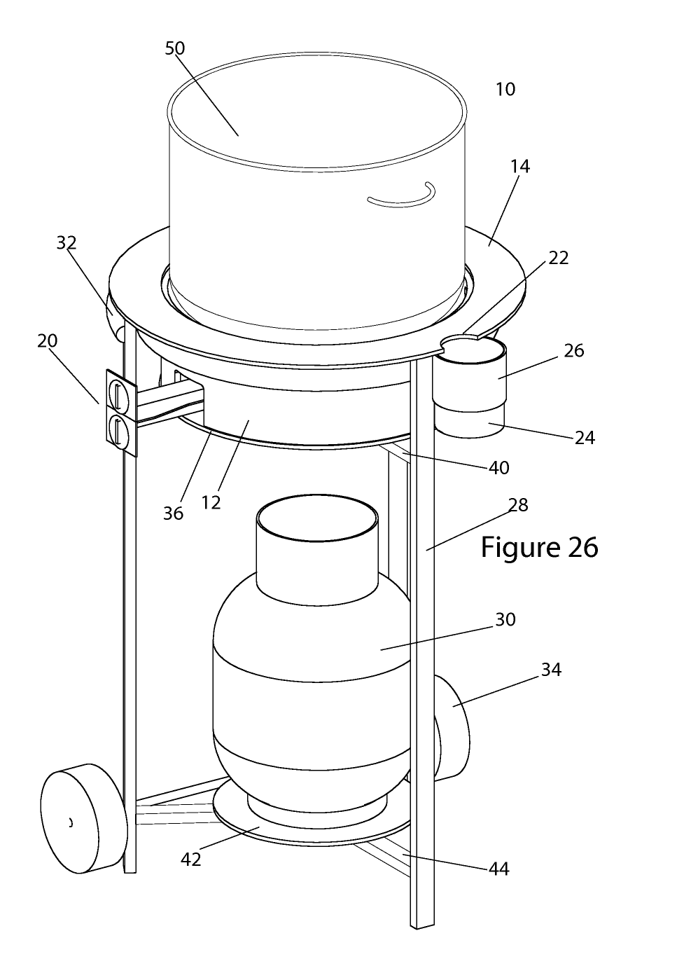

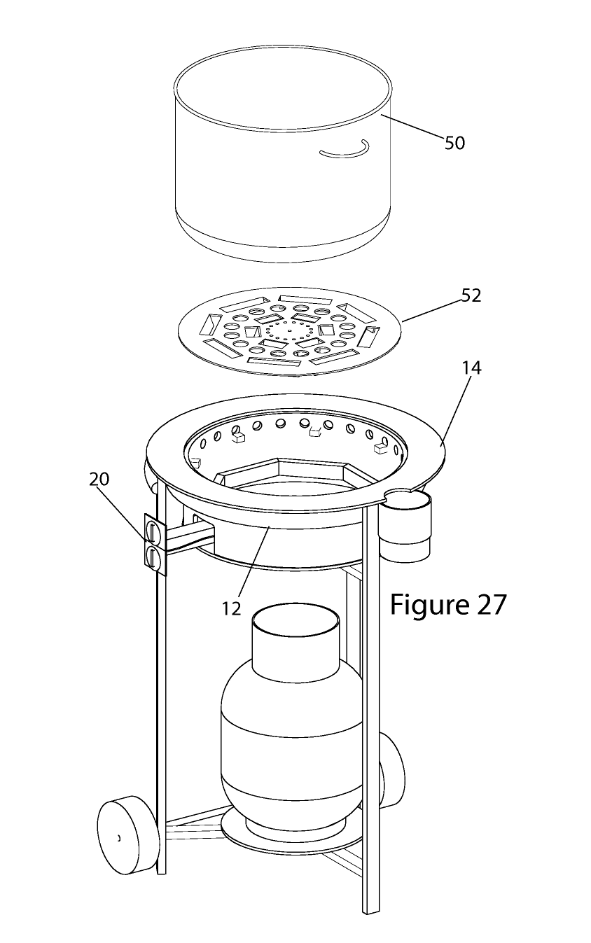

With a slight reconfiguration, removing the wok accessory ring 46, an extra-wide stockpot can be used. FIG. 26 is a perspective view of the embodiment of the inventive outdoor cooking grill configured with an extra-wide stockpot. FIG. 27 is an exploded perspective view of the embodiment of the inventive outdoor cooking grill showing the extra-wide stockpot and upside heat spreader providing a support for the extra-wide stockpot.

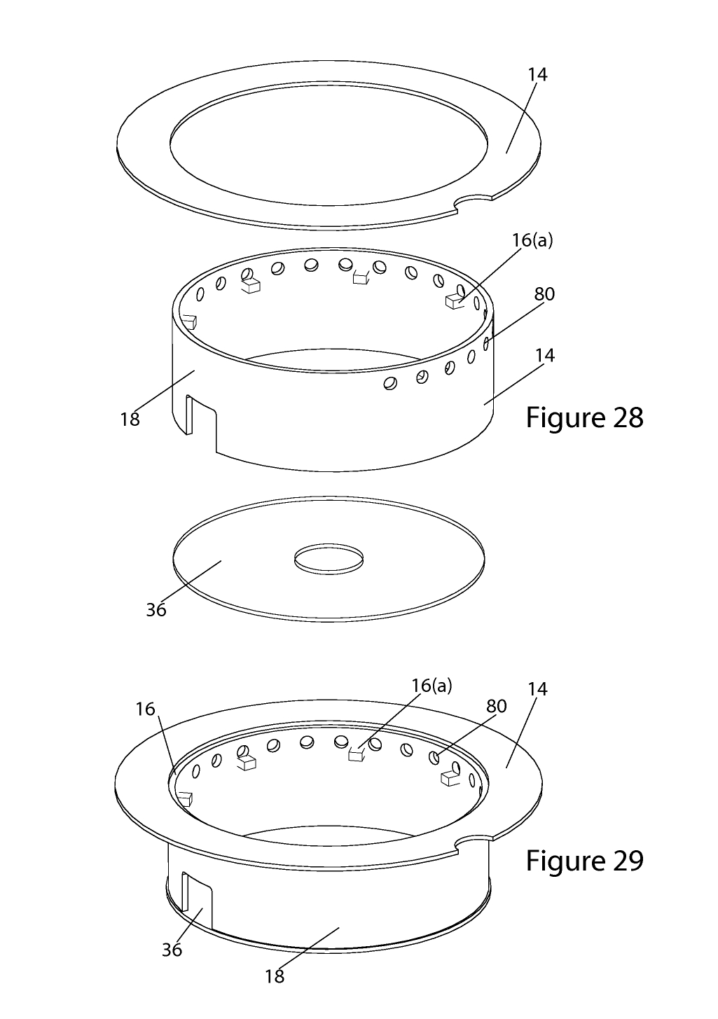

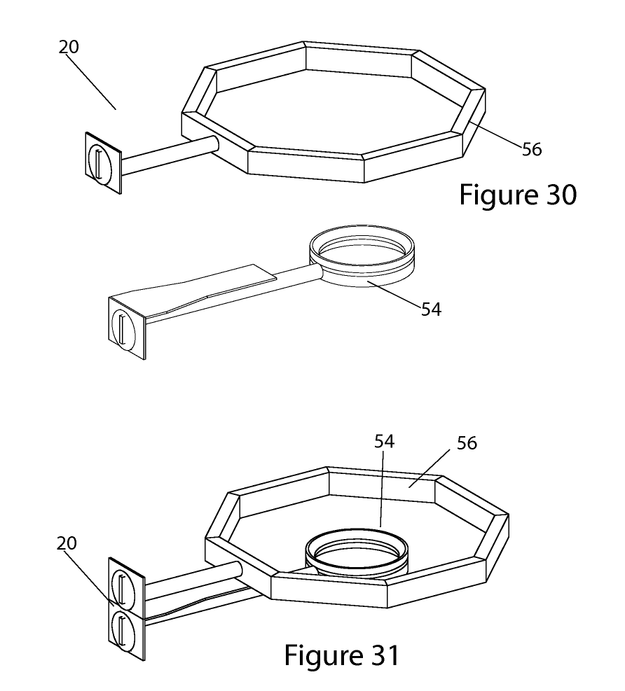

FIG. 28 is an exploded view of the inventive fire unit 12. FIG. 29 is an assembled view of the inventive fire unit 12. FIG. 30 is an exploded view of an inventive two-burner assembly 20. FIG. 31 is an assembled view of the inventive two-burner assembly 20. The burner assembly 20 can include a first burner 54 (e.g., fast IR/blue flame burner shown) for combusting a compressed flammable gas for providing a concentrated source of heat energy to an area of a cooking surface 50, and a second burner 56 (e.g., ring tube burner shown) for combusting a compressed flammable gas for providing a distributed source of heat energy to a different area of the cooking surface 50. As shown in FIGS. 28 and 29, a heat containment structure (the fire unit 12) contains the heat energy from the first and the second burner 54, 56 and directs the heat energy towards the cooking surface 50. The heat containment structure includes an airflow ventilation system 80 configured and dimensioned so that airflow needed for combusting the compressed flammable gas is effective for each cooking configuration of the cooking grill. For example, when wok cooking with the wok stand 48, the sides of the wok stand 48 provide a guide for the hot gasses to flow upwards towards the wok pan, and the geometry of the stand enables proper air flow. The airflow ventilation system 80 of the heat containment structure provides additional airflow movement and thus prevents the hot gasses caused by the combustion to become bottled up. When the inventive multi-configurable outdoor cooking grill is configured as a griddle, this airflow ventilation system 80 becomes even more important to ensure that there is proper airflow for safe and efficient combustion of the compressed flammable gas. The airflow ventilation system 80 can include controllable airflow restriction structures (such as repositionable vent covers, not shown) for controlling the airflow depending on the cooking configuration to improve the effectiveness of the combusting of the compressed flammable gas.

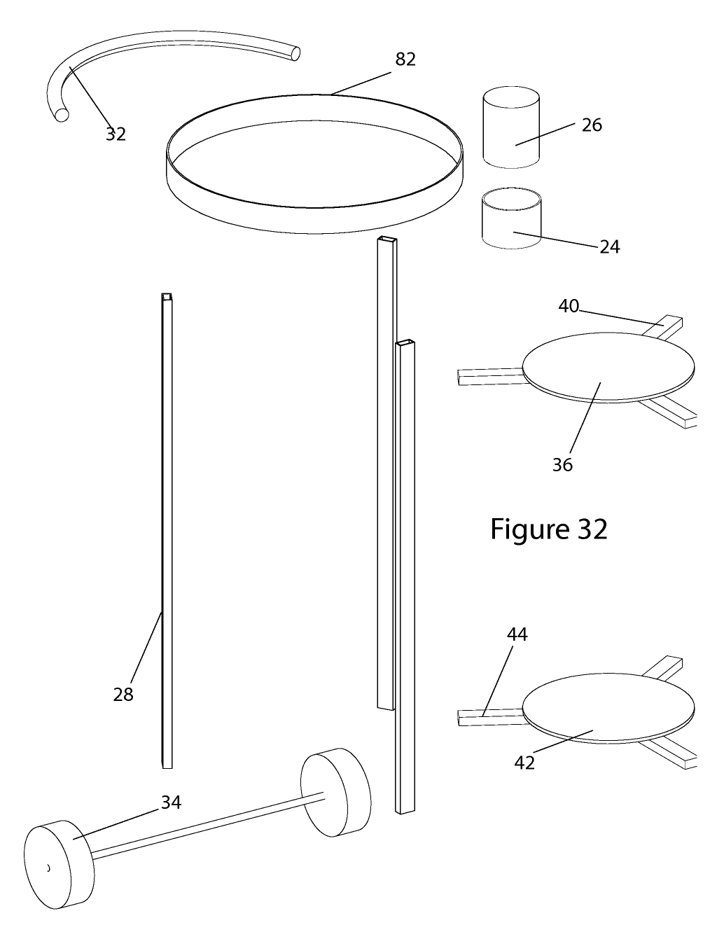

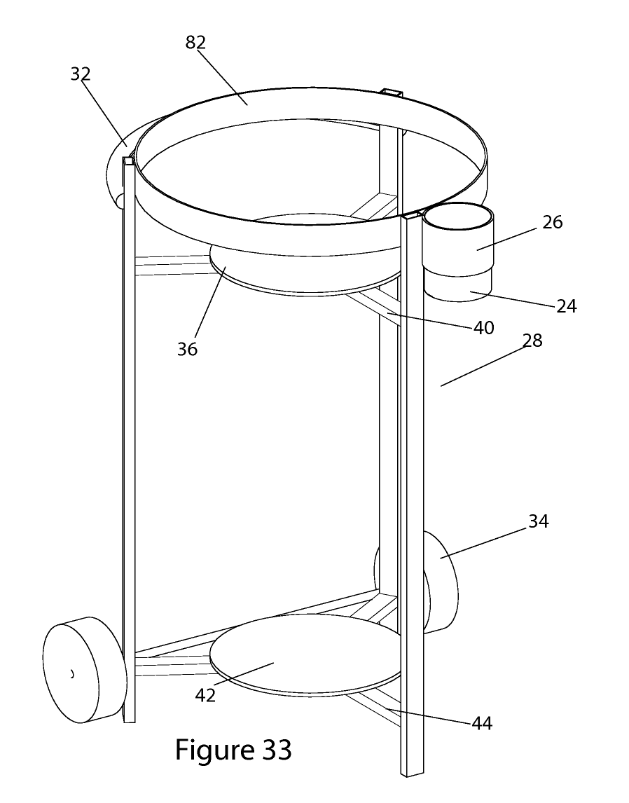

FIG. 32 is an exploded view of a stand frame 28 configuration for the inventive outdoor cooking grill. FIG. 33 is an assembled view of the stand frame 28 configuration for the inventive outdoor cooking grill. To protect the user from feeling too much heat, the airflow ventilation system 80 can be provided towards the back side of the heat containment structure and further, in accordance with an embodiment of the present invention, a stand ring 82 is provided to support the top 14 (and the cooking surface 50, accessory 46, burner assembly 20, etc.) and provide a heat shield to direct hot flowing air away from the user.

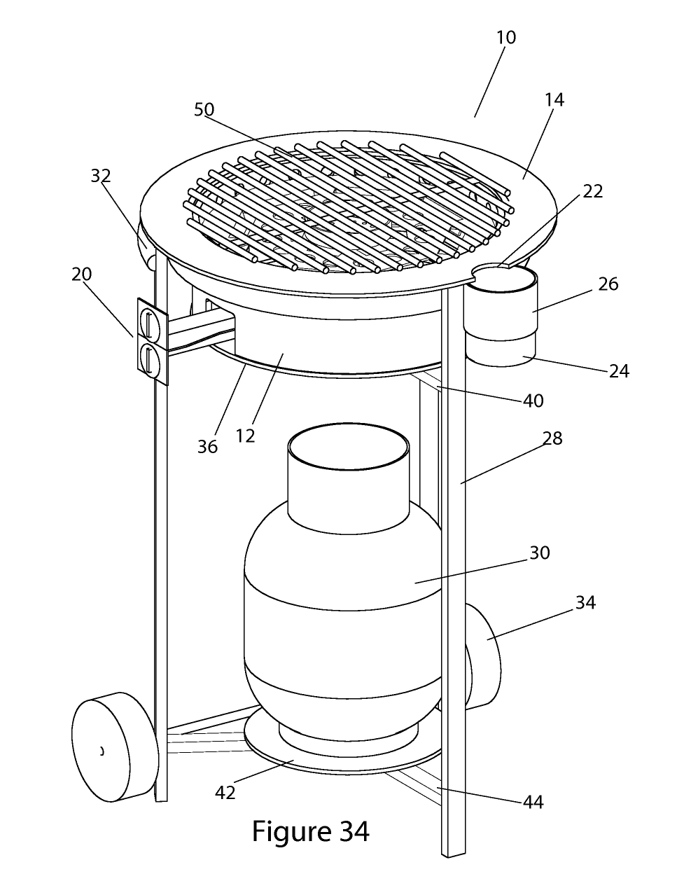

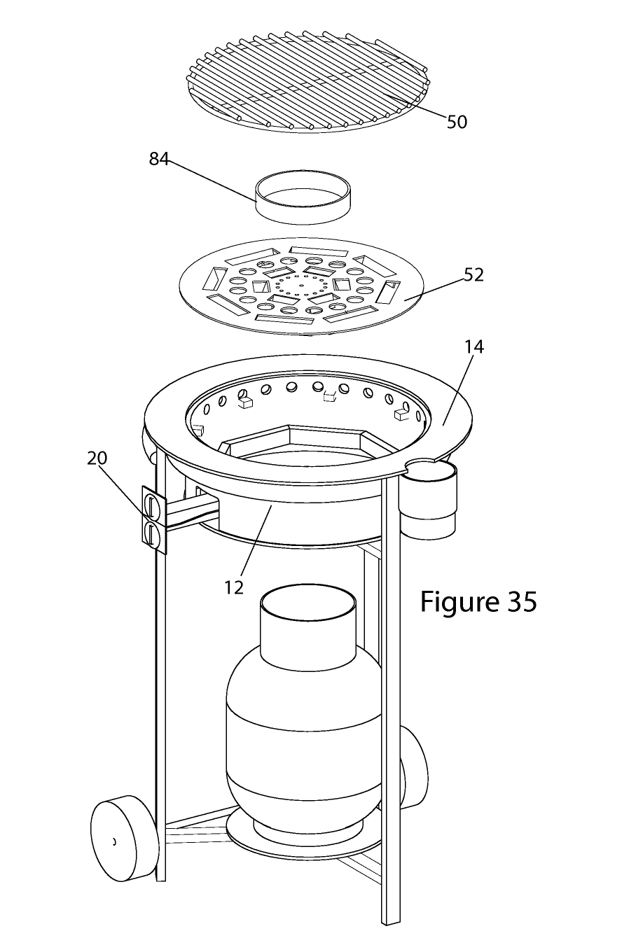

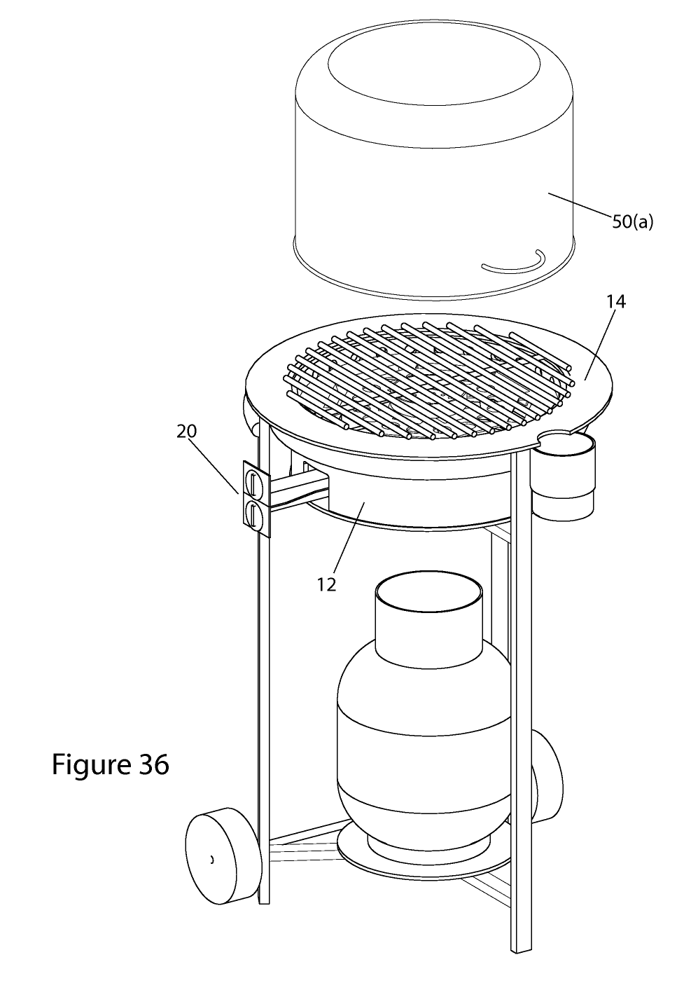

The same accessories 46 and cooking surfaces 50 can be utilized in a variety of arrangements to enable multiple cooking techniques. For example, FIG. 34 is a perspective view of the inventive outdoor cooking grill configured as a multiple heat zone grill with the inventive two-burner assembly 20 creating a central searing zone and an outer warming zone. FIG. 35 is an exploded perspective view of the inventive outdoor cooking grill configured as a multiple heat zone grill and having a smoke ring 84 provided for retaining wood chips in contact with the heat spreader/sear plate 52. FIG. 36 is an exploded view of the inventive outdoor cooking grill configured as a multiple heat zone grill and using the extra-wide stockpot as a smoker/baking oven lid 50(a). FIG. 37 is a perspective view of the inventive outdoor cooking grill showing a large wok supported directly on the wok ring accessory 46. FIG. 38 is an exploded perspective view of the inventive outdoor cooking grill showing the large wok and the wok ring accessory 46. FIG. 39 is a perspective view of the inventive outdoor cooking grill configured as a smoker/baking oven incorporating an inventive riser ring 86 and using the large wok turned upside down as a lid 50(a). FIG. 40 is an exploded perspective view of the inventive outdoor cooking grill configured as a steamer with the inventive sloped griddle 64 and the large wok turned upside down as a lid 50(a).

FIG. 41 is an exploded perspective view of the inventive outdoor cooking grill configured as a baking oven showing the inventive riser ring 86 for supporting a baking stone. FIG. 42 is an exploded perspective view of the inventive outdoor cooking grill configured as a baking oven with the extra-wide stockpot as a lid 50(a). FIG. 43 is a perspective view of the inventive outdoor cooking grill configured as a shish kabob cooker using the inventive riser ring 86. FIG. 44 is a perspective view of the fire unit 12 with a steam/smoker/baking rack 88 and using the extra-wide stockpot as a lid 50(a).

An advantage of the inventive multi-configurable outdoor cooking grill is the repurposing and multi-tasking of the accessories 46 and cooking surfaces 50 to enable many cooking techniques while limiting the need, cost and space required for additional manufactured and assembled components. For example, the wok cooking surface 50 can be turned upside down and utilized as a lid 50(a) for various cooking configurations, such as steaming, smoking, baking and covered grilling. In accordance with the present invention, a telescoping lid clamping mechanism 90 may be used to enhance the functionality of this multi-tasking feature. Alternatively, instead of re-purposing the wok cooking surface 50, a dedicated lid may be used.

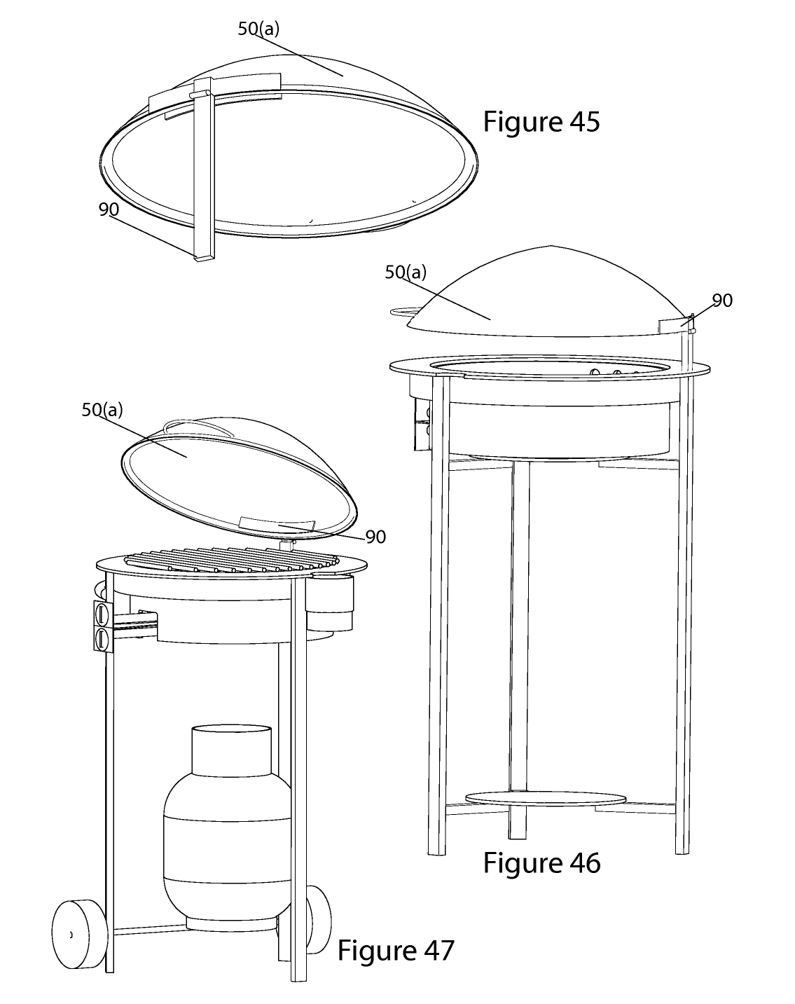

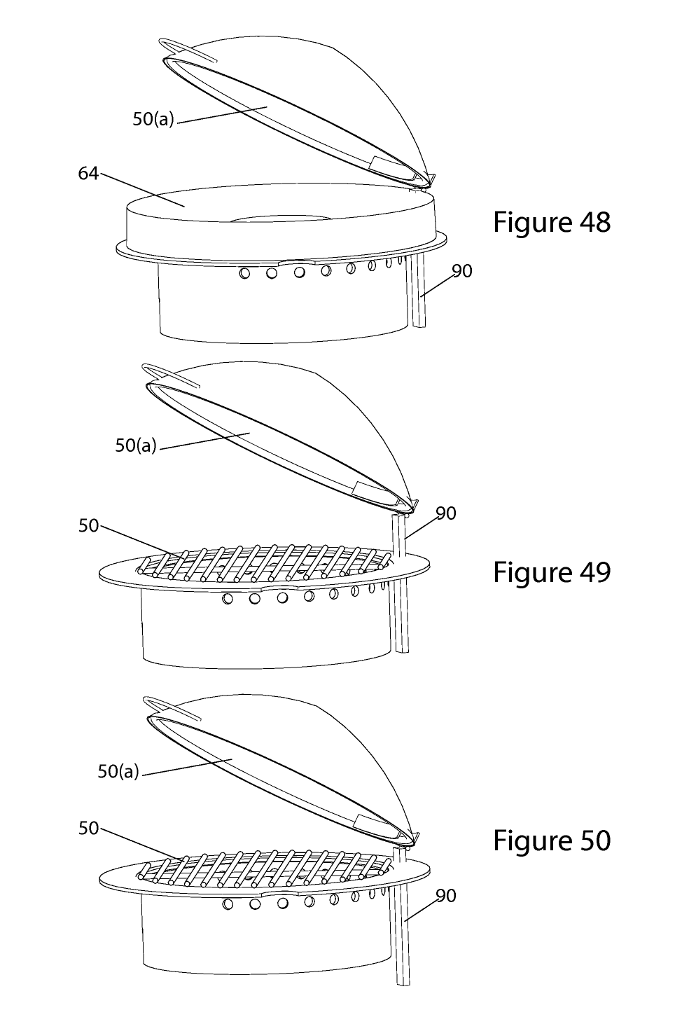

FIG. 45 is an isolated view showing the large wok with an inventive telescoping lid-clamping mechanism 90. FIG. 46 is a perspective view of the inventive outdoor cooking grill configured with the inventive telescoping lid-clamping mechanism 90 holding a large wok as a lid 50(a). FIG. 47 is a perspective view of the inventive outdoor cooking grill showing the large wok supported by the inventive telescoping lid-clamping mechanism 90. FIG. 48 is an isolated view of the fire unit 12 with the large wok supported by the inventive telescoping lid-clamping mechanism 90 raised to accommodate the inventive sloped griddle 64. FIG. 49 is an isolated view of the fire unit 12 with the large wok supported by the inventive telescoping lid-clamping mechanism 90 in a raised position to reduce flare-ups on the grill. FIG. 50 is an isolated view of the fire unit 12 with the large wok supported by the inventive telescoping lid-clamping mechanism 90 in a lowered position to cover the grill surface. FIG. 51 is a perspective view of the inventive outdoor cooking grill showing the large wok supported by the inventive telescoping lid-clamping mechanism 90 raised to accommodate the inventive sloped griddle 64 configured with the grill as a steamer. FIG. 52 is an exploded view of an embodiment of the inventive telescoping lid-clamping mechanism 90. In this aspect of the invention, two woks are used to create a double wall lid 50(a) that is held by the lid-clamping mechanism 90. The double walls provide better thermal insulation to keep the interior cooking area hotter and the exterior of the lid cooler.

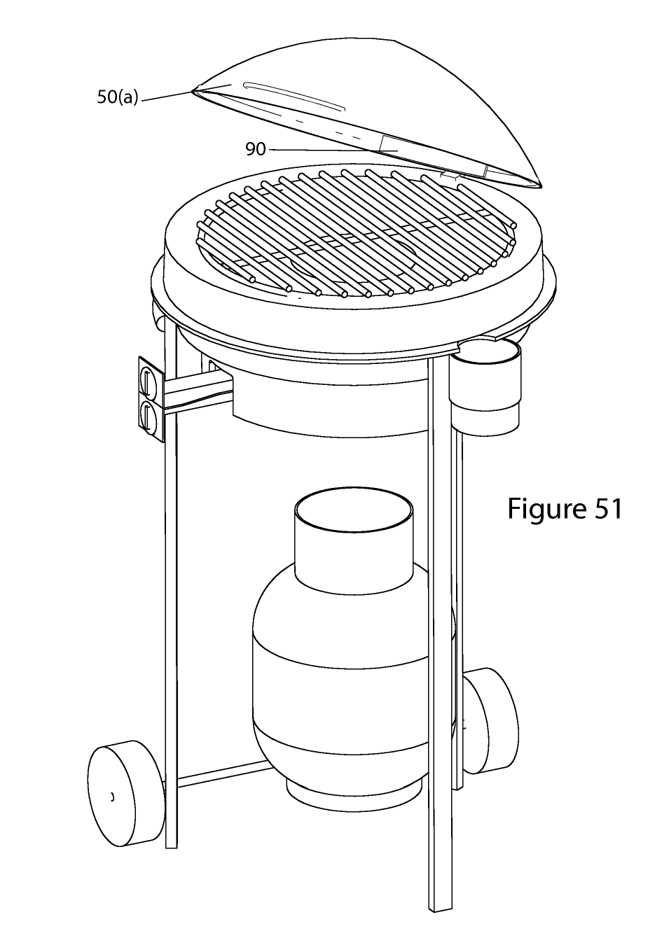

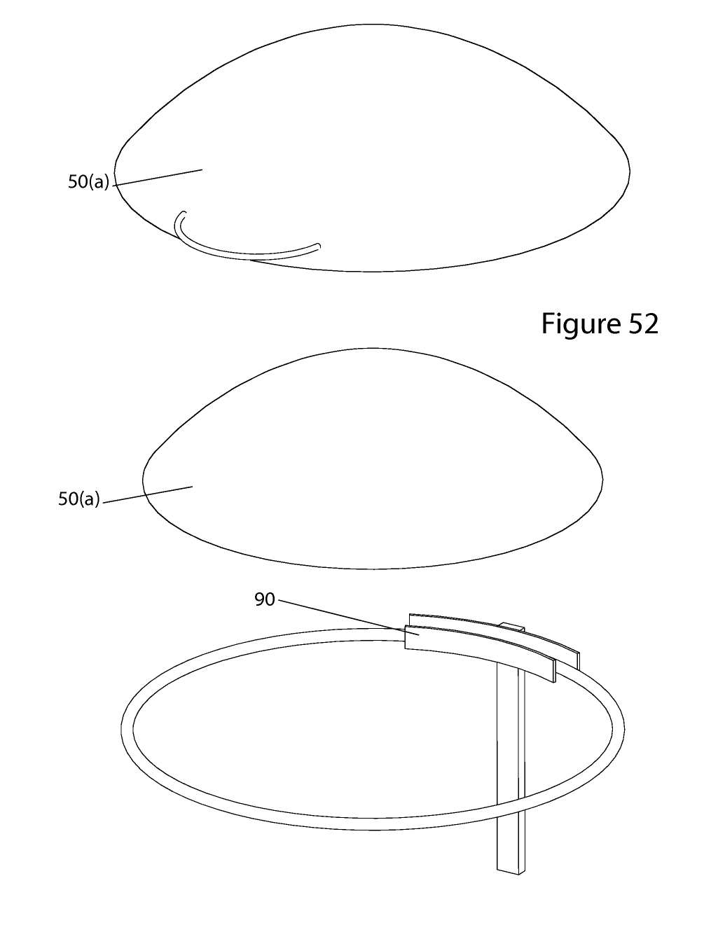

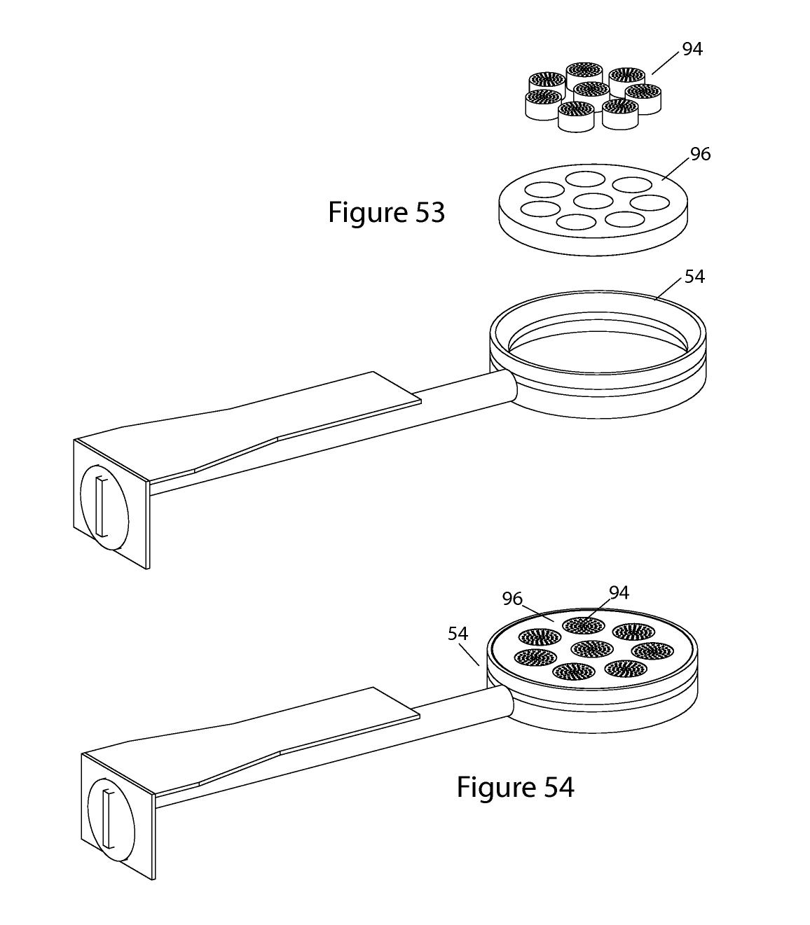

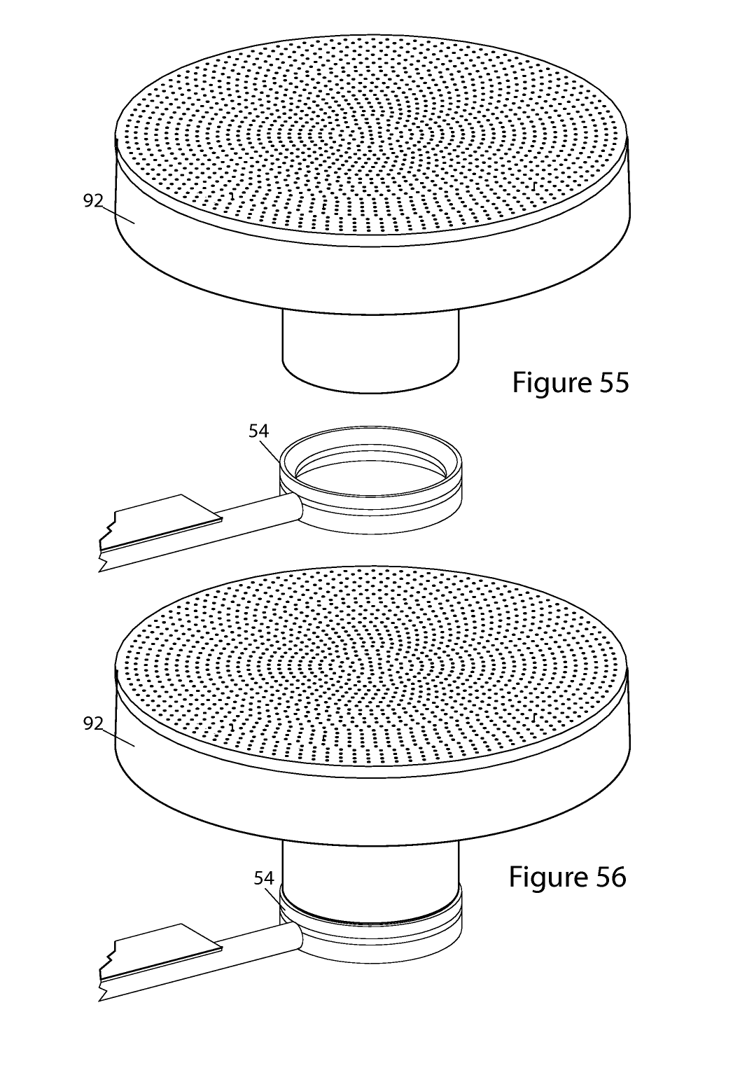

In accordance with the present invention, a multi-burner unit is provided that works in conjunction with the accessories and cooking surfaces 50 to make a myriad of cooking techniques available from the inventive outdoor cooking grill. Examples of cooking techniques made available include grill, griddle, wok, discata, sauté, bake, sear, deep fry, shallow fry, boil, steam, hot smoker, cold smoker, rotisserie, shish kabob, and simultaneous combinations of these techniques, such as searing and steaming simultaneously using the inventive sloped griddle 64 with the telescoping lid clamping mechanism 90 holding a upside down large wok as a steamer lid 50(a). In one embodiment, the burner unit comprises a relatively high BTU central burner for providing concentrated high heat to the cooking surface 50 and a relatively low BTU outer burner for providing distributed heat to the cooking surface 50. The burner unit may also comprise additional burners, or the burners may be split into separately controllable burners. The burners can be electric or gas burners. Examples of burner types include tube burners, jet burners, cast burners, IR burners, electric resistance burners, naturally aspirated gas burners, quartz burners, coiled resistance wire burners, duck burners, impinged jet burners, etc. Also included are embodiments of the inventive multi-configurable cooking grill that utilize solid fuel, such as wood, charcoal or coal. The burner unit may be a high BTU central burner for providing concentrated high heat to the cooking surface 50, a relatively low BTU central burner for providing low heat to the cooking surface 50, and a relatively low BTU outer burner for providing distributed heat to the cooking surface 50. This burner configuration enables the outdoor cook to employ the high BTUs necessary for properly accomplishing many cooking techniques, such as wok and searing, while having the controllability to use the same outdoor grill for gentler cooking methods such as smoking and simmering. FIG. 53 is an assembled view of the inner fast burner 54. FIG. 54 is an isolated exploded perspective view of an inventive ceramic IR conversion insert 92 for use with an inner fast burner 54. FIG. 55 is an exploded view of an inner fast burner 54 showing ceramic IR inserts 94 and cast metal gas diffuser 96.

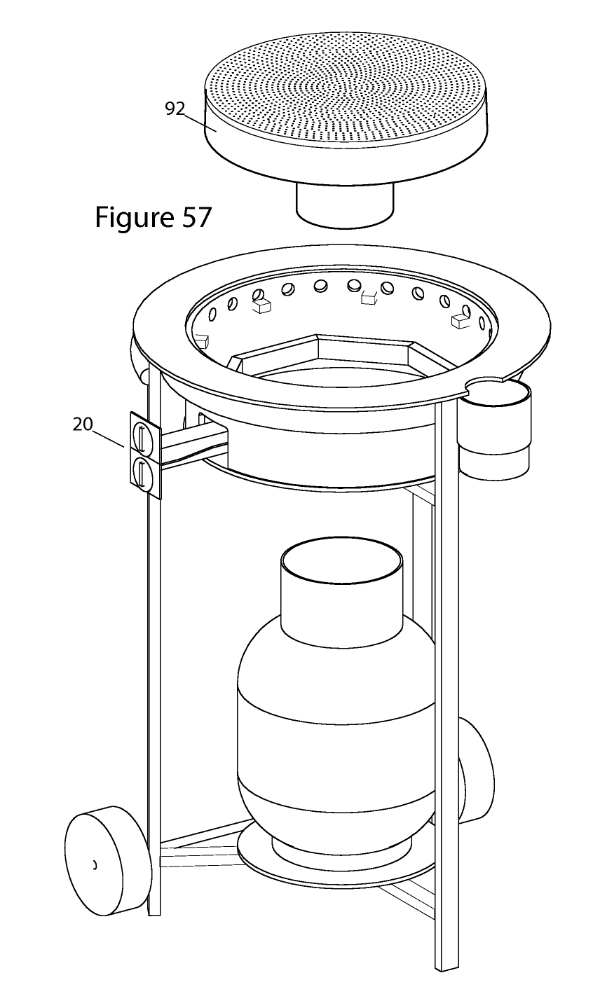

FIG. 56 is an isolated assembled view of the inventive ceramic IR conversion insert 92 assembled with the inner fast burner 54. This IR conversion insert 92 enables the inner fast burner 54 to be reconfigured as a wide area IR burner by a simple retrofit. FIG. 57 is an exploded perspective view of the inventive outdoor cooking grill showing the inventive IR conversion insert 92.

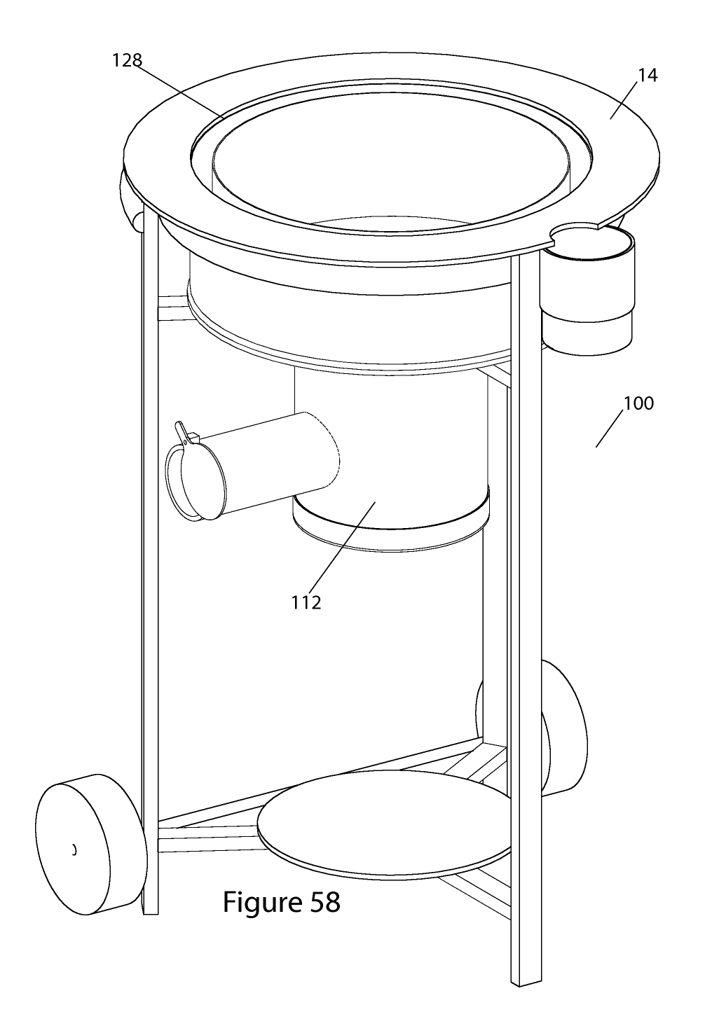

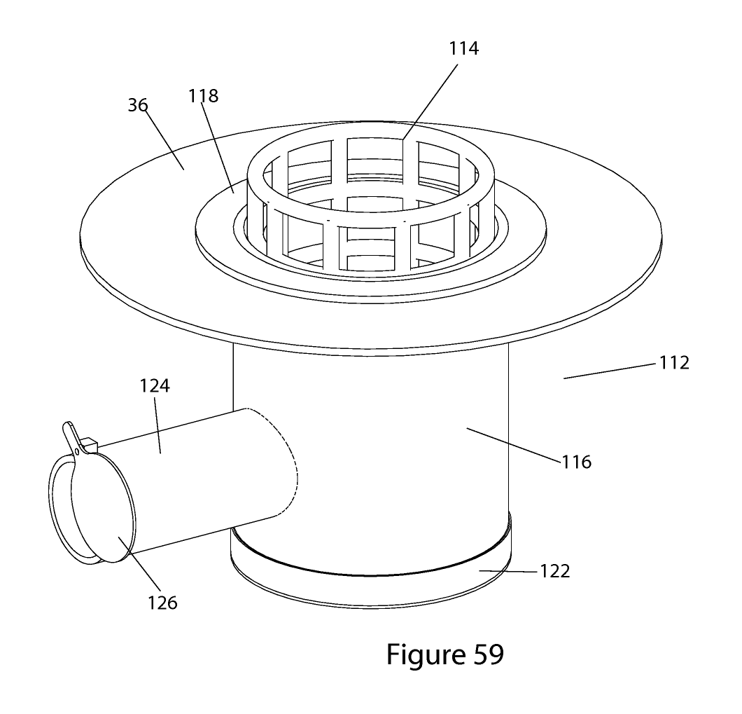

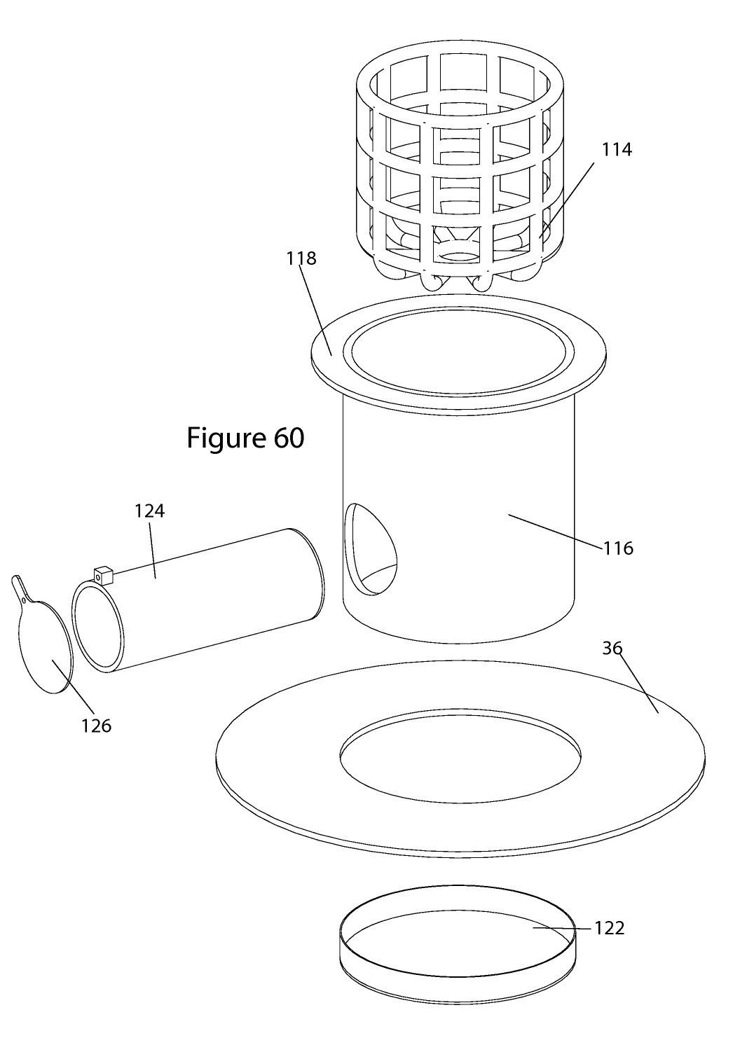

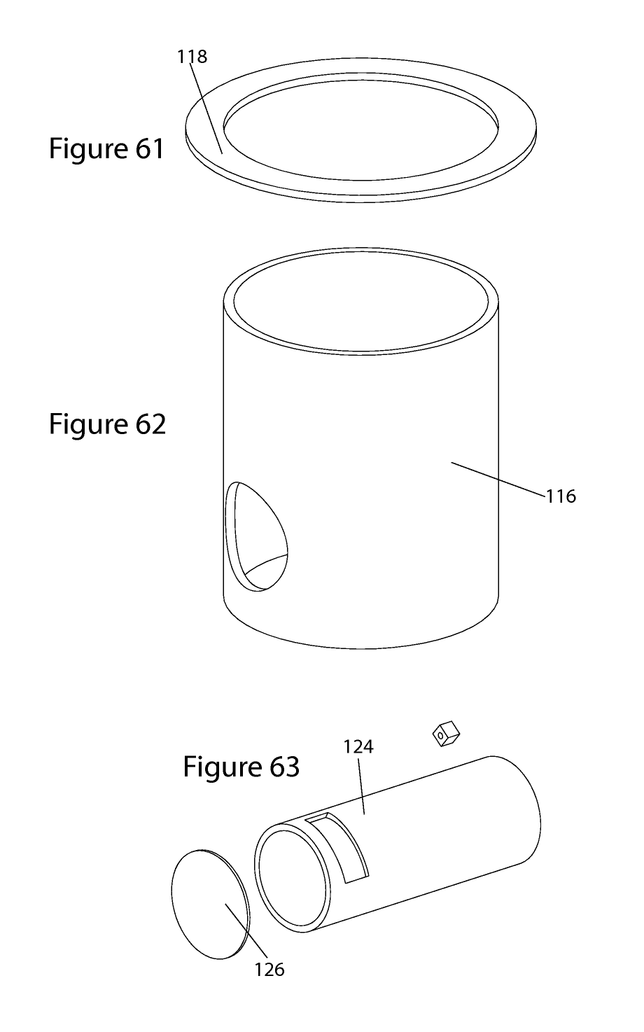

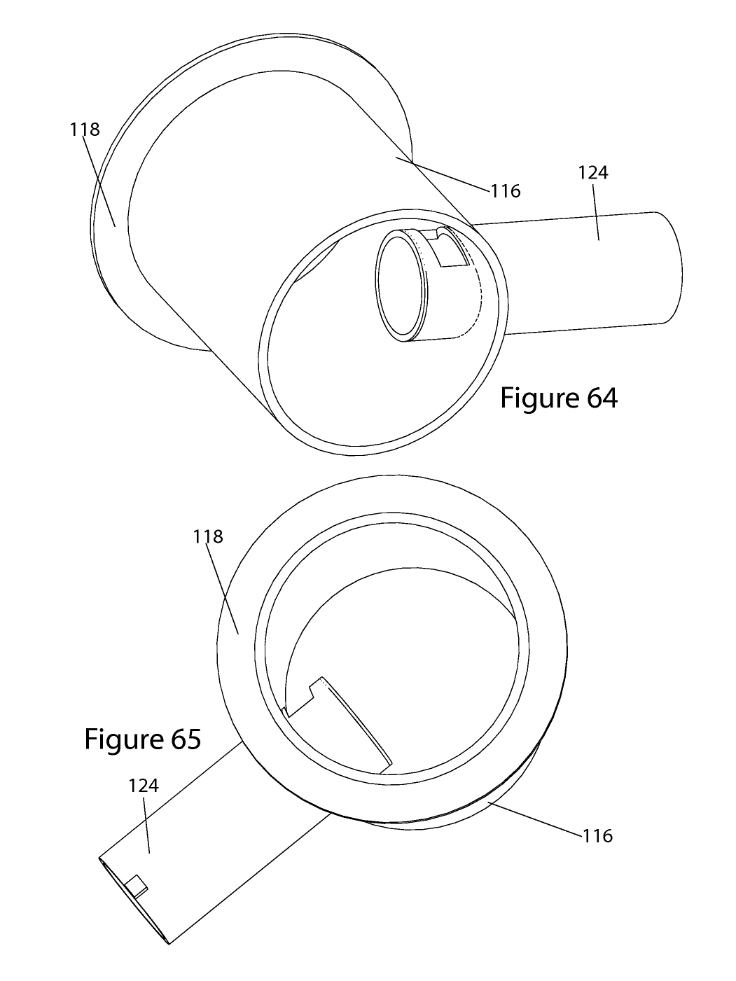

FIG. 58 is a perspective view of a solid fuel fired embodiment 100 of the inventive outdoor cooking grill having a charcoal or wood burning fire unit 112. FIG. 59 is an isolated view of the charcoal or wood burning fire unit 112 showing a fuel basket 114 inserted in a fire chamber tube 116. FIG. 60 is an exploded view of the charcoal or wood burning fire unit 12 showing the fuel basket 114, fire chamber tube 116 with integrated fire chamber flange 118, fire chamber bottom plate 120, fire chamber cap 122, air intake pipe 124 and air intake controller 126. FIG. 61 is an isolated view showing the fire chamber flange 118. FIG. 62 is an isolated view showing the fire chamber tube 116. FIG. 63 is an isolated view showing the air intake pipe 124 and air intake controller 126. FIG. 64 is a bottom perspective view showing the air intake pipe 124 assembled with the fire chamber tube 116. FIG. 65 is a top perspective view showing the air intake pipe 124 assembled with the fire chamber tube 116.

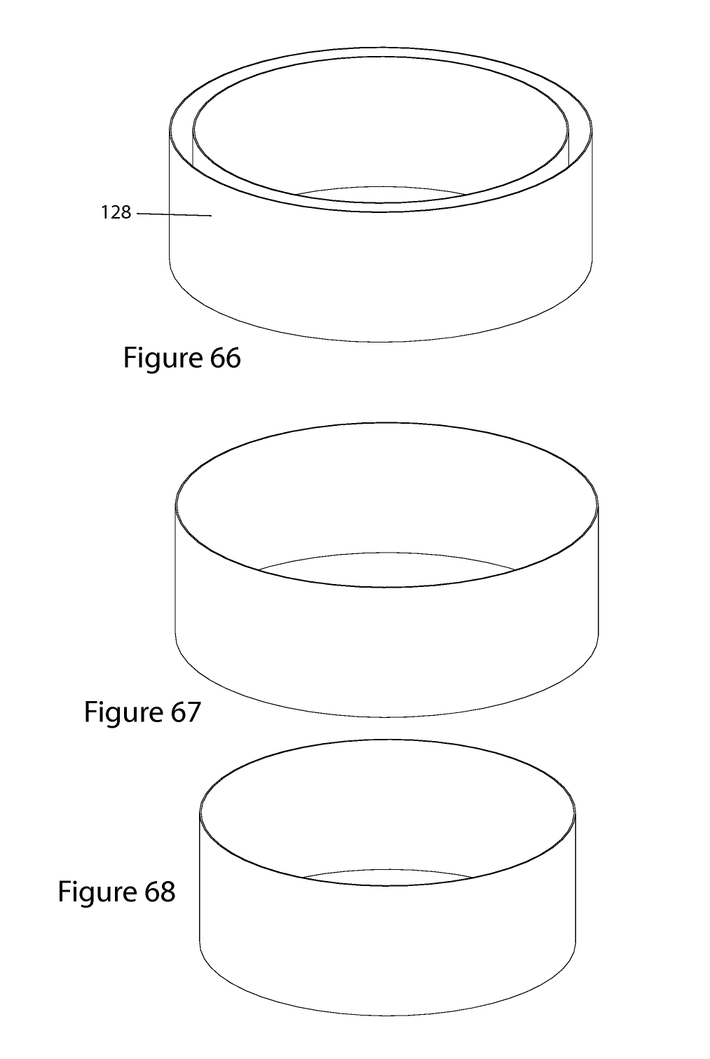

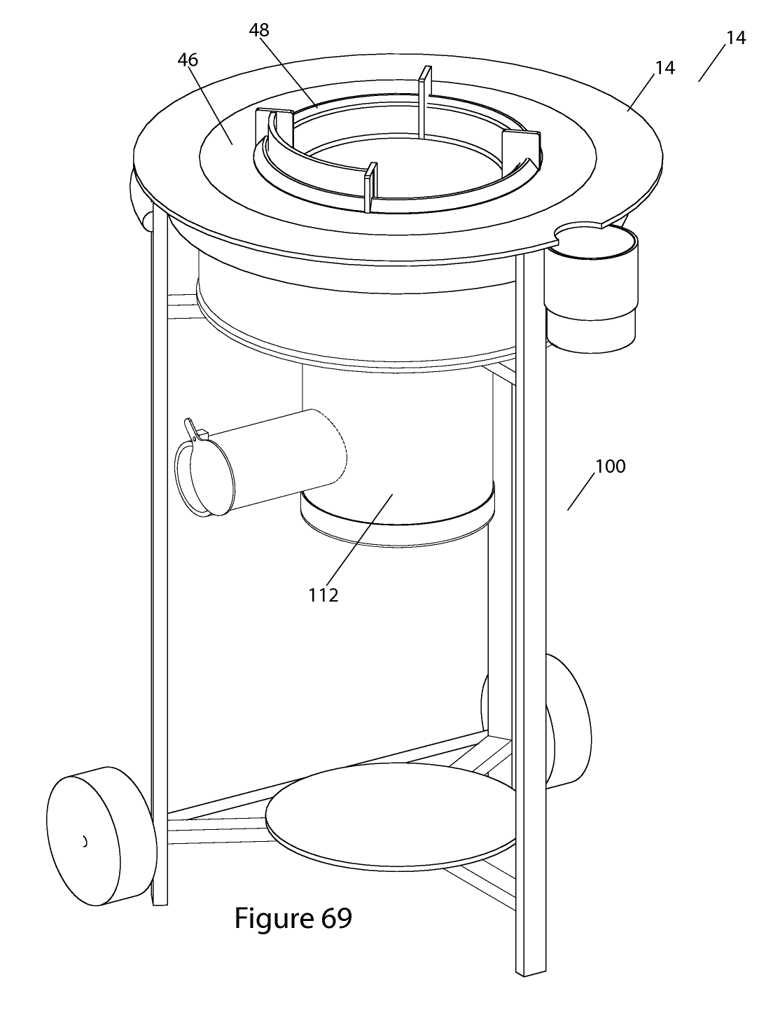

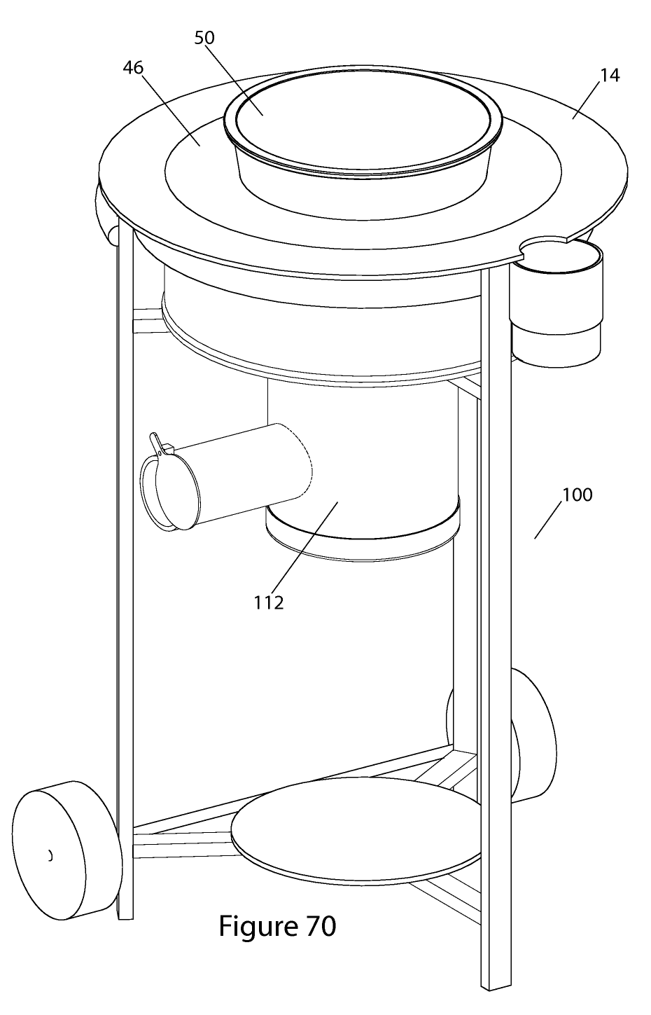

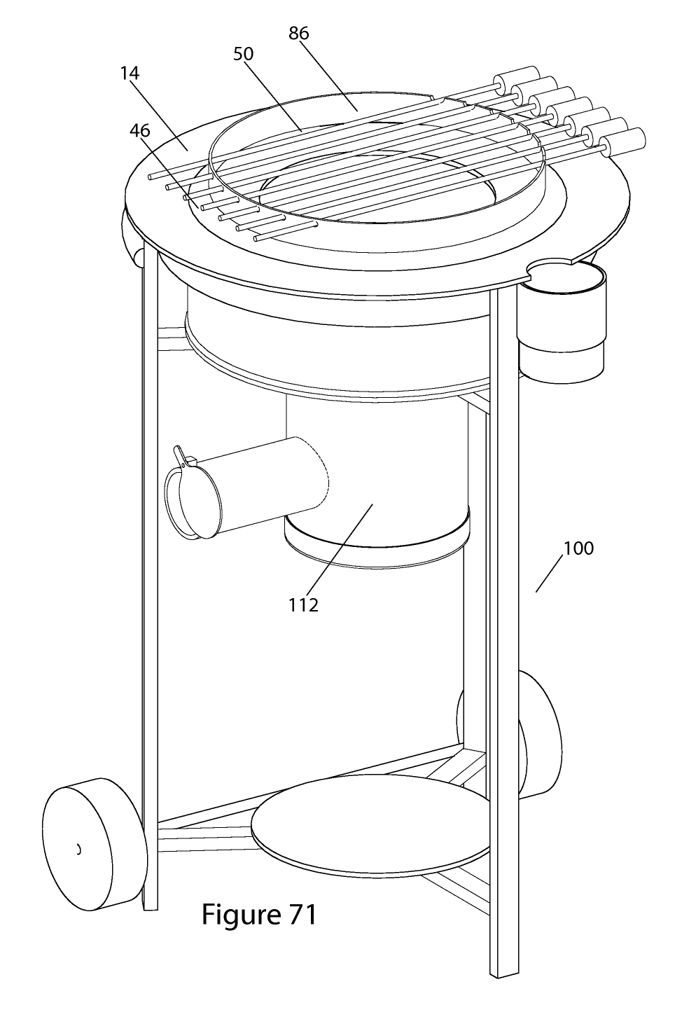

FIG. 66 is an isolated view of a dual-wall fire tube 128. FIG. 67 shows the outer wall of the dual-wall fire tube 128. FIG. 68 shows the inner wall of the dual-wall fire tube 128. FIG. 69 is a perspective view of the embodiment 100 of the inventive outdoor cooking grill configured for wok-style cooking. FIG. 70 is a perspective view of the embodiment 100 of the inventive outdoor cooking grill configured for Dutch oven-style cooking. FIG. 71 is a perspective view of the inventive outdoor cooking grill configured for shish kabob-style cooking.

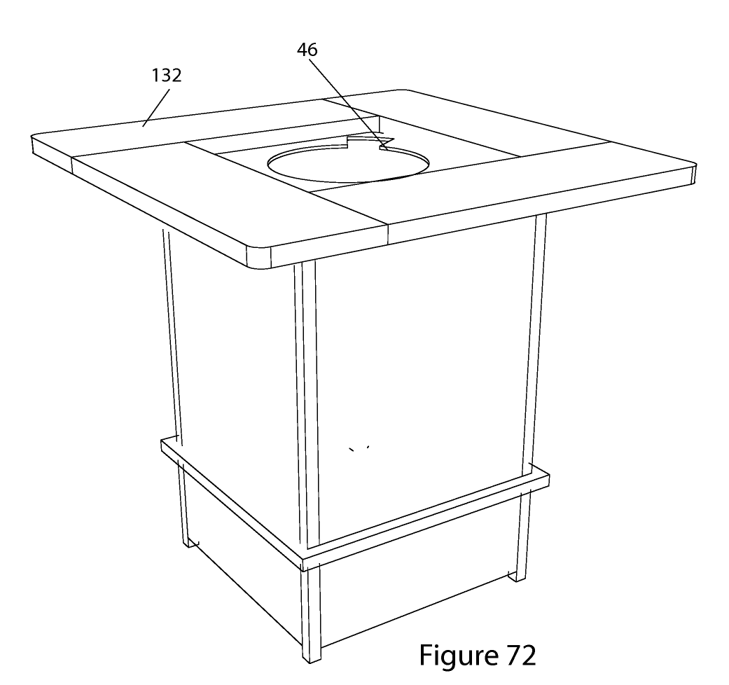

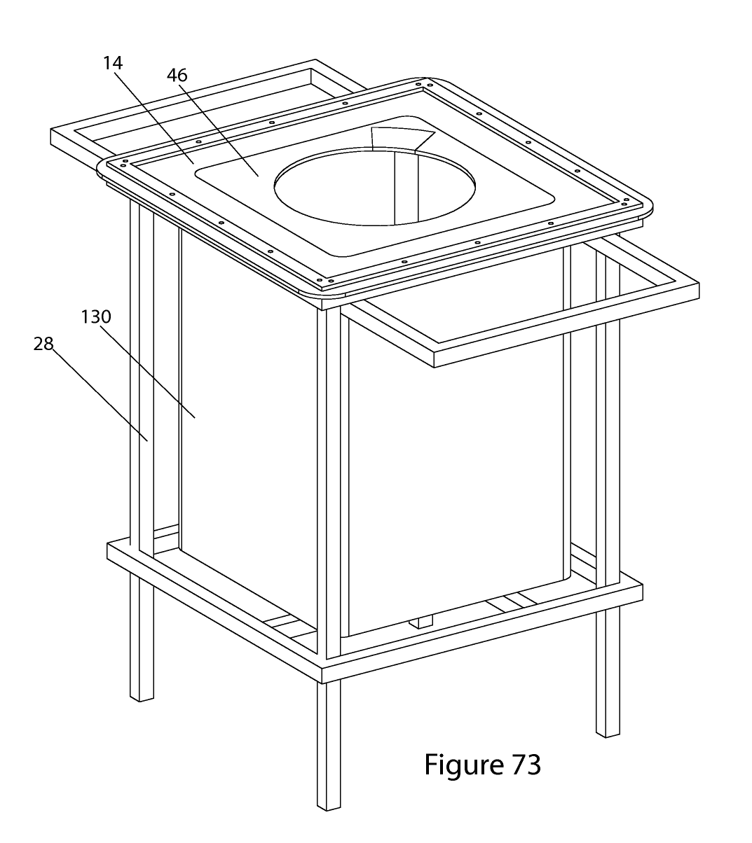

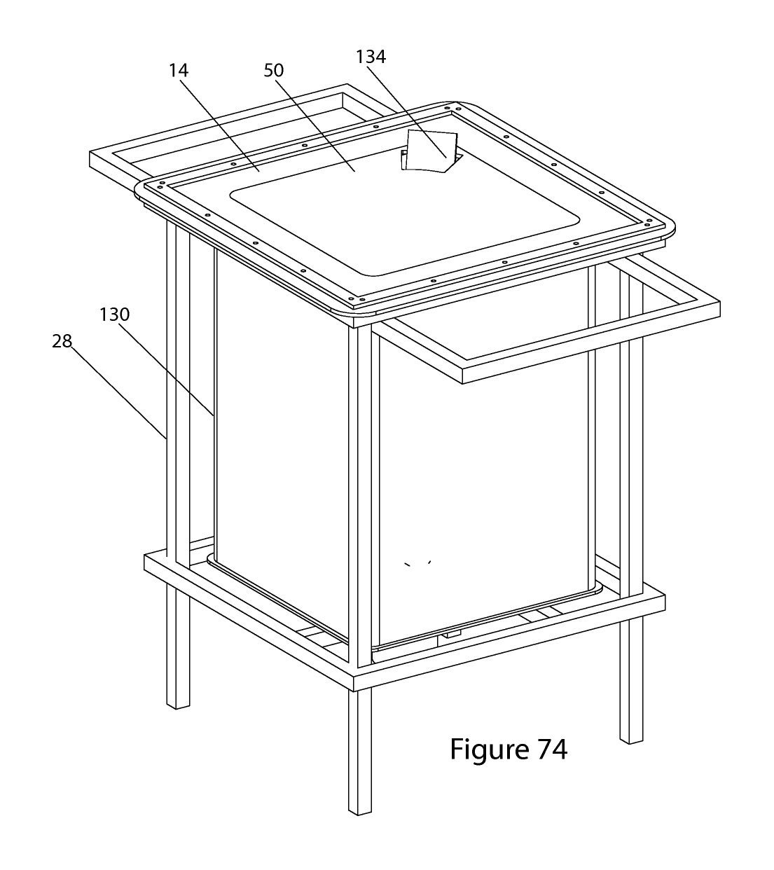

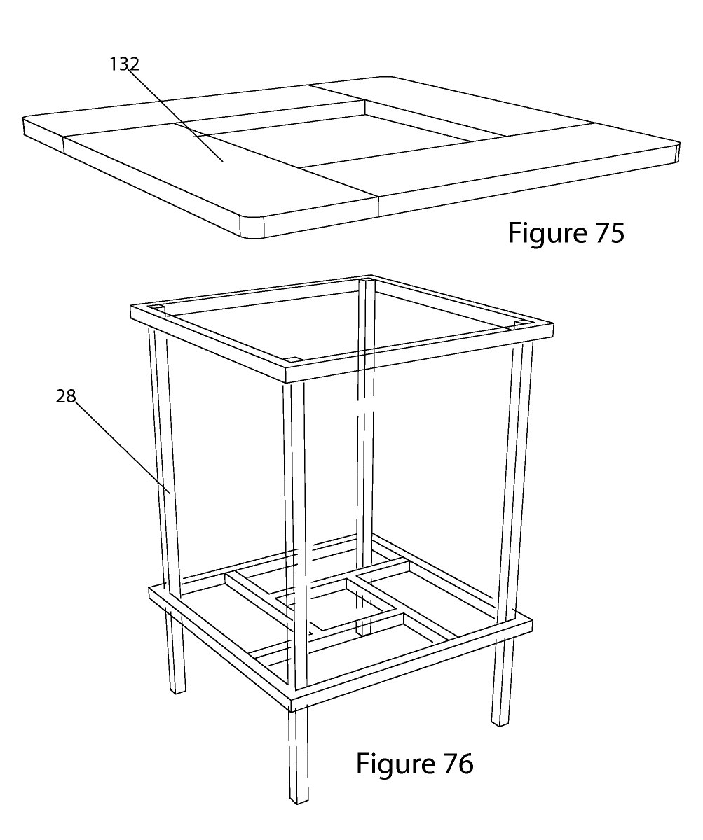

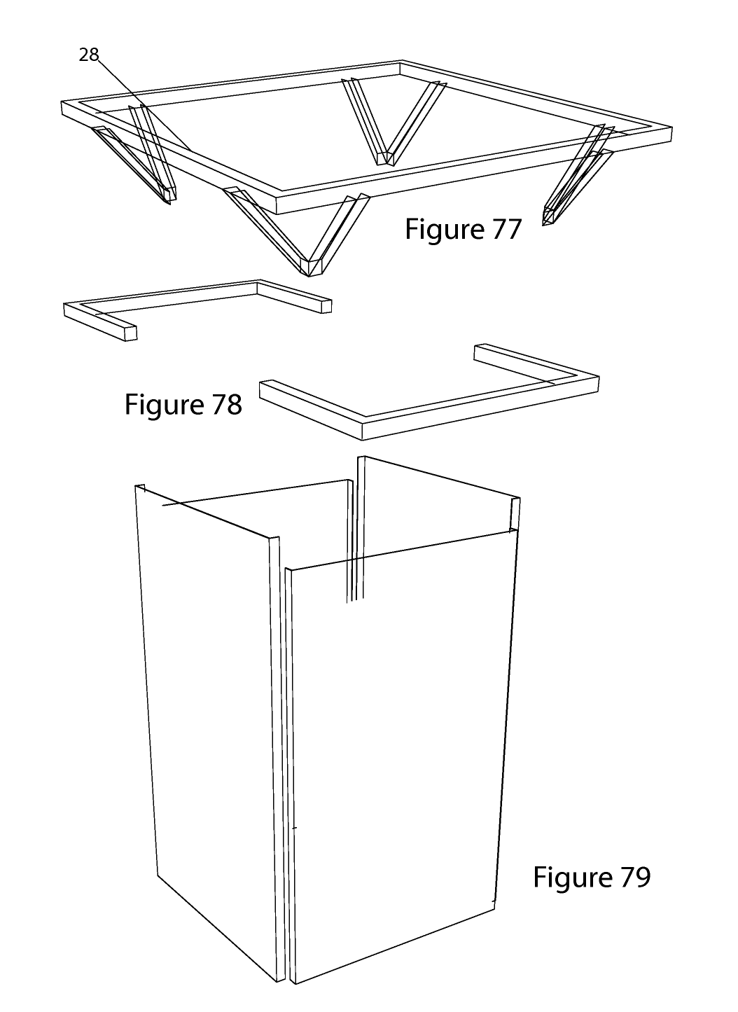

FIG. 72 is a perspective view of another embodiment of the inventive outdoor cooking grill having a wood or charcoal burning fire unit 112 and a ceramic fire box 130. FIG. 73 is a perspective view of the embodiment of the inventive outdoor cooking grill showing the stand frame 28, wok ring accessory 46 and metal stand frame 28. FIG. 74 is a perspective view of the embodiment of the inventive outdoor cooking grill showing a griddle accessory 46. FIG. 75 is an isolated perspective view of a soapstone top 132. FIG. 76 is an isolated perspective view of the metal stand frame 28. FIG. 77 is an exploded perspective view of the top support stand frame 28 of the embodiment of the inventive outdoor cooking grill. FIG. 78 is an exploded perspective view of the handles of the embodiment of the inventive outdoor cooking grill. FIG. 79 is an exploded perspective view of the sheet metal panels of the embodiment of the inventive outdoor cooking grill.

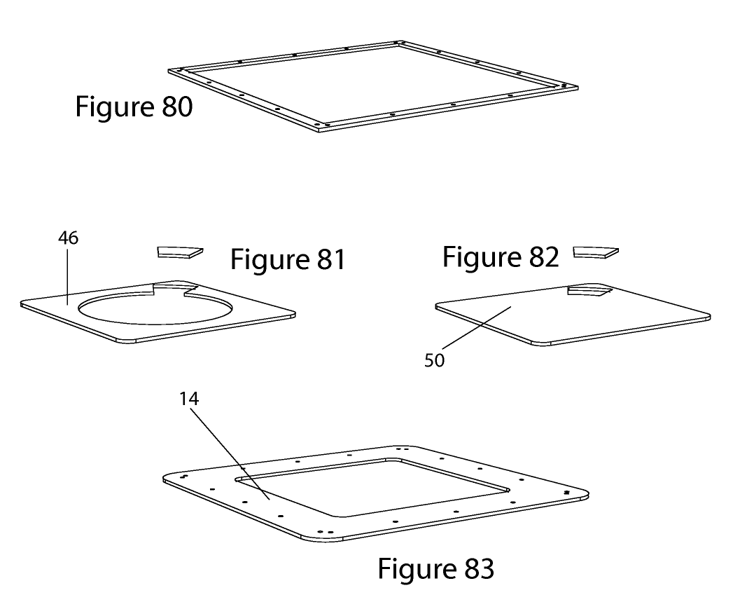

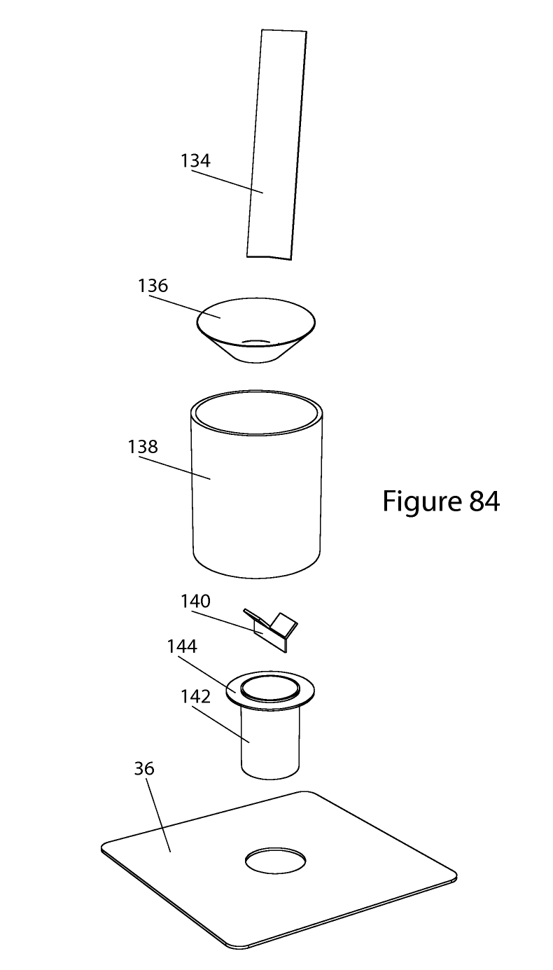

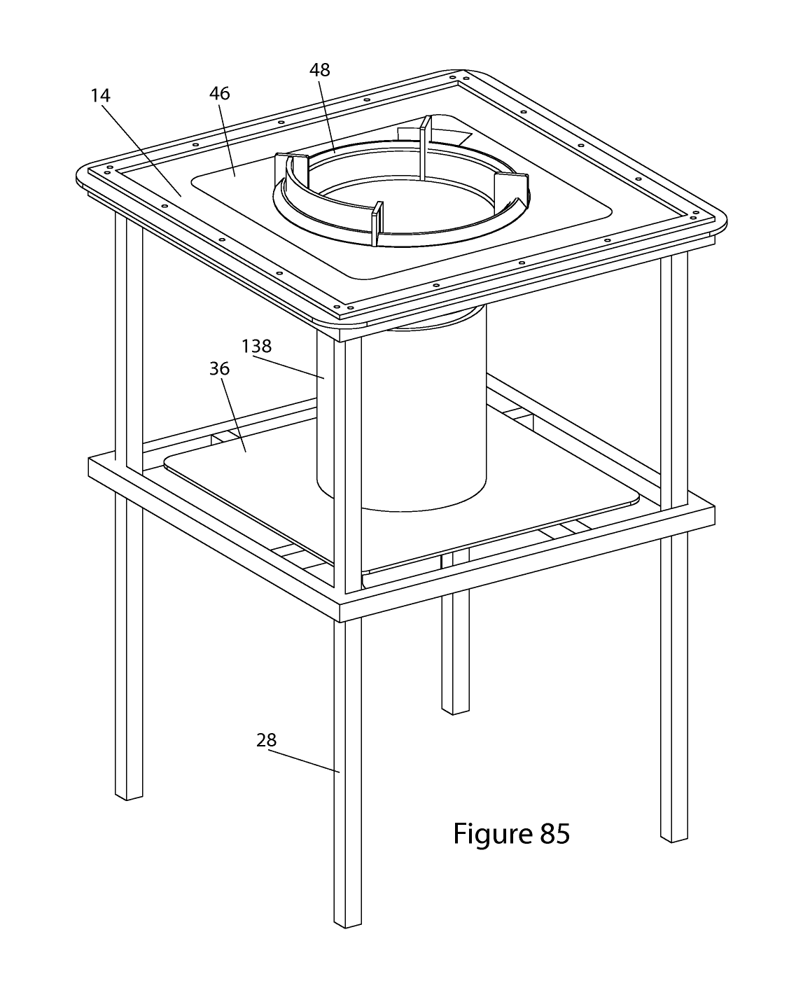

FIG. 80 is a perspective view of an inventive drip-catch accessory engagement structure 16. FIG. 81 is a perspective view of a wok ring accessory 46 insert and fuel chute block for the embodiment of the inventive outdoor cooking grill. FIG. 82 is a perspective view of a griddle accessory 46 insert and fuel chute block for the embodiment of the inventive outdoor cooking grill. FIG. 83 is a perspective view of a top 14 for the embodiment of the inventive outdoor cooking grill. FIG. 84 is an exploded view of an alternative solid fuel fire unit 12 showing the fuel chute 134, ash guide 136, fire chamber 138, air vane 140, intake pipe 142, pipe flange 144 and bottom plate 36 of the embodiment of the inventive outdoor cooking grill. FIG. 85 is a perspective view of the embodiment of the inventive outdoor cooking grill configured for wok cooking and showing the stand frame 28, alternative fire unit 12, bottom plate 36, top 14, wok ring accessory 46 and wok stand 48.

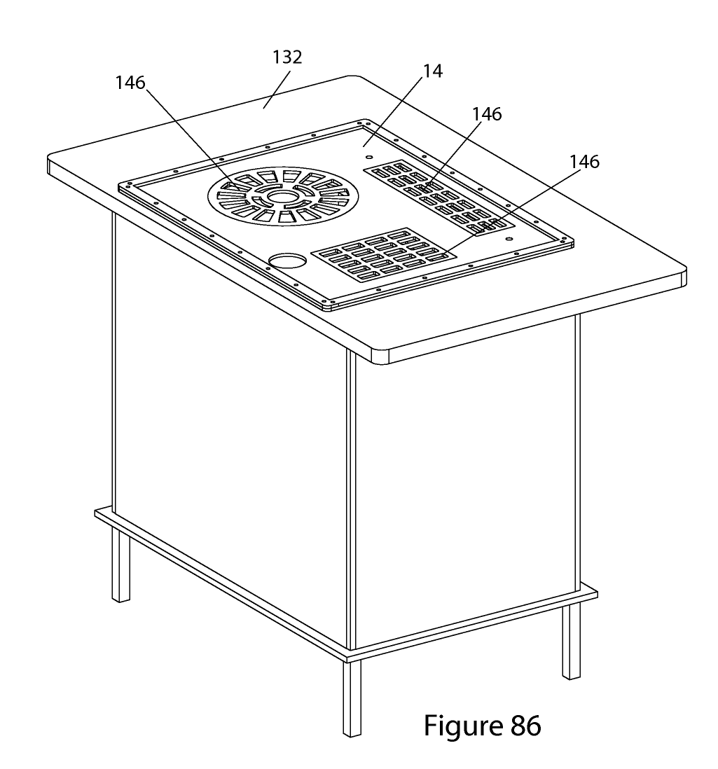

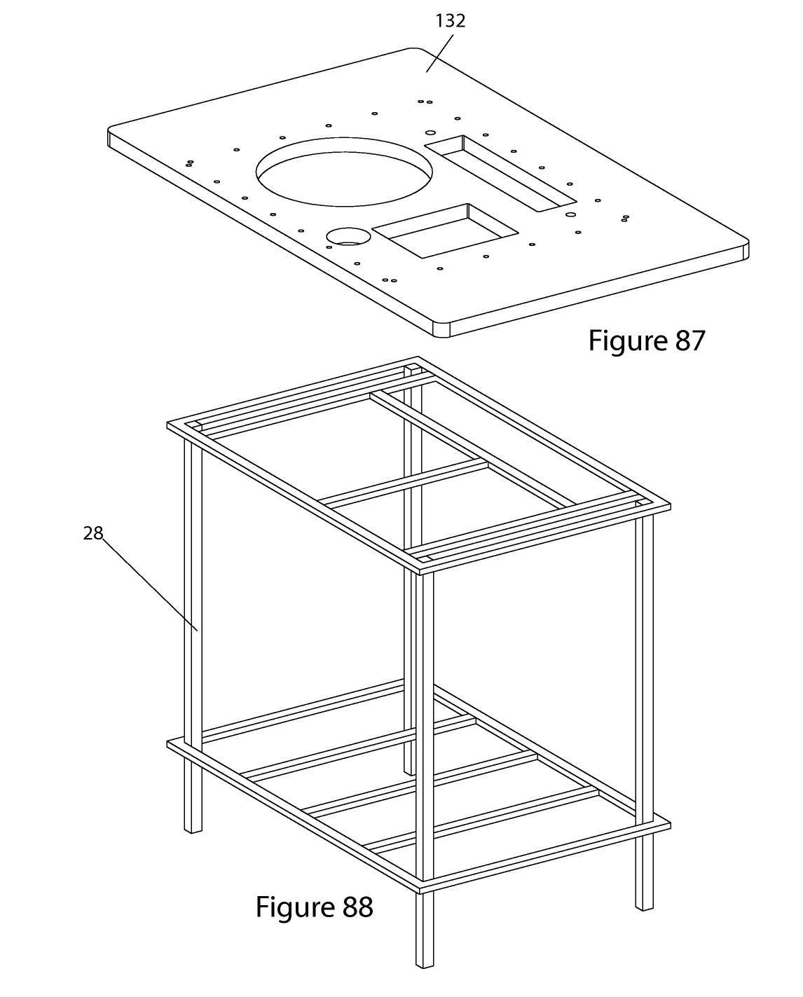

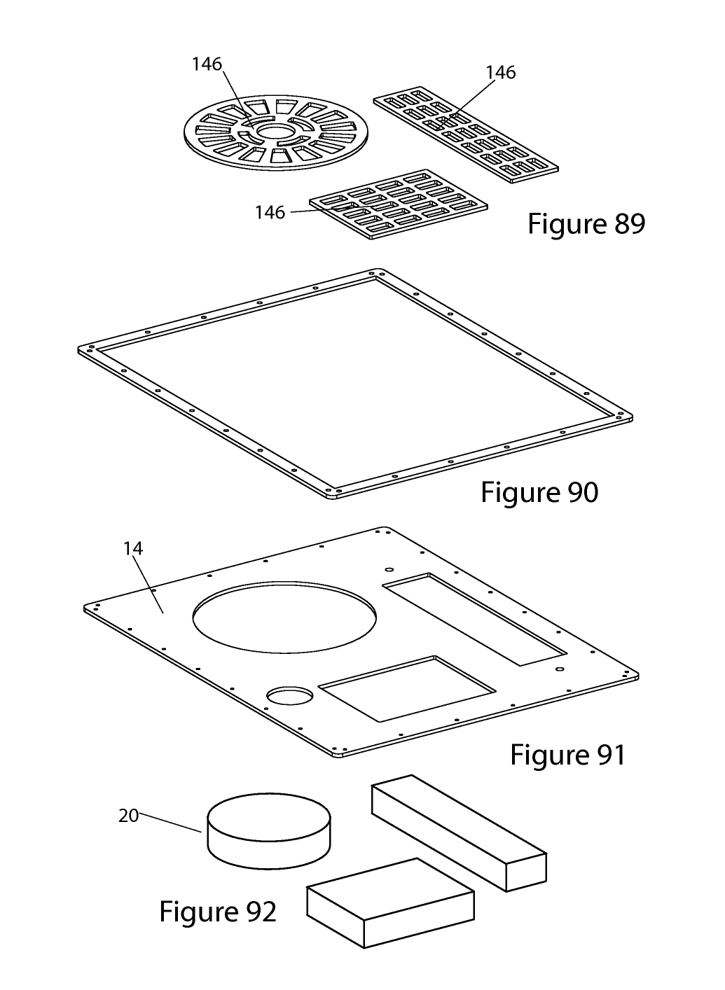

FIG. 86 is a perspective view of a multi-zoned embodiment of the inventive cooking grill. FIG. 87 is an isolated perspective view of a soapstone top 132 for the multi-zoned embodiment of the inventive cooking grill. FIG. 88 is an isolated perspective view of the metal stand for the multi-zoned embodiment of the inventive cooking grill. FIG. 89 is an isolated perspective view of individual zone cooking grates 146 for the multi-zoned embodiment of the inventive cooking grill. FIG. 90 is an isolated perspective view of a top rim for the multi-zoned embodiment of the inventive cooking grill. FIG. 91 is an isolated perspective view of a metal top 14 for the multi-zoned embodiment of the inventive cooking grill. FIG. 92 is a block representation of cooking burners, such as IR, gas or electric burners for the multi-zoned embodiment of the inventive cooking grill.

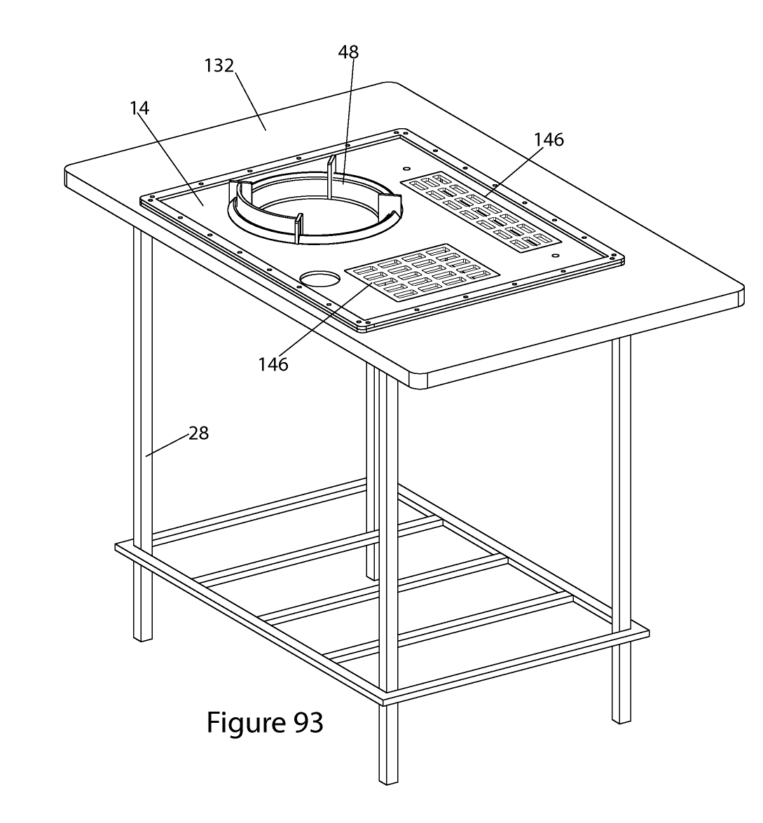

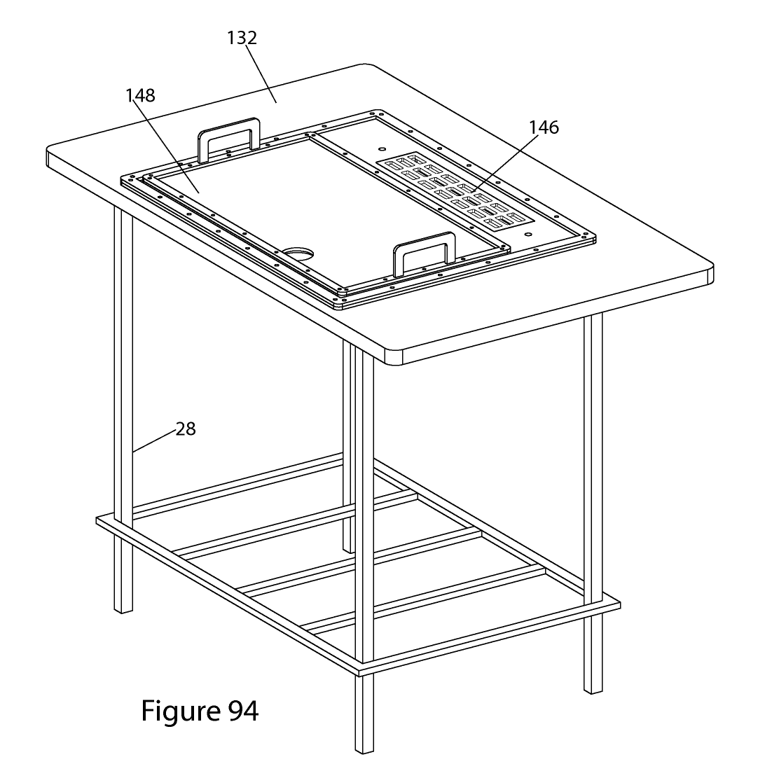

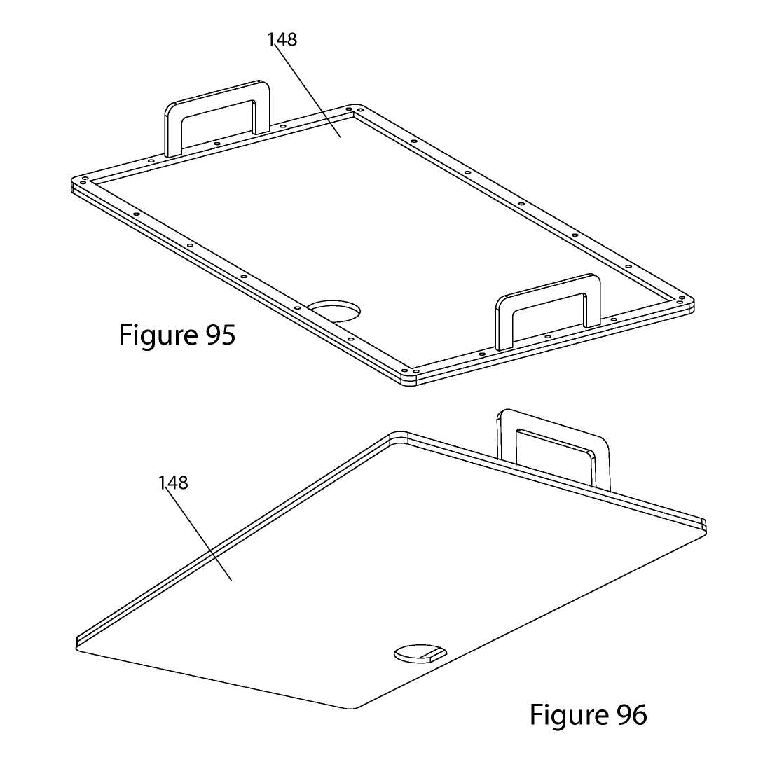

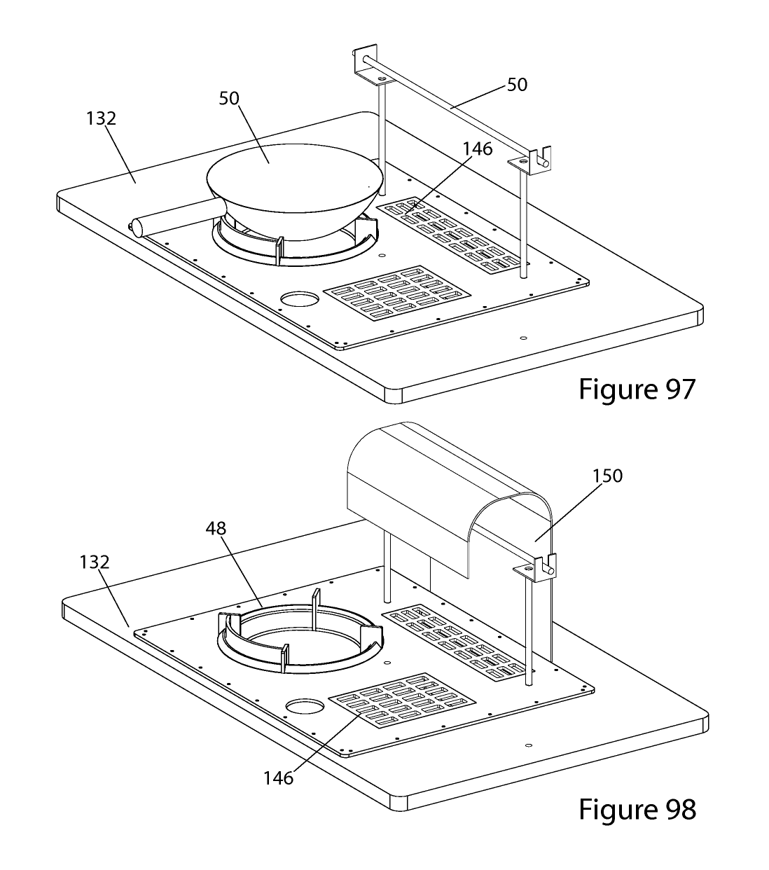

FIG. 93 is an assembled perspective view of the multi-zoned embodiment of the inventive cooking grill with one of the burner zones configured for wok cooking and the other two-burner zones configured with the individual zone cooking grates 146. FIG. 94 is an assembled perspective view of the multi-zoned embodiment of the inventive cooking grill with two of the burner zones configured for a two-zone griddle 148. FIG. 95 is an isolated perspective view of the two-zone griddle 148. FIG. 96 is an isolated bottom perspective view of the two-zone griddle 148. FIG. 97 is an isolated view of the soapstone and metal cook top 14 configured for simultaneous wok cooking, rotisserie and sear grilling. FIG. 98 shows a heat/wind deflector attachment 150 for the rotisserie.

The metal cook top 14 is utilized in the cooking and/or in keeping foods warm that are cooked on the interchangeable cooking surface 50, such as the cooking grates 146. The top 14 is thermally separated from the cooking grates 146 and/or other cooking surfaces 50. Also, another burner element (not shown) can be provided directly underneath a portion of the metal cooktop 14 to enable a more intense and controlled heating of the metal cook top 14. The metal top 14 can be controllably heated to a different temperature than the grates 146 or other cooking surfaces 50.

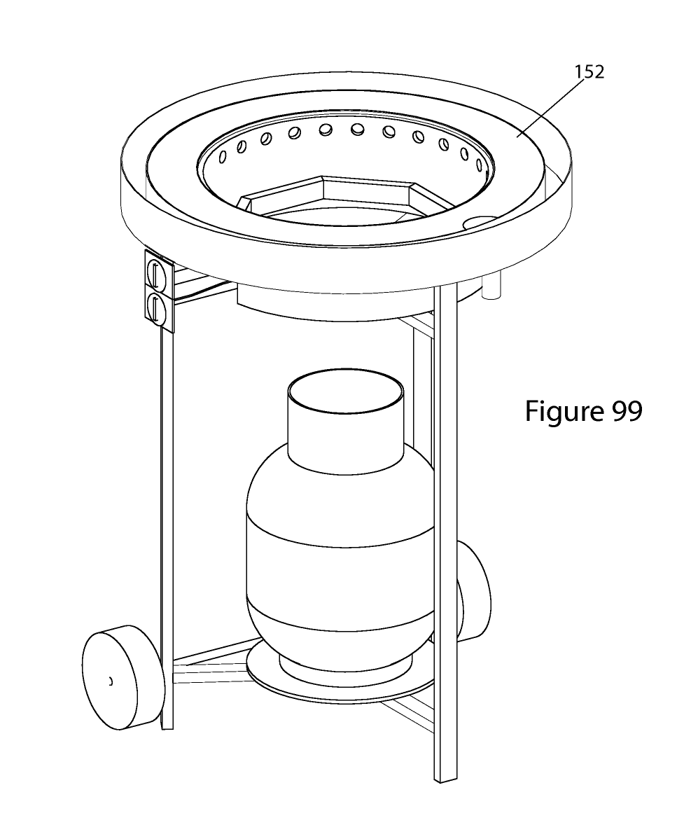

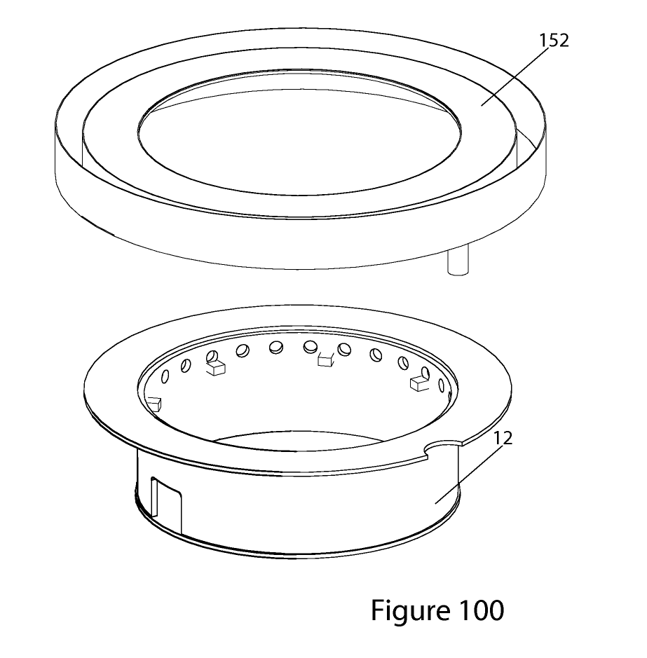

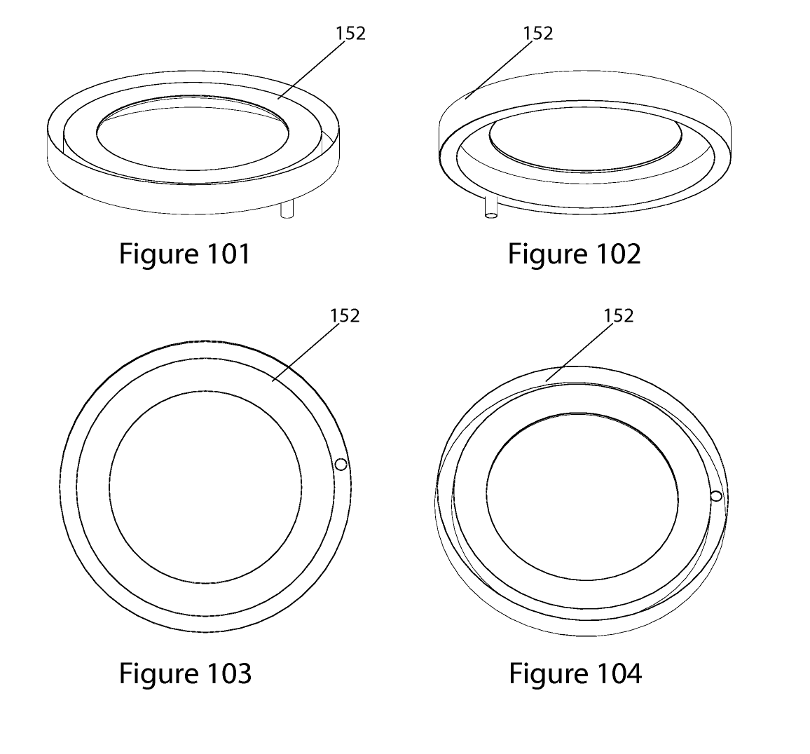

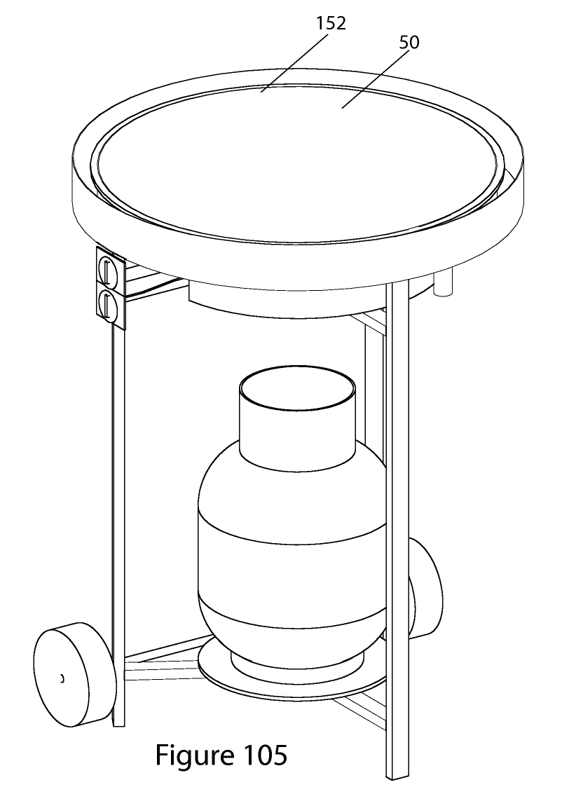

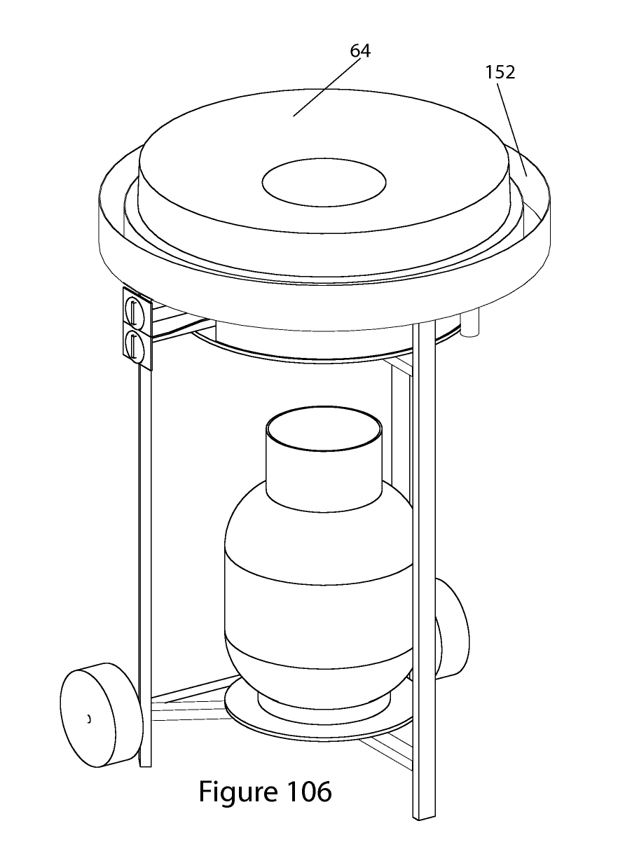

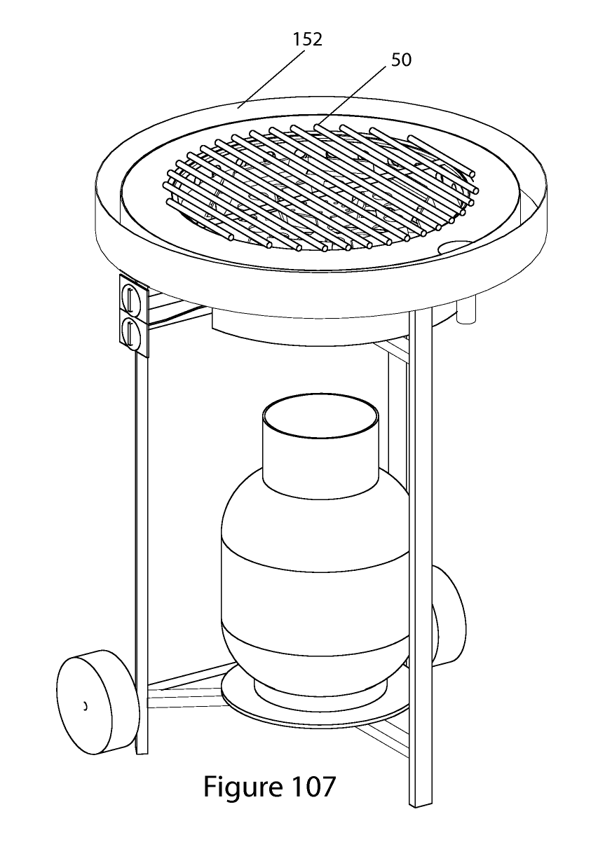

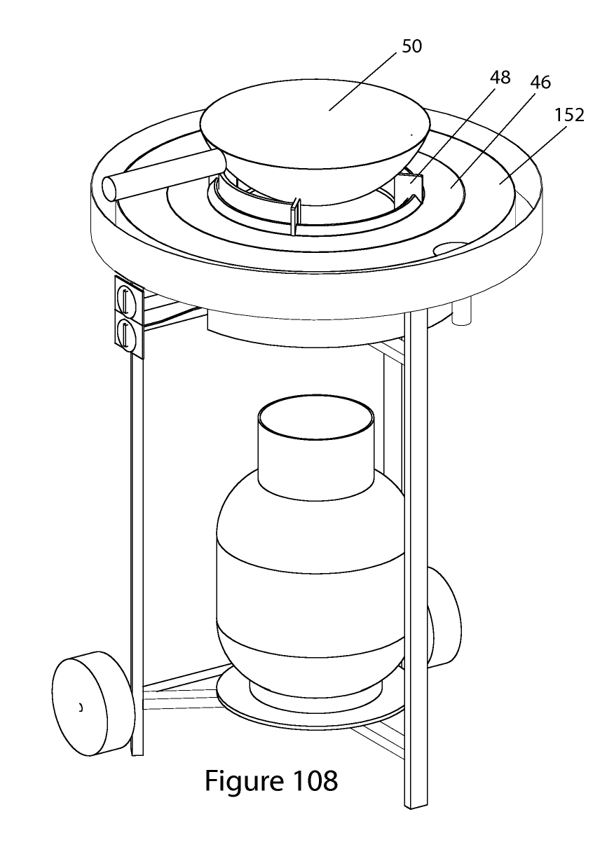

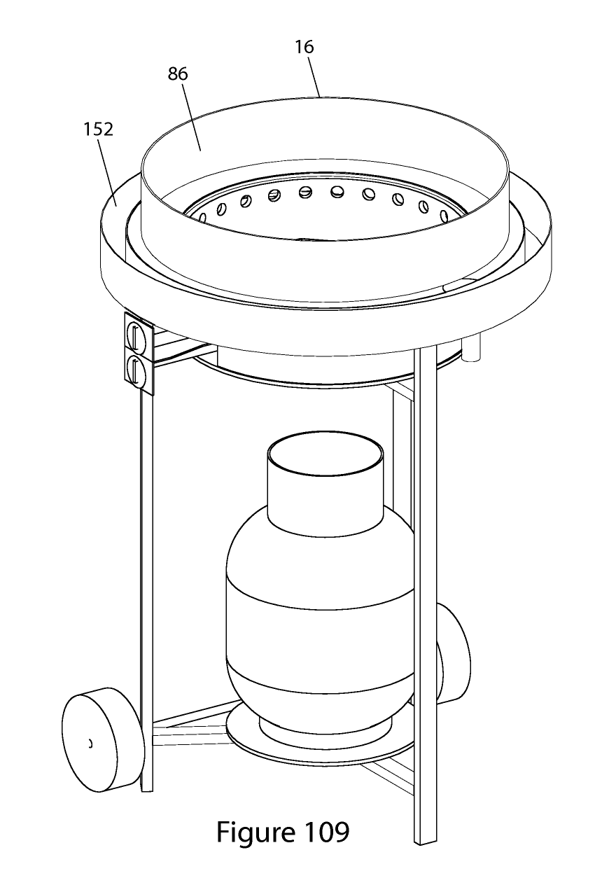

FIG. 99 is a perspective view of another concentric burner gas fired embodiment of the inventive outdoor cooking grill showing an outer edge drip tray 152. FIG. 100 is an isolated exploded perspective view of the outer edge drip tray 152 and the assembled fire unit 12. FIG. 101 is an isolated perspective view of the outer edge drip tray 152. FIG. 102 is an isolated bottom perspective view of the outer edge drip tray 152. FIG. 103 is an isolated top 14 view of the outer edge drip tray 152. FIG. 104 is an isolated bottom view of the outer edge drip tray 152. FIG. 105 is a perspective view of the concentric burner gas fired embodiment of the outdoor cooking grill with outer edge drip tray 152 and configured as a large circular griddle. FIG. 106 is a perspective view of the concentric burner gas fired embodiment of the outdoor cooking grill with outer edge drip tray 152 and configured as a large sloped griddle 64. FIG. 107 is a perspective view of the concentric burner gas fired embodiment of the outdoor cooking grill with outer edge drip tray 152 and configured as a large grill. FIG. 108 is a perspective view of the concentric burner gas fired embodiment of the outdoor cooking grill with outer edge drip tray 152 and configured as a wok cooker. FIG. 109 is a perspective view of the concentric burner gas fired embodiment of the outdoor cooking grill with outer edge drip tray 152 with a large riser ring 86 accessory engagement structure 16.

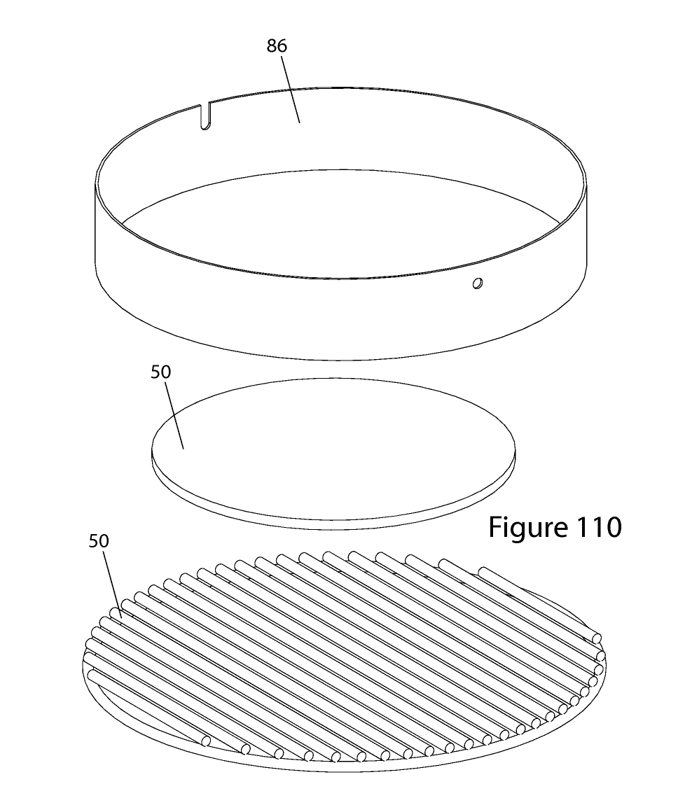

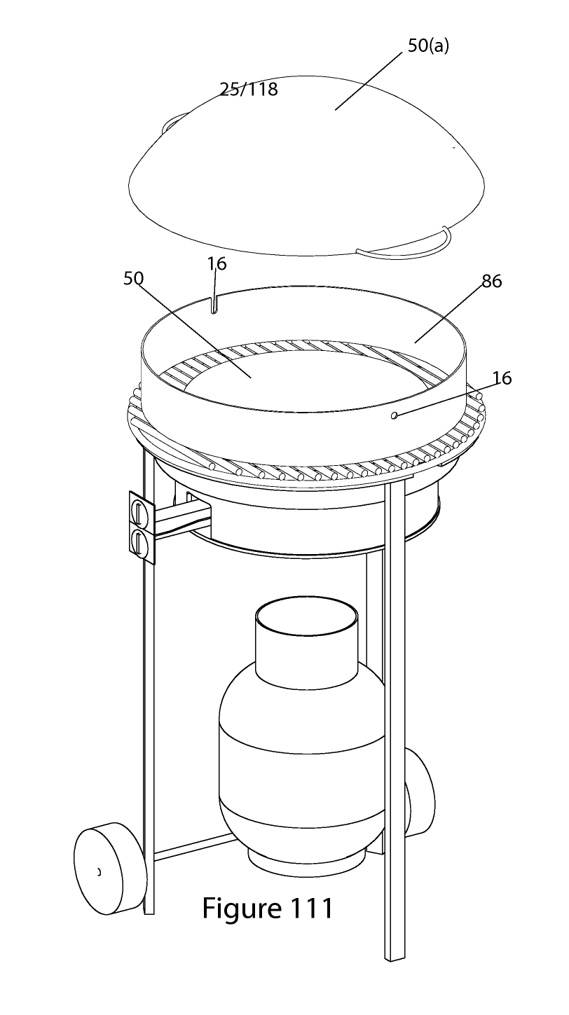

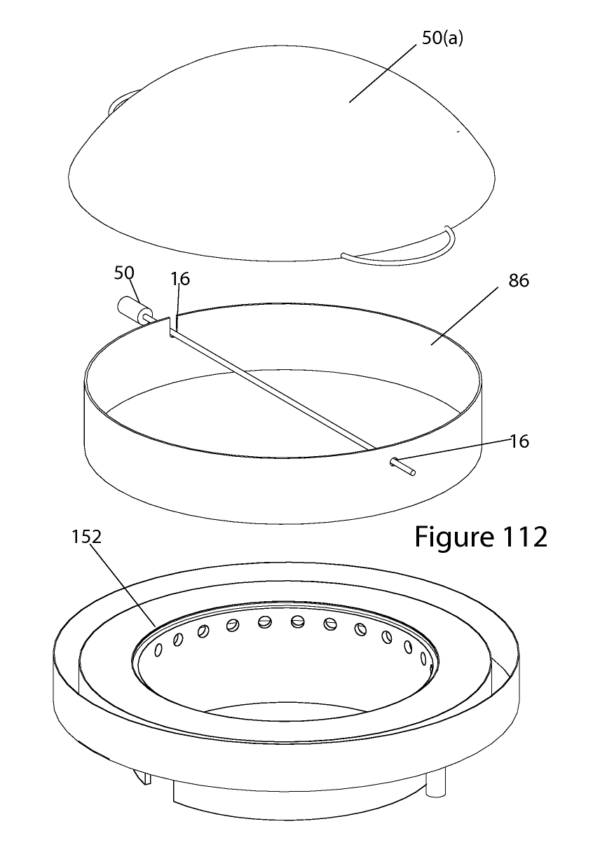

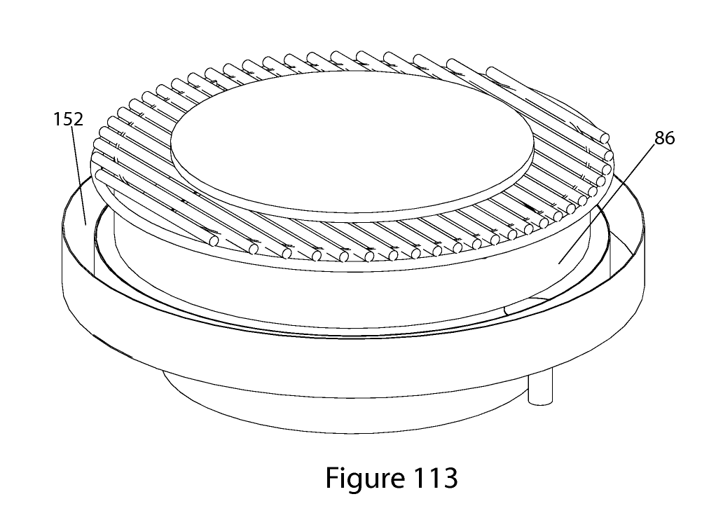

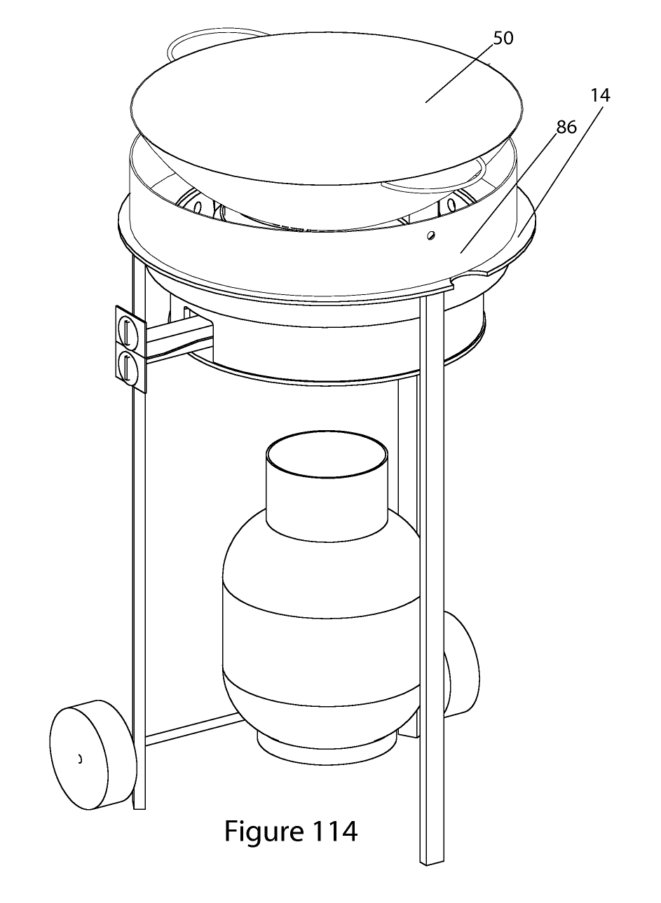

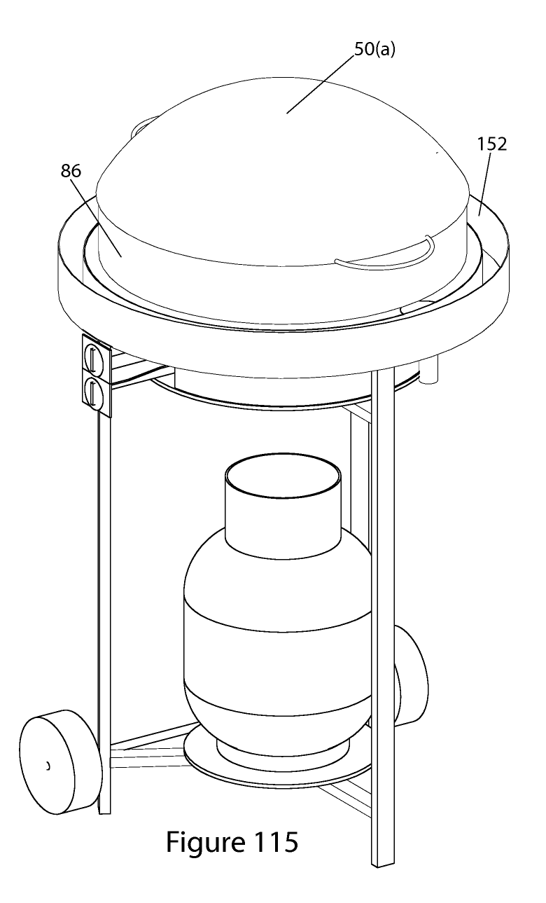

FIG. 110 is an isolated exploded view of the riser ring 86, a baking stone, and a grill for configuring the concentric burner gas fired outdoor cooking grill as a baking oven. FIG. 111 is a perspective view of the concentric burner gas fired embodiment of the outdoor cooking grill with outer edge drip tray 152 and configured as a baking oven using the large wok as a lid 50(a). FIG. 112 is an exploded isolated perspective view showing the fire unit 12 with outer edge drip tray 152, the riser ring 86 with a rotisserie skewer and the large wok as a lid 50(a) for configuring the concentric burner gas fired outdoor cooking grill for rotisserie cooking. FIG. 113 is an isolated perspective view showing the assembled fire unit 12, outer edge drip tray 152, riser ring 86, grill and baking stone for configuring the concentric burner gas fired outdoor cooking grill as a pizza or bread oven. FIG. 114 is a perspective view showing the concentric burner gas fired outdoor cooking grill configured as a large wok cooker. FIG. 115 is a perspective view showing the concentric burner gas fired outdoor cooking grill configured as an oven.

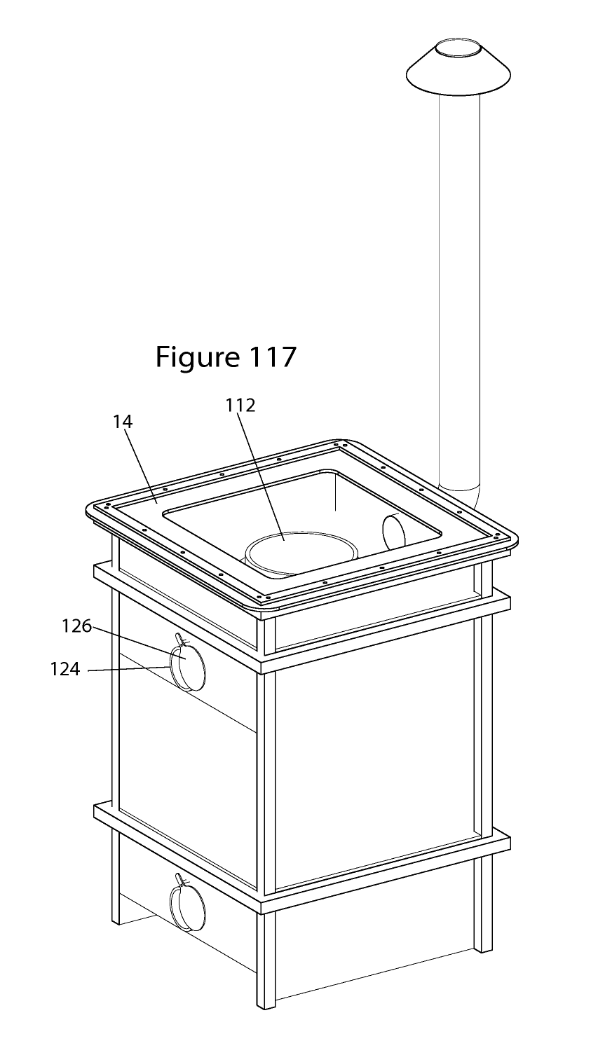

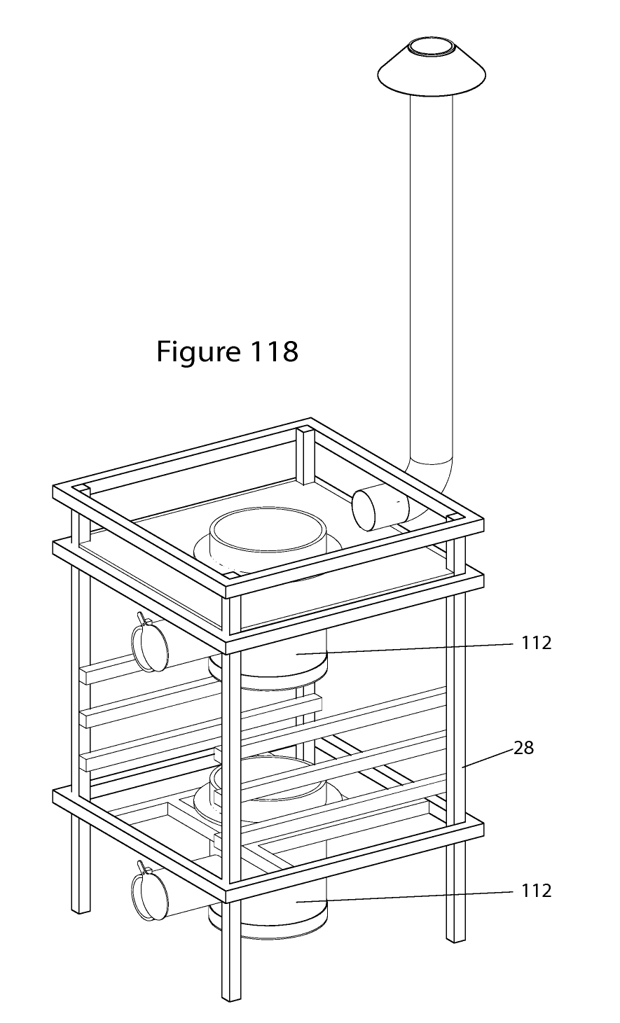

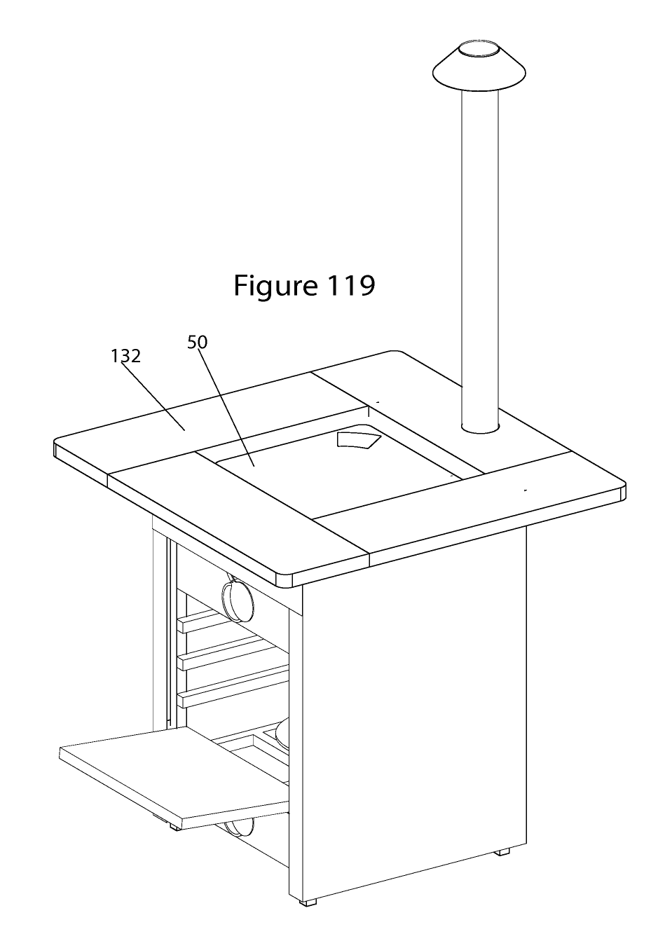

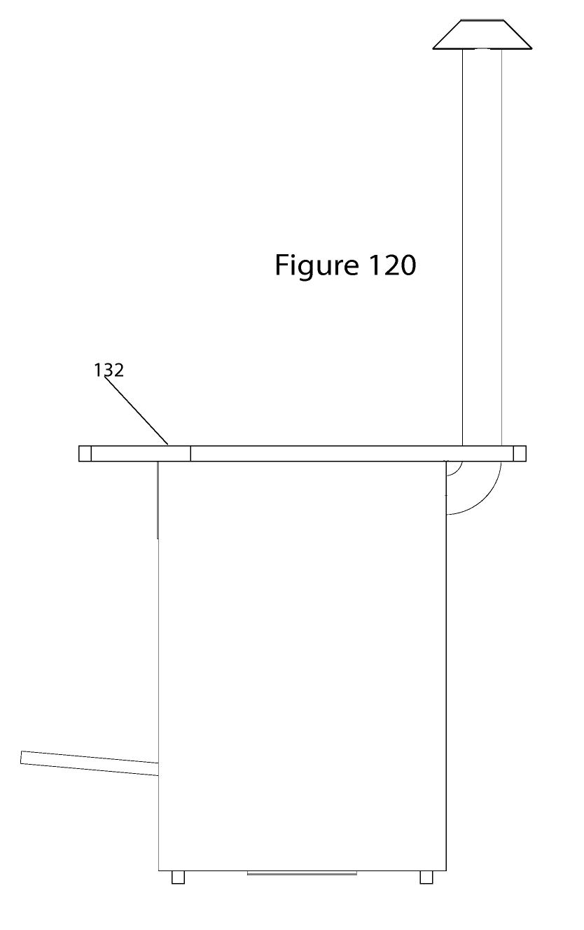

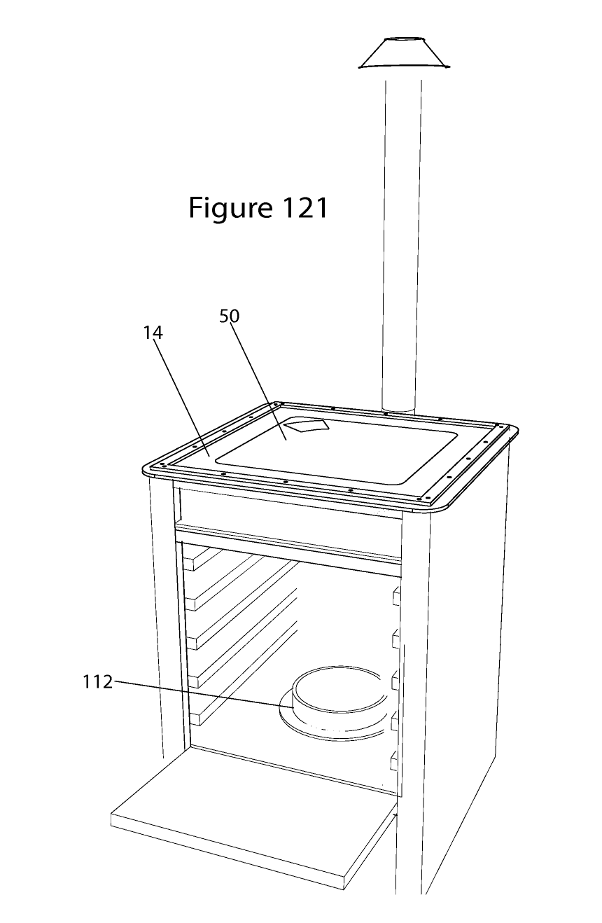

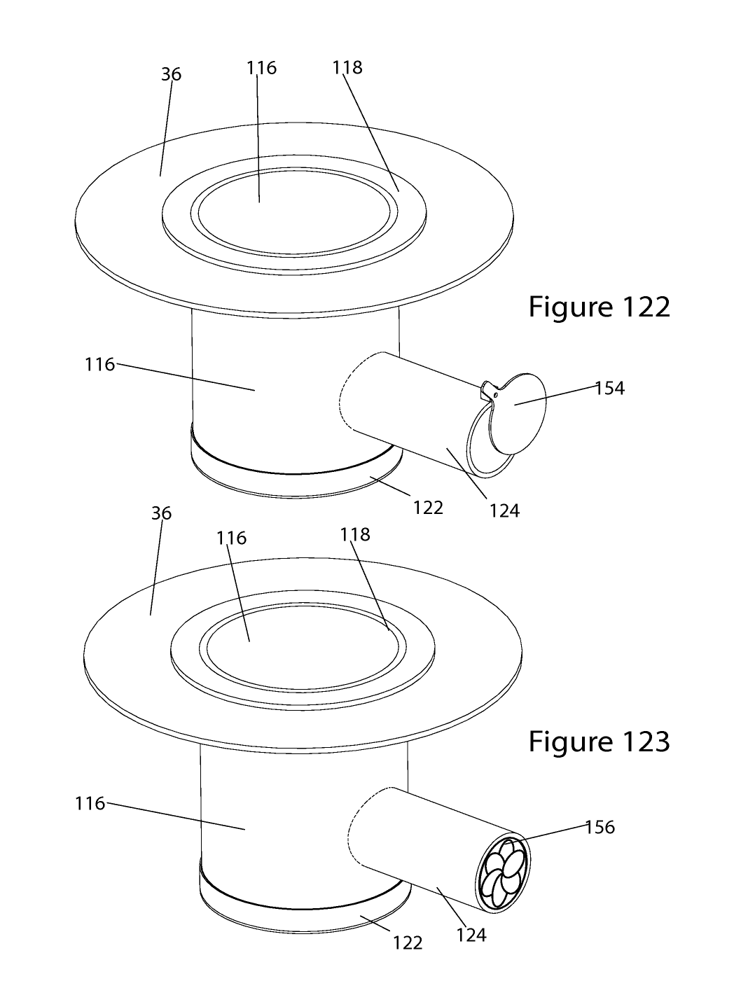

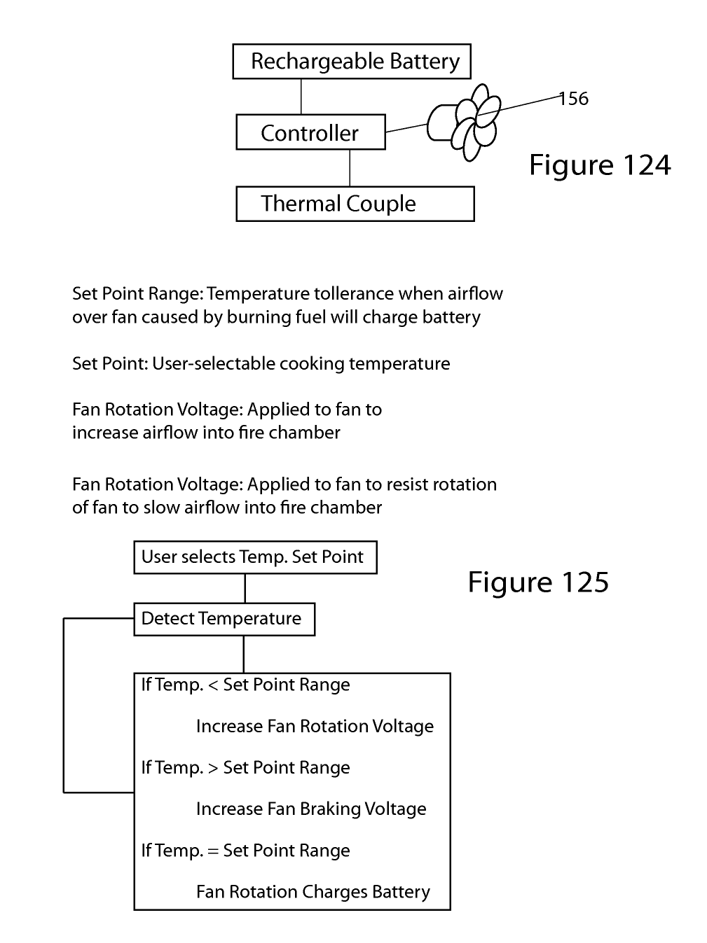

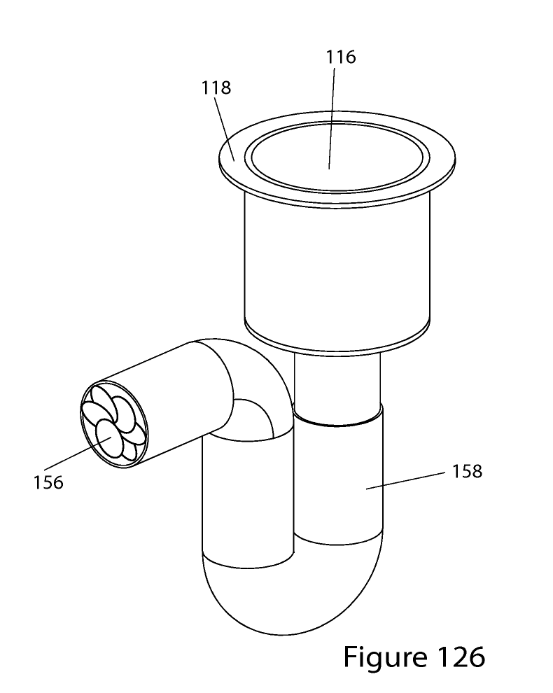

FIG. 116 is a perspective view of a solid fuel fired oven and grill/stove/griddle embodiment of the inventive outdoor cooking grill. FIG. 117 is a perspective view of the solid fuel fired oven embodiment of the inventive outdoor cooking grill showing the oven chamber and top opening. FIG. 118 is a perspective view of the embodiment of the inventive outdoor cooking grill showing the metal stand frame 28 and dual solid fuel fire units 112. FIG. 119 is a perspective view showing the embodiment of the inventive outdoor cooking grill showing the griddle accessory 46. FIG. 120 is a side view of the embodiment of the inventive outdoor cooking grill. FIG. 121 is a perspective view of the embodiment of the inventive outdoor cooking grill showing the oven chamber and racks. FIG. 122 is an isolated view of the solid fuel fire unit 12 showing an air intake control damper 154. FIG. 123 is an isolated view of the solid fuel fire unit 12 showing a fan of a controllable forced air intake system 156. FIG. 124 is a block diagram showing the controllable forced air intake system 156. FIG. 125 is a flowchart showing a control scheme for the controllable forced air intake system 156. FIG. 126 is an isolated view of a bubbler system 158 for the controllable forced air intake system 156.

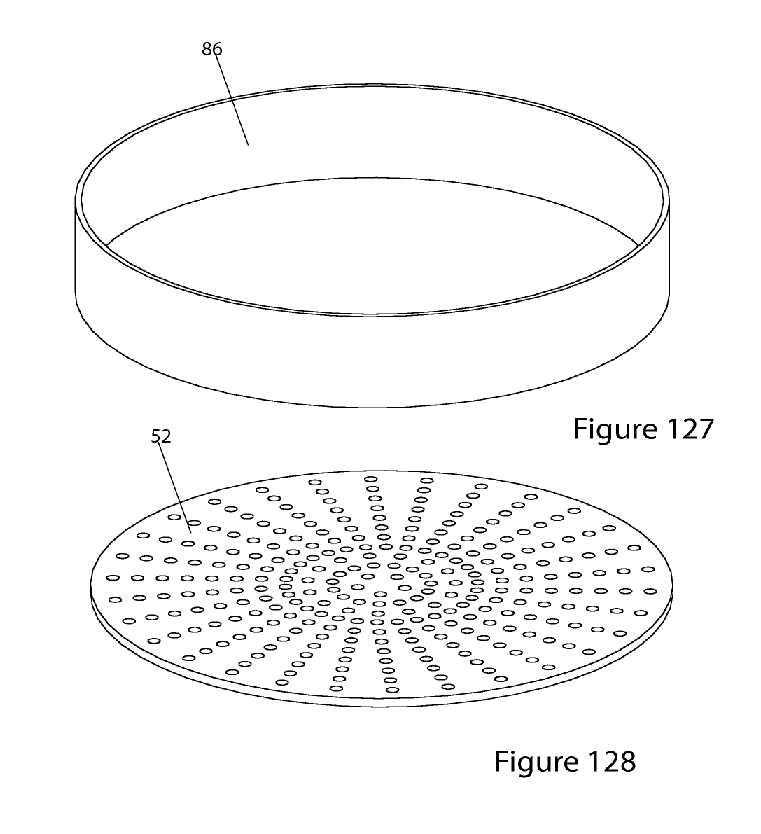

FIG. 127 is a perspective view of a riser ring 86 for use with the various embodiment of the inventive outdoor cooking grill. FIG. 128 is a perspective view of a heat spreader/sear plate 52 for use with the various embodiments of the inventive outdoor cooking grill. FIG. 132 is a perspective view of an outer ring burner 56 having naturally aspirated burner tips. FIG. 133 is a perspective view of a split outer ring burner 56. FIG. 134 is a perspective view of an outer ring tube burner 56.

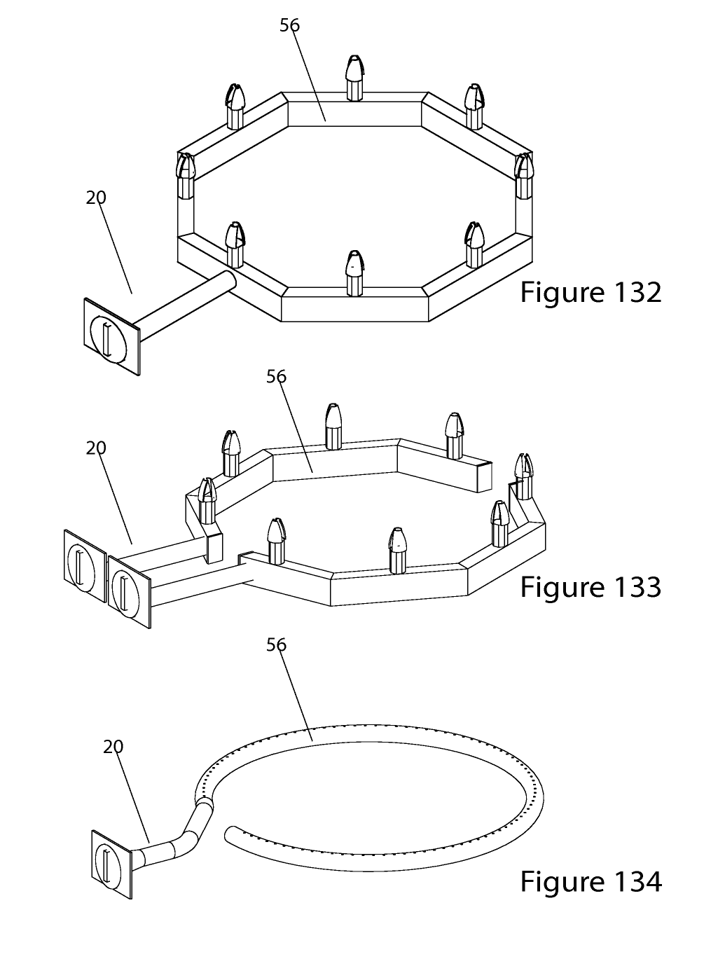

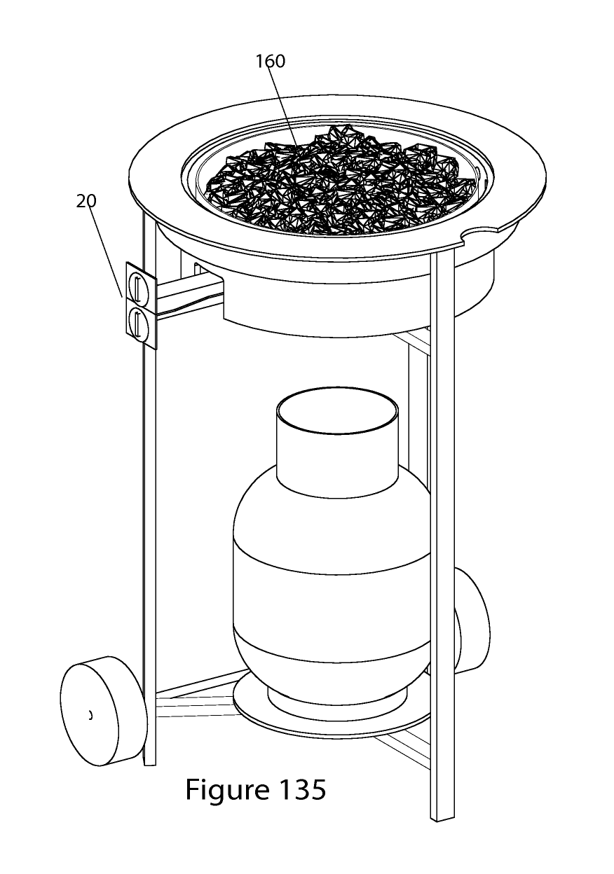

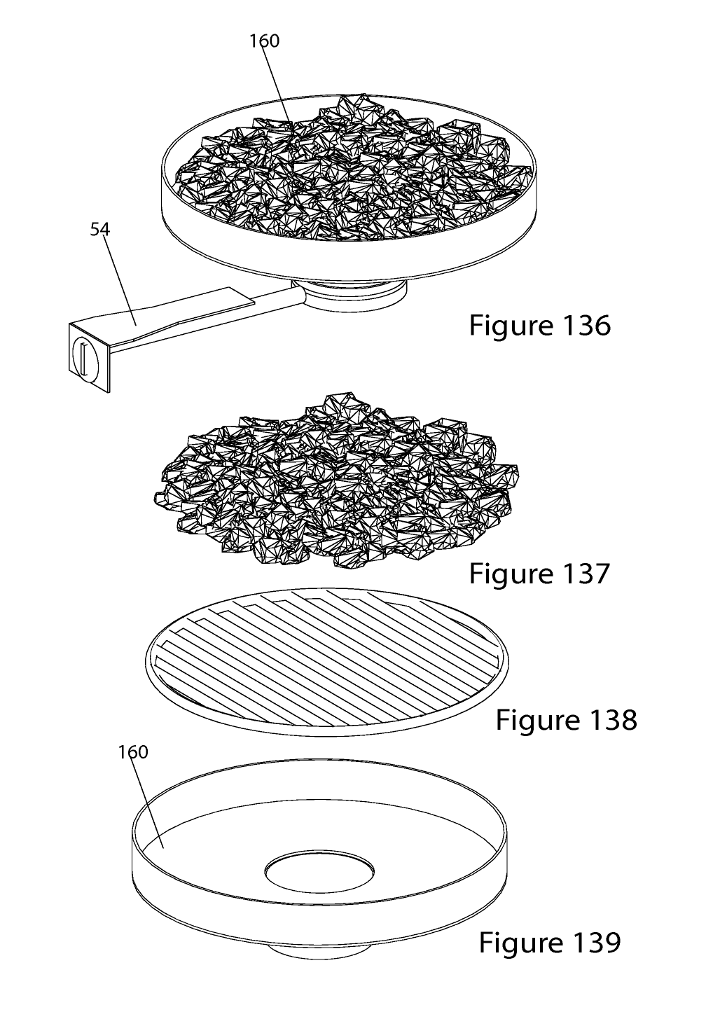

In accordance with another aspect of the present invention, the burner assembly 20 can be retrofit with a campfire accessory 160. This campfire accessory 160 allows the compressed flammable gas to be ignited in an aesthetically interesting flame, simulating a campfire. FIG. 135 is a perspective view of an embodiment of the gas fired outdoor cooking grill with a campfire accessory 160. FIG. 136 is an isolated view of the fast burner with the campfire accessory 160. FIG. 137 is an isolated view of the campfire accessory fire stones, FIG. 138 is an isolated view of the campfire accessory grate and FIG. 139 is an isolated view of the campfire accessory housing.

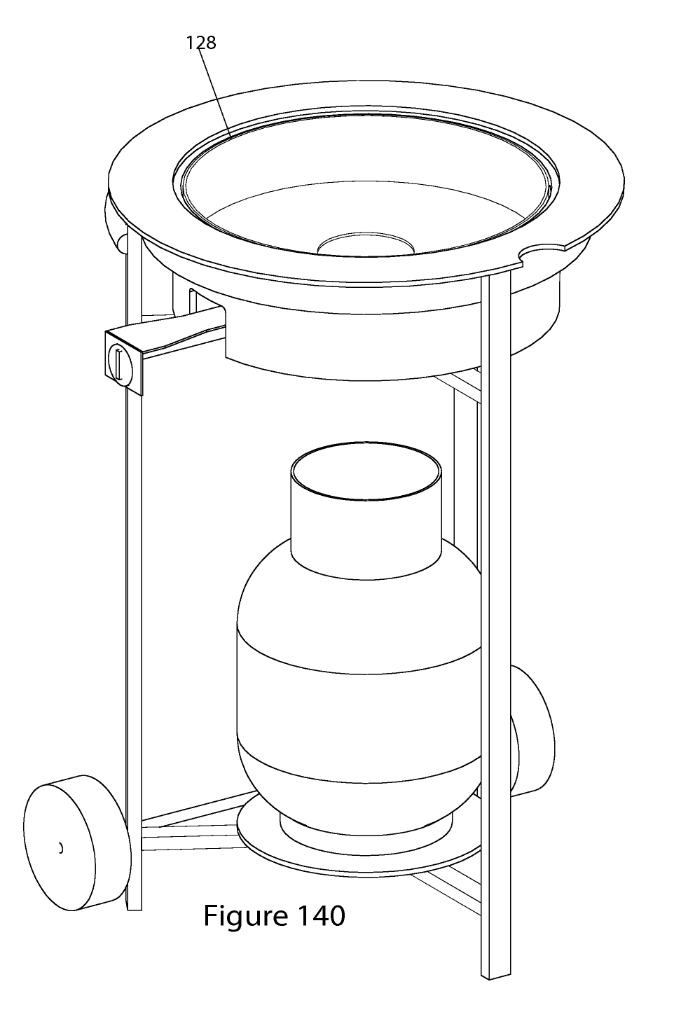

FIG. 140 is a perspective view showing a gas fired embodiment of the inventive outdoor cooking grill showing a dual wall fire tube 128. This dual wall fire tube 128 provides an insulation against the heat generated by the burner assembly 20. The gap between the walls of the dual wall fire tube 128 can be left as an air gap, filled with insulation, such as glass wool, or filled with a thermal mass material, such as sand.

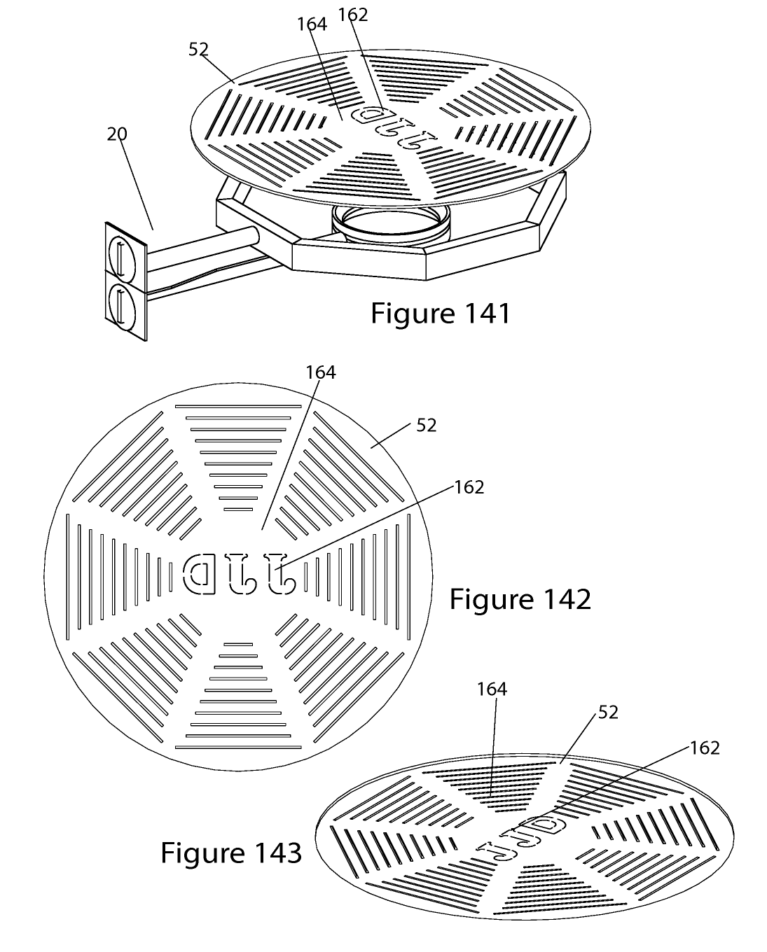

The inventive grill embodiments shown herein have flat and tube parts that can be fabricated using highly efficient CNC cutting of flat plate stock, using for example, plasma, torch or laser cutting. Many of these parts can also be fabricated using stamping and pressing operations. The advantage of CNC digital cutting of the flat and tube stock for mass production is that the product can easily have some level of customization specific for the customer. As shown, for example, in FIGS. 141-149, a heat spreader/sear plate 52 can be customized so that it will “brand” a steak, hamburger, or other food item with an image 162, such as a football, favorite team logo, or letters, such as the user's initials. Depending on the embodiment, most of the other grill parts are fabricated by welding either stainless steel angle iron or stainless steel tubing.

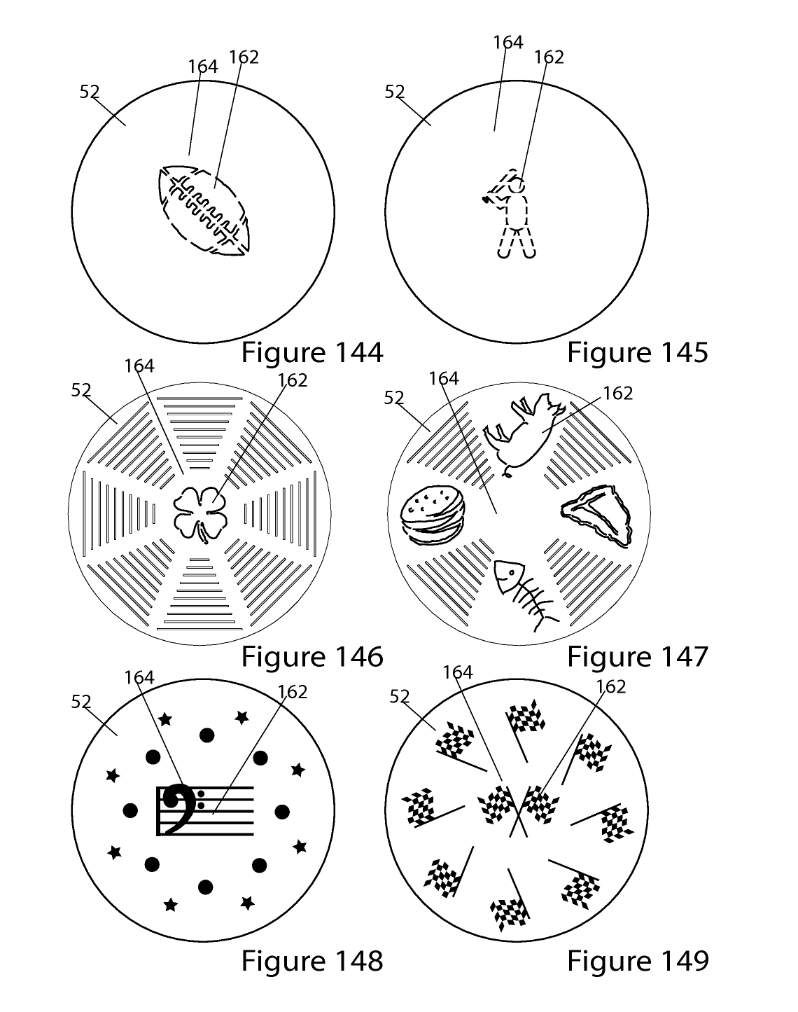

FIG. 141 is a perspective view showing the inventive heat spreader/sear plate 52 in combination with the fast burner 54 and outer ring burner 56 of an embodiment of the inventive outdoor cooking grill. FIG. 142 is a top view of the inventive heat spreader/sear plate 52. FIG. 143 is an isolated perspective view of the inventive heat spreader/sear plate 52. FIG. 144 is an example of a customizable food branding image 162 cut into an embodiment of the inventive heat spreader/sear plate 52 wherein the image 162 is a football. FIG. 145 is another example of a customizable food branding image cut into an embodiment of the inventive heat spreader/sear plate 52 wherein the image 162 is a baseball player. FIG. 146 is another example of a customizable food branding image 162 cut into an embodiment of the inventive heat spreader/sear plate 52 wherein the image 162 is a shamrock. FIG. 147 is another example of a customizable food branding image cut into an embodiment of the inventive heat spreader/sear plate 52 wherein the image 162 is a series of typically food items. FIG. 148 is another example of a customizable food branding image cut into an embodiment of the inventive heat spreader/sear plate 52 wherein the image 162 is a music staff. FIG. 149 is another example of a customizable food branding image 162 cut into an embodiment of the inventive heat spreader/sear plate 52 wherein the image 162 is a series of NASCAR-type checkered flags.

In accordance with this aspect of the invention, the accessory 46 comprises a heat spreader/sear plate 52 having a searing surface 164 configured and dimensioned to act as a sear plate for receiving food directly on the searing surface 164. The searing surface 164 can have heat-concentrating elements for creating a predefined sear pattern on the food. The predefined sear pattern can be, for example, indicia including at least one of a graphic image 162 and a letter image 162. The predefined sear pattern can be customizable by digitally cutting the heat spreader/sear plate 52 using one of a plasma, torch, water-jet, and laser computer-numeric-controlled cutting tool. When heated, the cut edges of the image 162 allow more heat to be directly applied to the surface of a food item, such as a steak. The effect is similar to the hot branding iron used to brand livestock, the image is transferred to the surface of the steak in the form of a sear pattern.

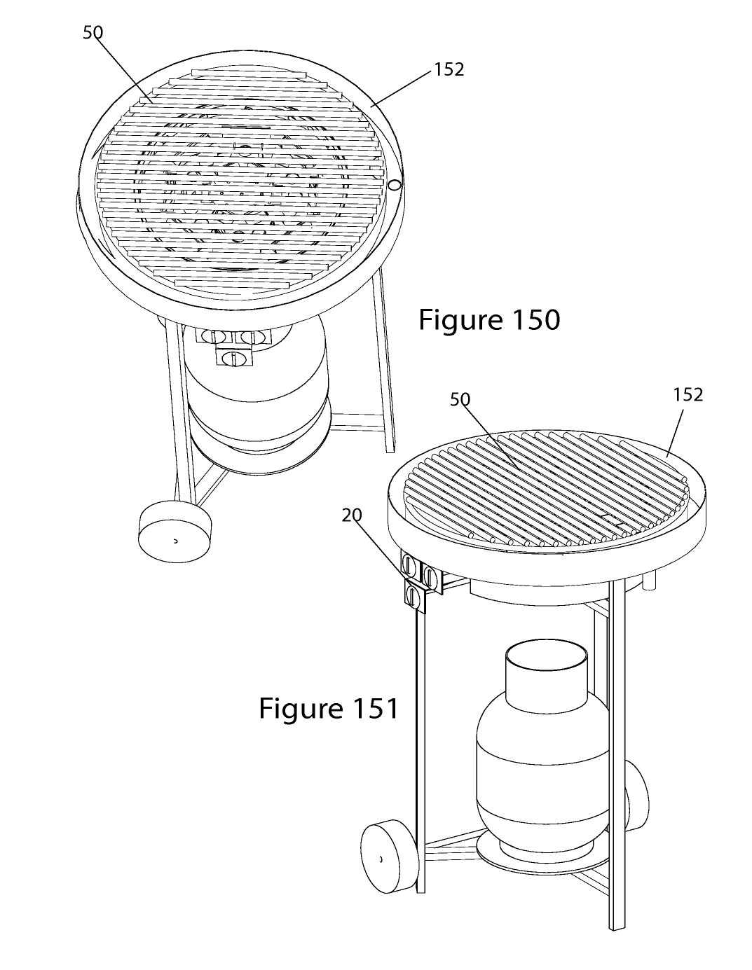

FIG. 150 is a perspective view showing an embodiment of the inventive outdoor cooking grill having a three-burner system and a circumferential drip tray. FIG. 151 is a perspective view of the embodiment of the inventive outdoor cooking grill showing the circumferential drip tray.

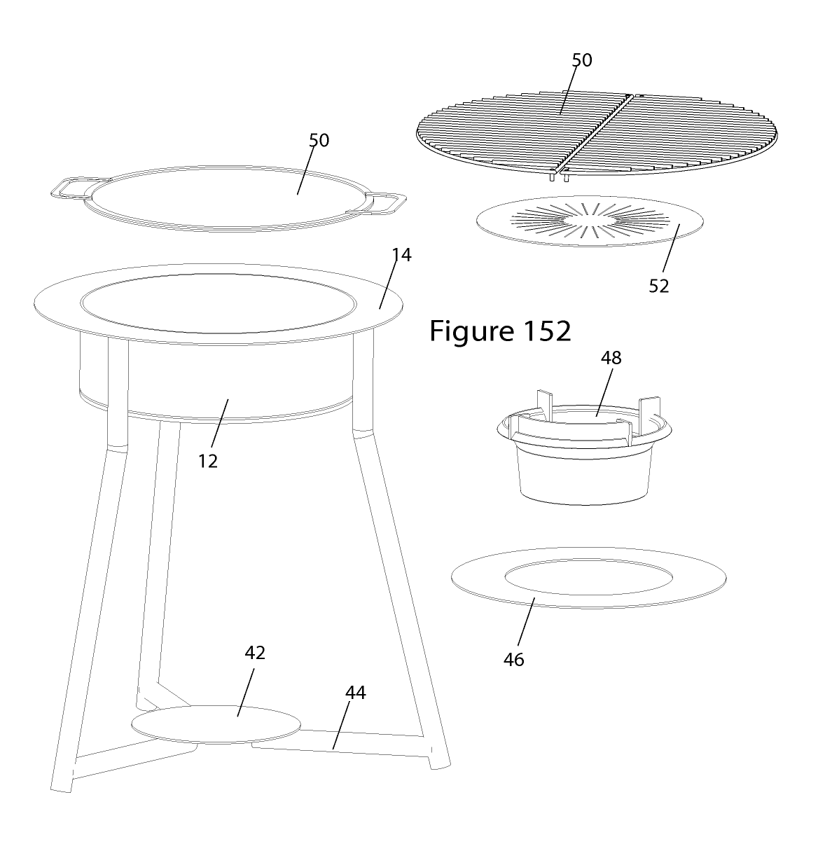

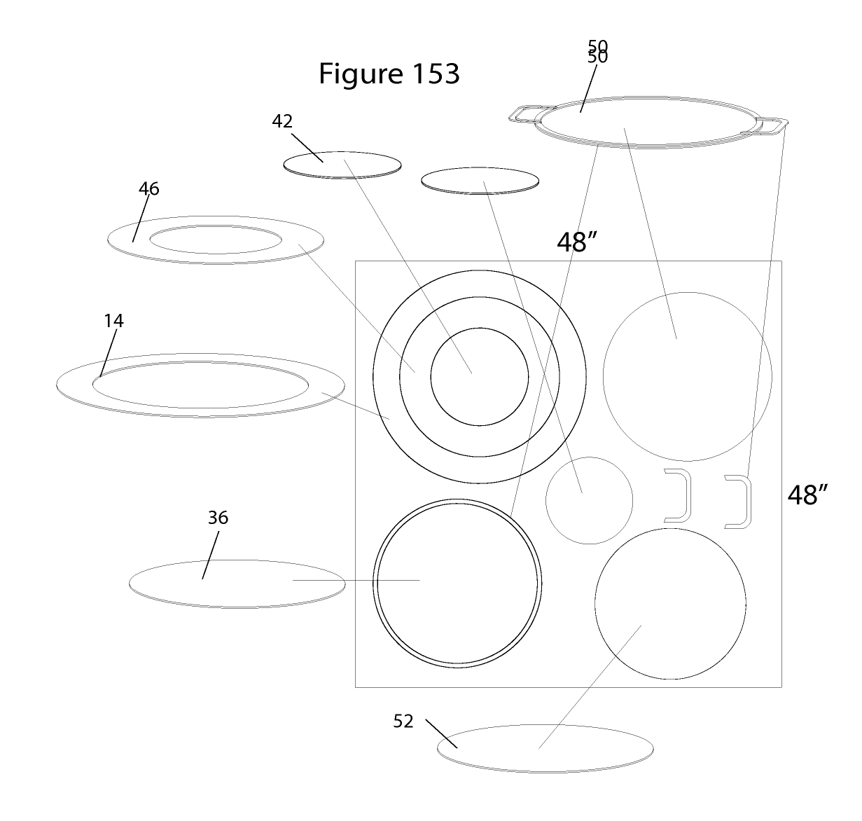

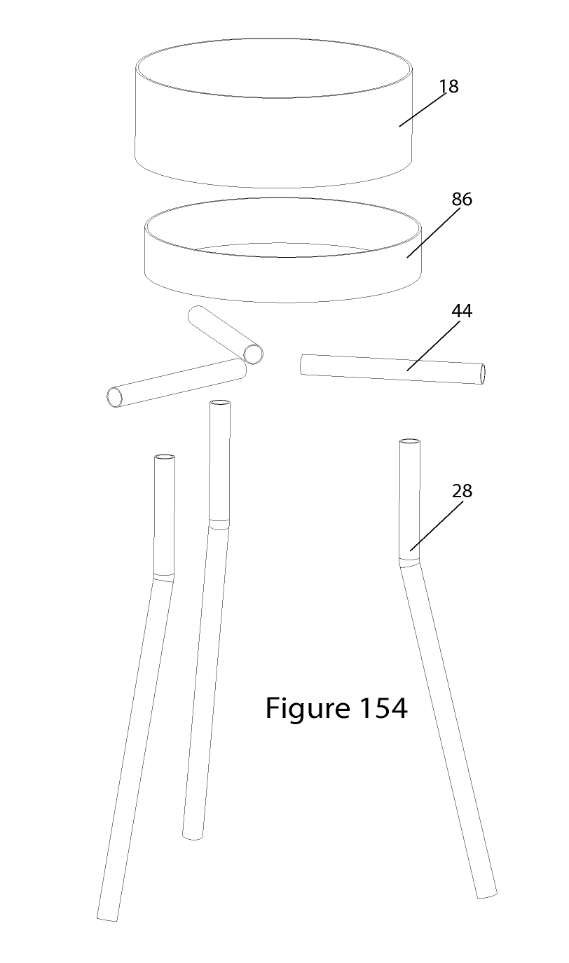

FIG. 152 is an exploded view of components of an embodiment of the inventive outdoor cooking grill showing tubular legs welded directly to the fire unit 12, a griddle accessory 46, a grill, a heat spreader/sear plate 52, a wok stand 48 and a wok ring accessory 46. FIG. 153 shows the layout for cutting various parts of the flat stock pieces that make up the embodiment of the inventive outdoor cooking grill. The inventive grill embodiments shown herein have flat and tube parts that can be fabricated using highly efficient CNC cutting of flat plate stock, using for example, plasma, torch or laser cutting. Many of these parts can also be fabricated using stamping and pressing operations. FIG. 154 is an exploded perspective view showing the various tubular and pipe section 18 or rolled parts that make up the embodiment of the inventive outdoor cooking grill.

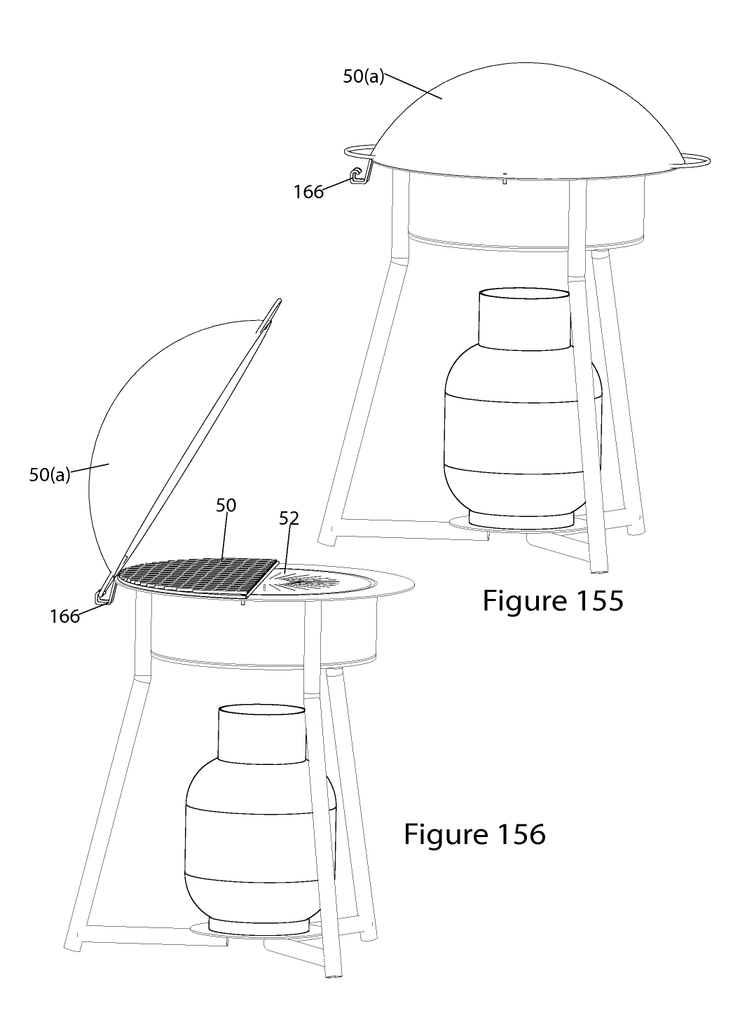

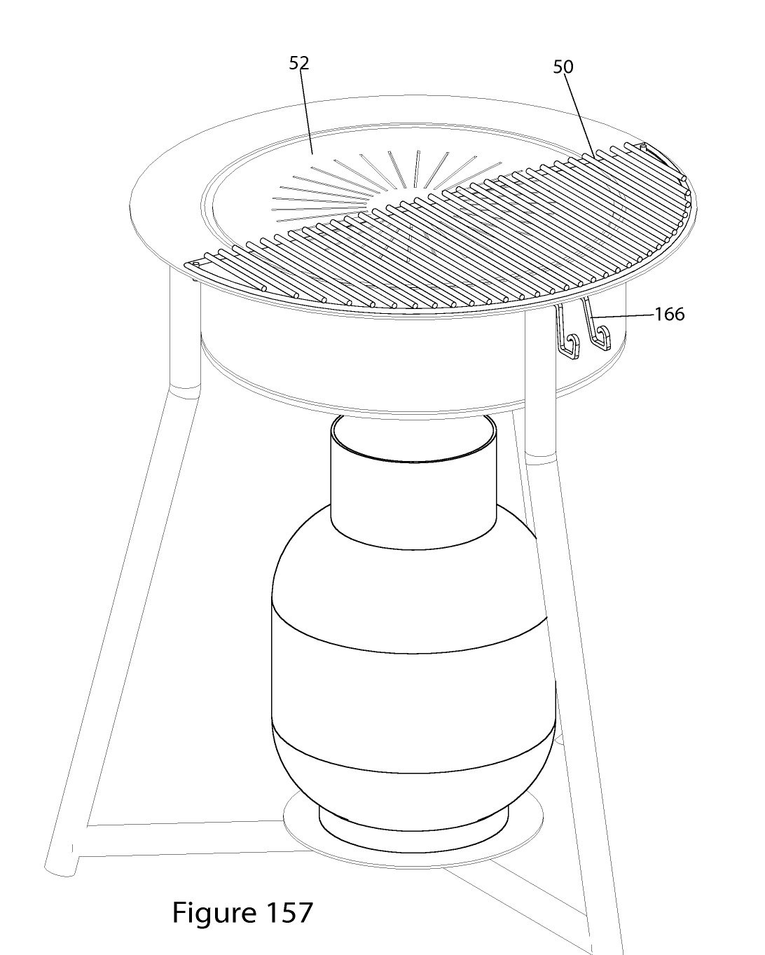

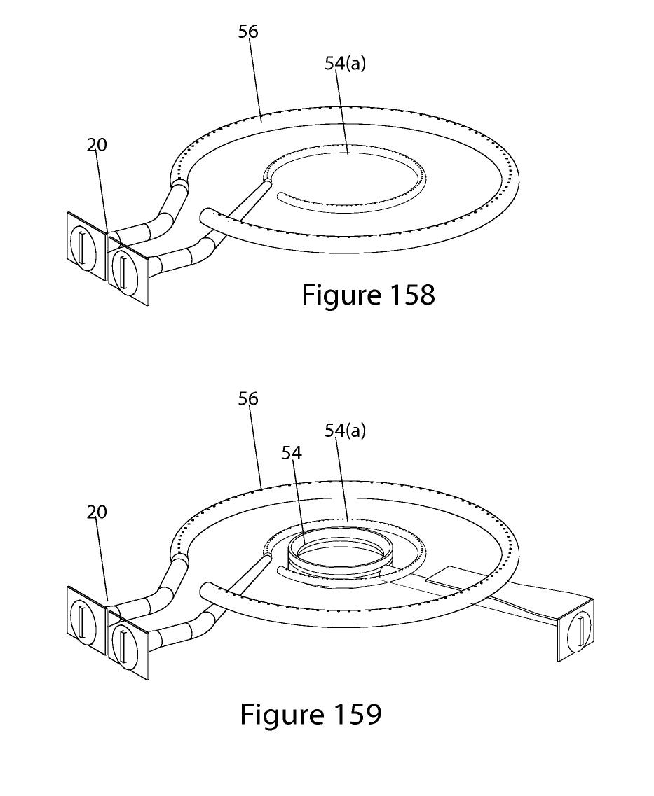

FIG. 155 is a perspective view of the inventive outdoor cooking grill showing a large wok used as a lid 50(a) to cover the grill. FIG. 156 is a perspective view of the inventive outdoor cooking grill showing the large wok held in a tipped up position by a wok lid brace 166. FIG. 157 is a perspective view of the embodiment of the inventive cooking grill showing a half grill covering half of the cooking surface 50 of an inventive heat spreader/sear plate 52. FIG. 158 is a perspective view of a two-ring burner showing an inner ring 54(a) and an outer ring 56. FIG. 159 is a perspective view of a three-burner system comprising a fast burner 54, an inner ring burner 54(a) and an outer ring burner 56.

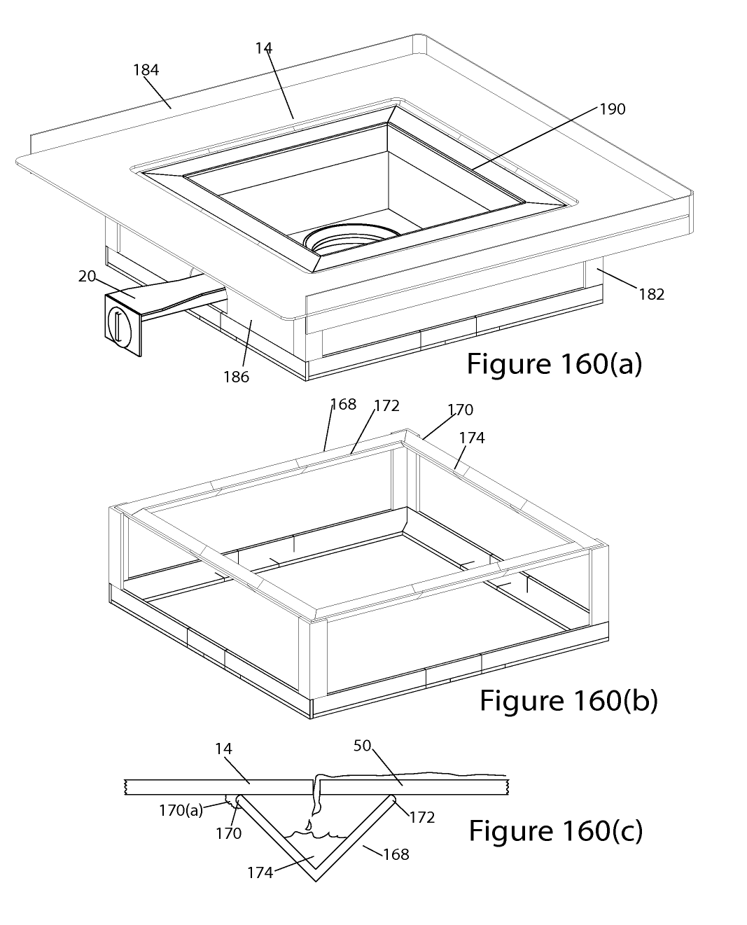

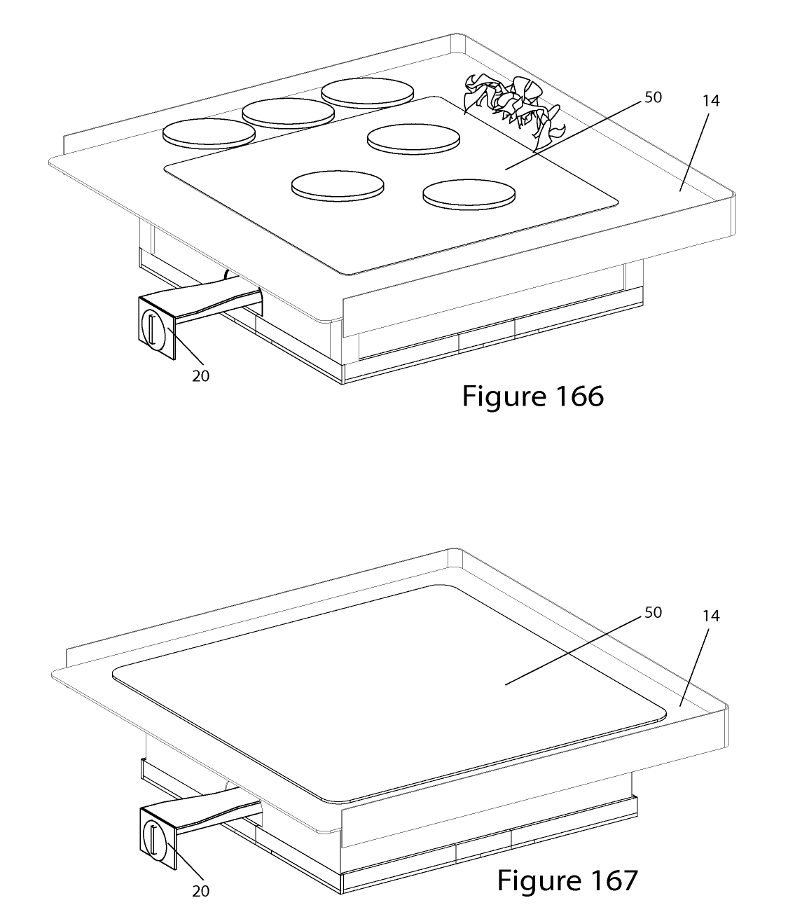

FIG. 160(a) is a perspective view of a single burner square grill embodiment of the inventive outdoor cooking grill. The inventive multi-configurable outdoor cooking grill includes an interchangeable cooking surface 50. A top 14 supports the interchangeable cooking surface 50. An accessory engagement structure 16 is associated with the top 14, the accessory engagement structure 16 comprising a drip catch channel 168. The top 14 is utilized in the cooking and/or in keeping warm foods cooked on the interchangeable cooking surface 50. The top 14 completely (as shown, for example in FIG. 162) or partially (not shown) encompasses the interchangeable cooking surface. When heat is applied to the interchangeable cooking surface 50 the top 14 achieves a relatively lower temperature than the interchangeable cooking surface 50 so that foods cooked on the interchangeable cooking surface 50 at a relatively higher temperature can be moved to the top 14 to be kept warm or continue cooking at the relatively lower temperature. For example, as shown in FIG. 166, hamburgers cooked on the griddle cooking surface 50 can be removed from the griddle cooking surface 50 and moved to the top 14 to complete carry-over cooking and to be kept warm for serving. The top 14 provides a convenient location for the hamburgers that are being cooked to be moved to so that hamburgers of different levels of doneness (e.g., rare, medium rare, medium, well) can all be served at once at a suitable serving temperature. Also, since the top achieves a relatively warm temperature, while the grill achieves a relatively hot cooking temperature, the top can be used to warm hamburger rolls, while keeping other food items, such as grilled onions, cooked on the grill warm so that an entire meal can be kept at the suitable serving temperature.

FIG. 160(b) is an isolated view of the frame of the single burner square grill embodiment of the inventive outdoor cooking grill. The drip catch channel has a top engagement surface 170 for engaging with the top 14 and accessory engagement structure 172 for removably supporting the interchangeably cooking surface 50. The drip catch channel 168 is configured and dimensioned so that a liquid spilling off from the interchangeable cooking surface 50 is received by the drip catch channel 168 and conveyed away from the interchangeable cooking surface 50. As described herein, a cooking accessory 46 is provided for removably engaging with the accessory engagement structure to change the cooking functionality of the cooking grill.

FIG. 160(c) is an isolated cross sectional view of the drip catch channel 168. In accordance with this aspect of the invention, the accessory engagement structure 16 is the drip catch channel 168 which acts both as a means to support the various accessories 46 and/or cooking surfaces 50, and as a means of conveniently removing liquids, such as water, oils, fats and drippings, that would otherwise either accumulate on the top 14 and the cooking surface 50, create a fire hazard and/or make a greasy mess. In accordance with an embodiment of the present invention, the drip catch channel 168 is constructed from angle iron. The drip catch channel is configured and dimensioned so that the top engagement structure 170 is engaged with the top 14. This top engagement structure 170 can be removably engaged so that the top 14 sits on the top engagement structure 170, and the top can be lifted away to facilitate cleaning. Alternatively, the top engagement structure 170 can be fixed to the top 14 using a suitable fastener, or more permanently by a weld 170(a). The cooking surface 50 or accessory 46 is removably supported by the accessory engagement structure 172 so that a seam or gap is provided between the cooking surface 50 (for example, the griddle) and the top 14. This seam or gap provides a thermal separation between the top 14 and the cooking surface 50 to facilitate keeping the top 14 at a suitably lower temperature so that food items (such as the hamburgers or grilled onions show in FIG. 166) can be kept warm while additional food items are cooked on the relatively higher temperature cooking surface 50. This seam or gap also allows liquids to flow off the cooking surface 50 and the top 14 and into the channel area 174.

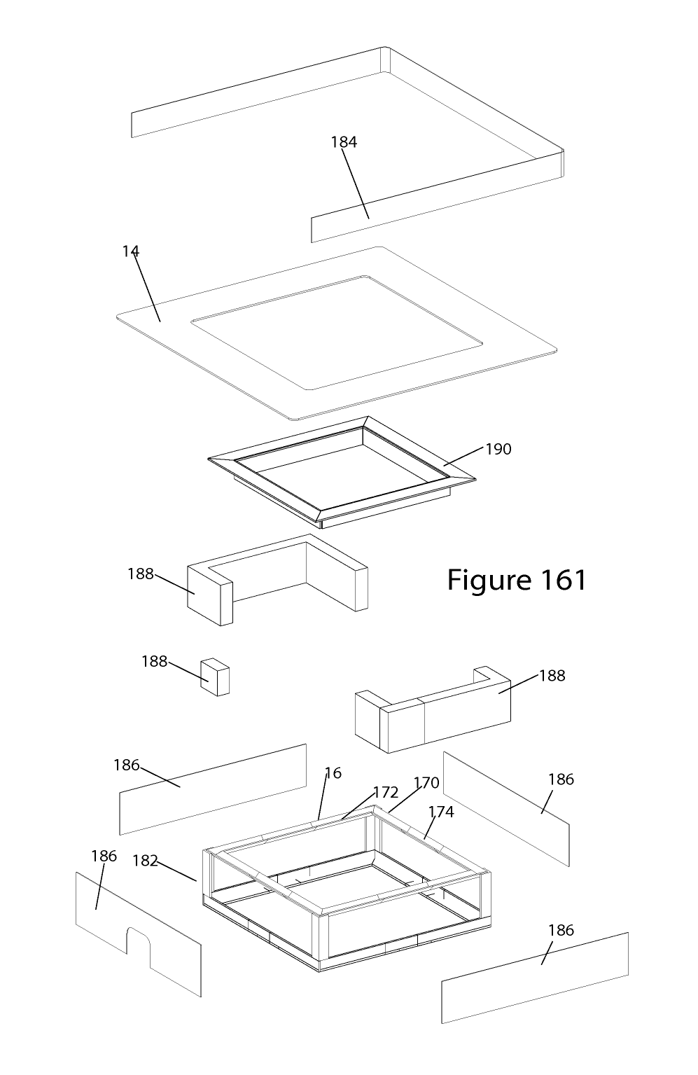

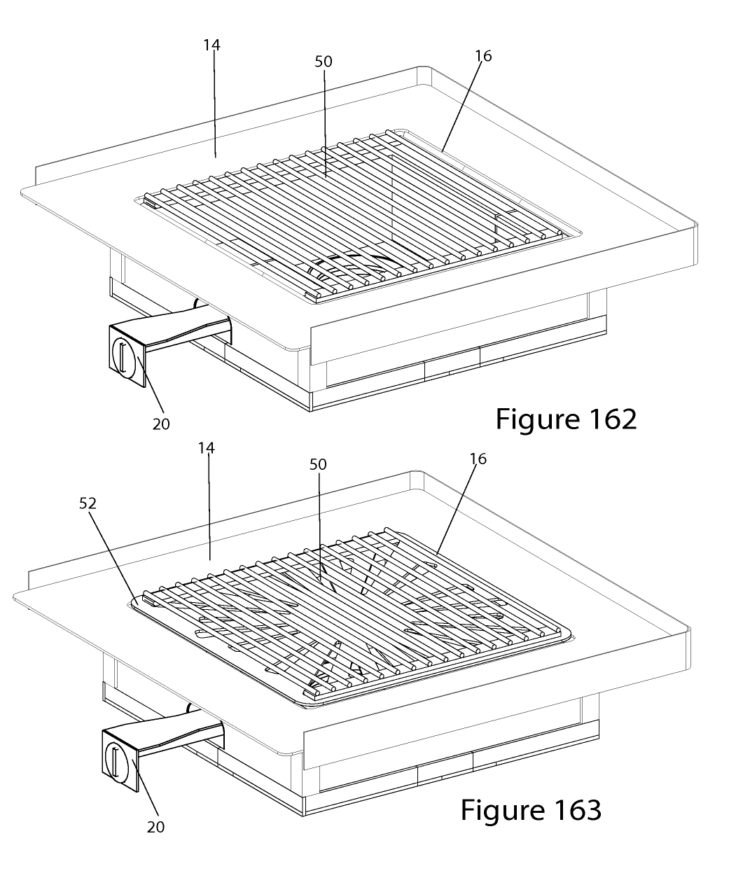

FIG. 161 is an exploded perspective view of the components that make up the single burner square grill embodiment. This embodiment, as with all the embodiments shown herein, illustrates some of the inventive aspects of the inventive multi-configurable outdoor cooking grill. These aspects can be included where appropriate in any of the embodiments shown. For example, the inventive drip catch channel 168 which is used as the accessory engagement structure 16 shown in FIG. 161 can be incorporated in the other embodiments described herein. In accordance with this aspect of the invention, the accessory engagement structure 16 comprises a drip catch channel 168 comprising a top engagement surface 170 for engaging with the top 14, an accessory engagement structure 172 for engaging with and supporting the accessory 46; and a drip catch channel area 174 defined by the top engagement surface 170 and the accessory engagement structure 172. When, for example, the cooking surface 50 is a griddle (as shown, for example, in FIGS. 166 and 167), any liquids that flow off the griddle or off the top 14 are received into the drip catch channel 168 and conveyed through the channel area 174 cleanly away from the cooking surface 50 and top 14.

A drip catch receptacle can be provided, such as the drip can shown in FIG. 1, and the drip catch channel 168 configured and dimensioned to receive liquids flowing from the cooking surface 50 or the top 14 so that the received fluids are drained away through the drip catch channel 168 and into the drip catch receptacle. The drip catch receptacle (not shown) can be provided within the stand frame 28 at one of the corners of the drip catch channel, and a hole in the corner provided so that the fluid drains from the channel, through the hole, and into the drip catch receptacle.

As shown in FIG. 161, in accordance with this embodiment of the inventive multi-configurable outdoor cooking grill, three sides of the top 14 can be bordered by a containment wall 182. The containment wall 182 keeps food and liquids from exiting the surface of the top 14. The containment wall 182 also may extend below the bottom surface of the top 14 to provide a heat deflector. The square frame 184 can be constructed from angle iron as shown, or can be constructed using metal flat stock or other suitable heat resistant materials, forming and assembly techniques. The square frame 184 may also integrally include the drip catch channel 168, which may also be formed using angle iron (as shown specifically in FIG. 160(c).

This construction of the multi-configurable cooking grill may also include windscreen panels 186 which fit into the square frame 184. The windscreen panels are configured and dimensioned to enable adequate airflow necessary for combustion of the flammable gas used by the burner assembly 20 for all of the configurations of the inventive outdoor cooking grill. The windscreen panels 186 and the containment wall 182 provide a means for enabling adequate air inflow necessary for the combustion of the flammable gas in all configurations of the inventive outdoor cooking grill, buffering the flame of the flammable gas from wind, while also defecting the heat generated by the burning flammable gas away from the grill user.

Firebricks 188 can be provided to enhance the thermal insulation of the heating of the cooking surface 50, while providing an additional preferred thermal pathway for the heat of the burning flammable gas to heat the cooking surface 50. The firebricks 188 can be held in place by a firebrick retaining structure 190 which may also be formed from welded angle iron.

FIG. 162 is a perspective view showing the single burner square grill embodiment configure for direct flame grilling. FIG. 163 is a perspective view showing the single burner square grill embodiment configured for heat spread/sear plate grilling. In this case, the cooking accessory 46 comprises a heat spreader/sear plate 52, and the interchangeable cooking surface 50 comprises a grill.

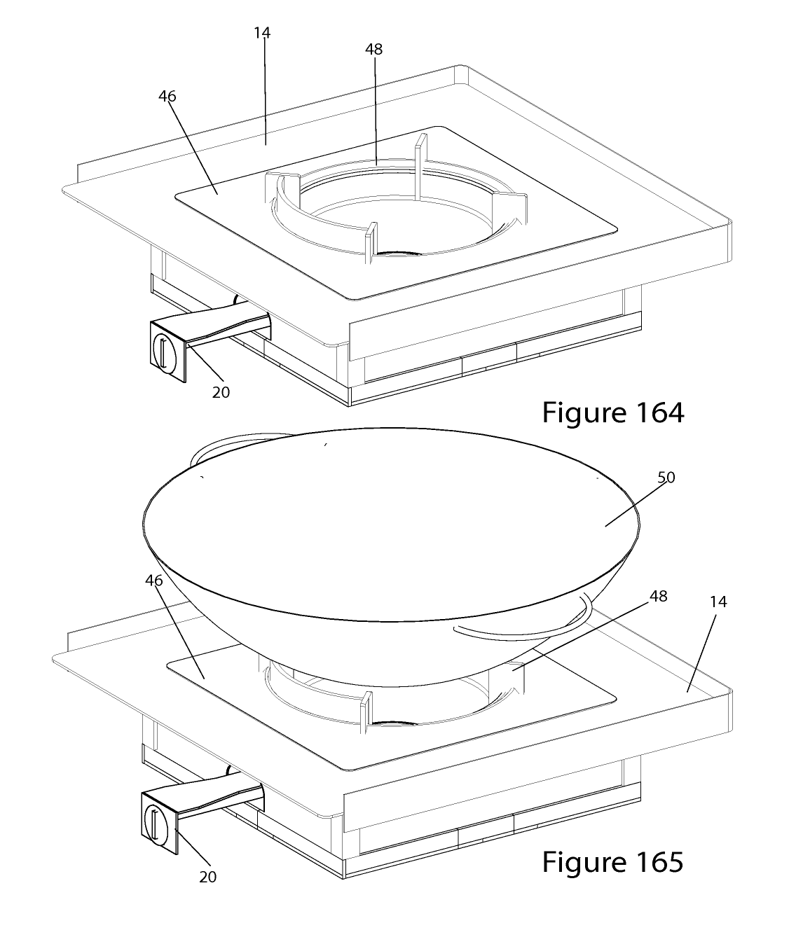

FIG. 164 is a perspective view showing the single burner square grill embodiment configured for wok cooking In this case, the cooking accessory 46 comprises a wok stand supporting plate configured and dimensioned for supporting a separate wok stand 48, and the interchangeable cooking surface 50 comprises a wok pan. FIG. 165 is a perspective view showing the single burner square grill embodiment configured for wok cooking and showing a large wok.

FIG. 166 is a perspective view showing the single burner square grill embodiment configured for griddle cooking In this case, the cooking accessory 46 comprises a griddle plate that can be removably engaged with the drip catch channel 168 for configuring the cooking grill as a griddle. The cooking accessory 46 can also comprise a heat spreader/sear plate 52 located beneath the griddle plate so that heat from the burner assembly 20 is more evenly distributed to the griddle plate. FIG. 167 is a perspective view showing the single burner square grill embodiment configured for griddle cooking using an enlarged griddle surface.

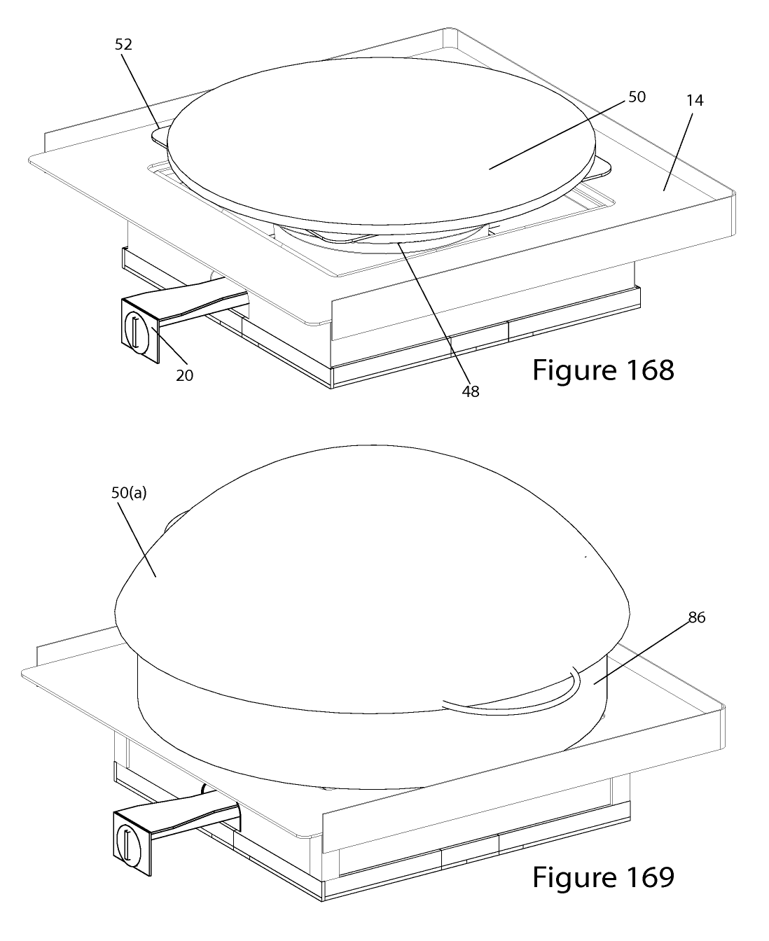

FIG. 168 is a perspective view of the single burner square grill embodiment configured with a wok stand 48, heat spreader/sear plate 52 and baking stone. In this case, the cooking accessory 46 comprises a riser ring 86, and the interchangeable cooking surface 50 comprises a baking stone.

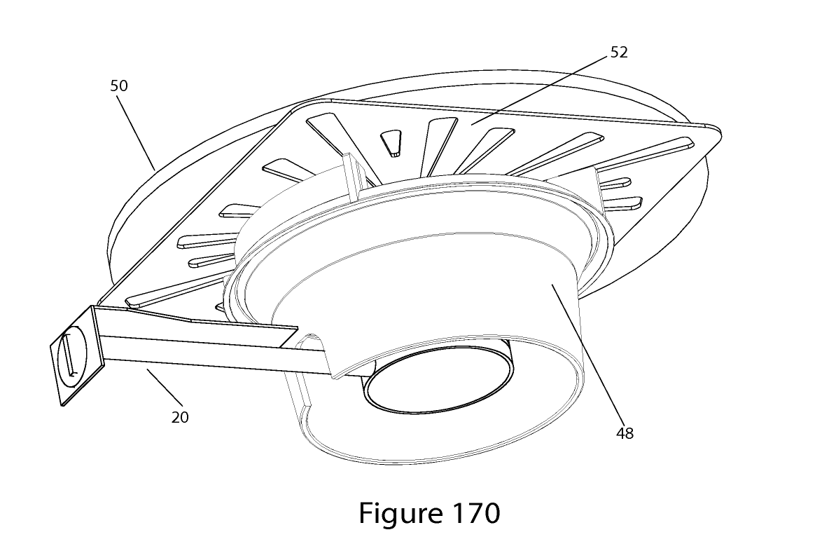

FIG. 169 is a perspective view of the single burner square grill embodiment configured with a riser ring 86 and wok as a lid 50(a) forming a cooking oven. The lid 50(a) is supported by the riser ring 86 to form a cooking oven enclosing the baking stone. FIG. 170 is a bottom isolated perspective view showing the components of a set up for configuring the inventive outdoor cooking grill as a baking oven.

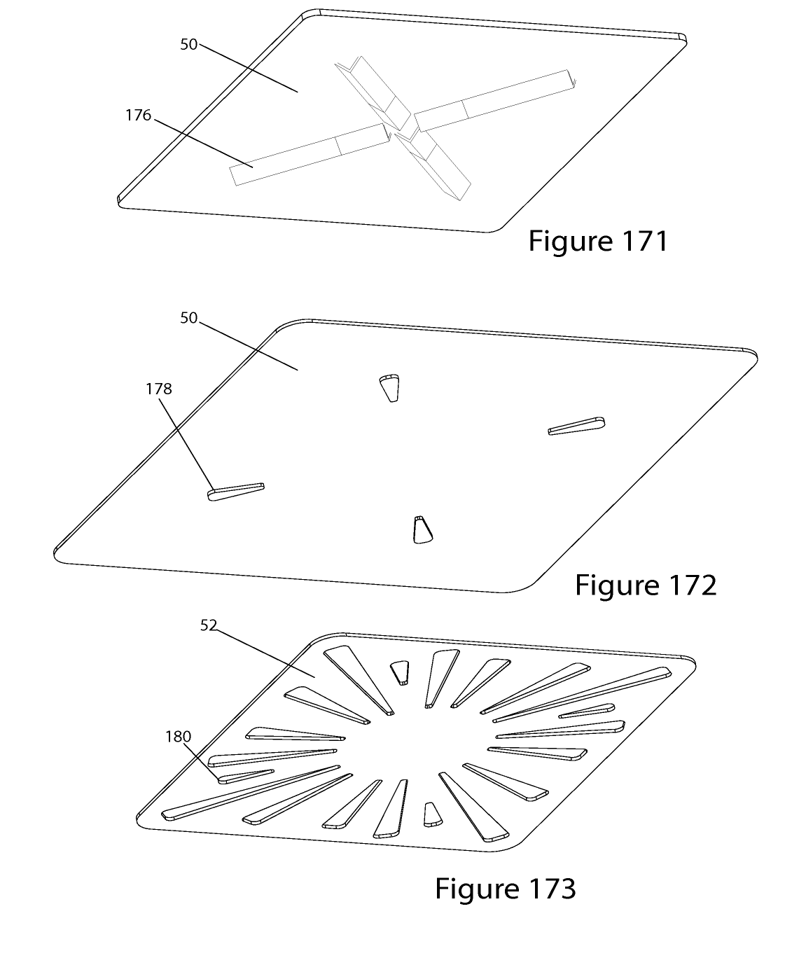

FIG. 171 is a bottom perspective view of a griddle accessory 46 showing anti-warping braces 176. These anti-warping braces 176 can be made, for example, by welding angle iron onto the griddle plate, allowing a more efficient use of material while also keeping the griddle flat even when subjected to high, concentrated heat.

FIG. 172 is a bottom perspective view of an enlarged griddle accessory 46 showing retaining structures 178. FIG. 173 is a perspective view of a heat spreader/sear plate 52 configured with engaging surfaces 180 for mating with the retaining structures 178 of the griddle accessory 46. In accordance with this aspect of the invention, the first accessory 46 includes an accessory retention structure (e.g., retaining structures 178), and the heat spreader/sear plate 52 includes an accessory retention mating structure (e.g., engaging surfaces 180). This retention system allows the cooking surface 50, for example, a grill or griddle, to be held in place by the action of the accessory engagement structure holding, for example, the heat spreader/sear plate 52, of the inventive multi-configurable outdoor cooking grill so that the cooking surface 50 does not move around when food is cooked on it or when pots or pans are placed on it.

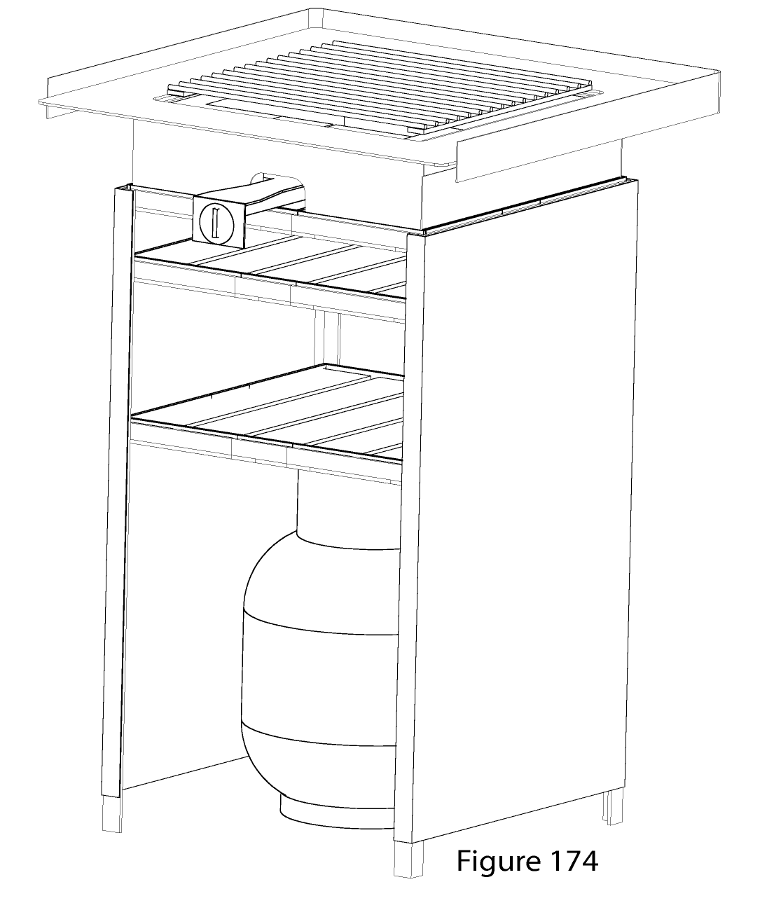

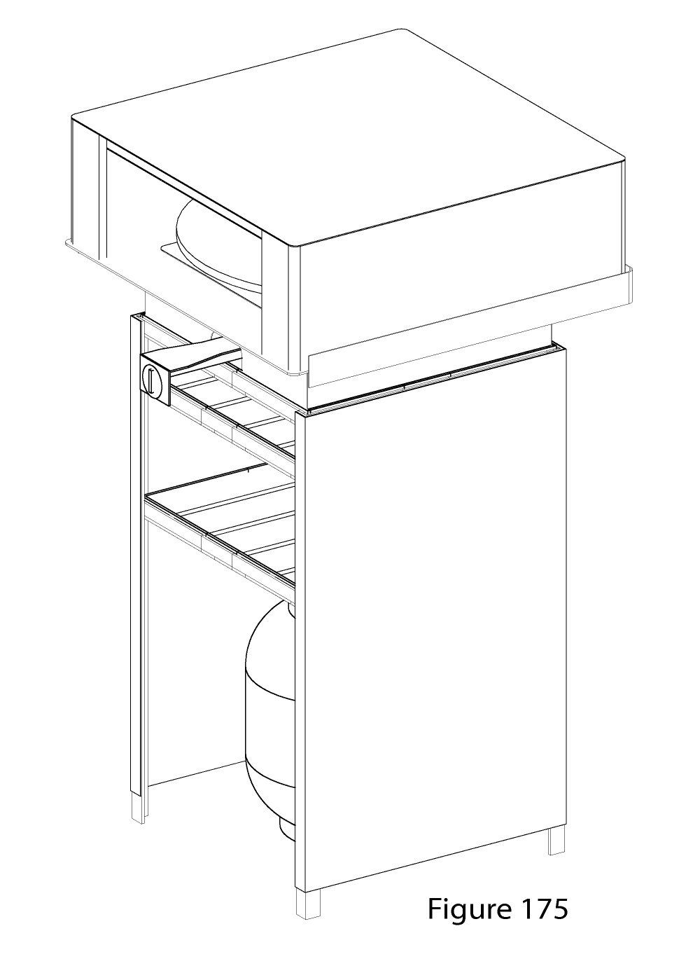

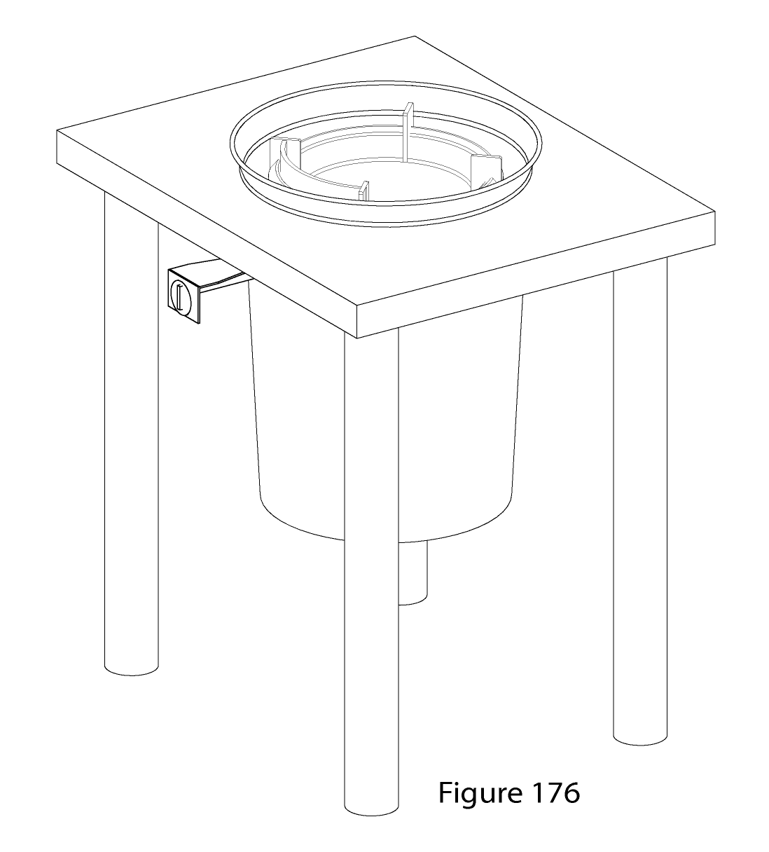

FIG. 174 is a perspective view showing the single burner square grill embodiment on an accessory 46 housing stand. FIG. 175 is a perspective view showing the single burner square grill embodiment on an accessory 46 housing stand, with a cooking oven closing the baking stone.

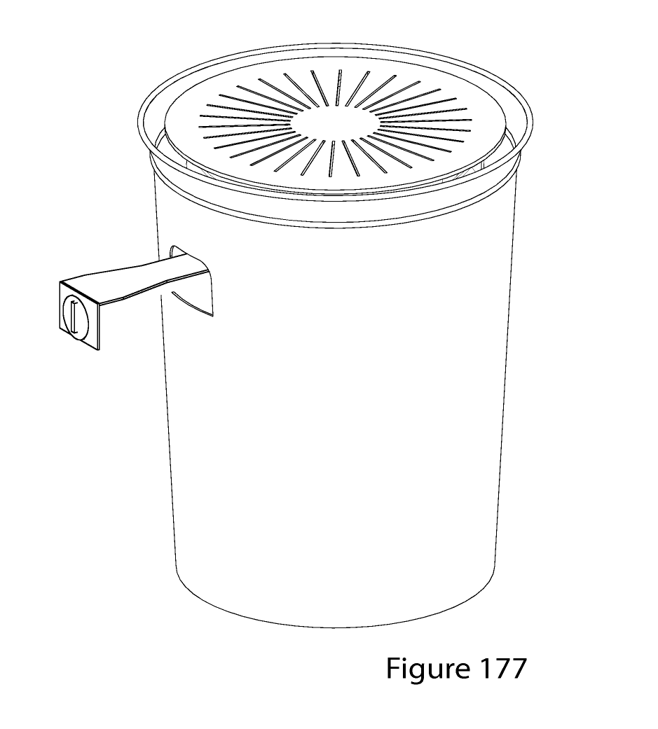

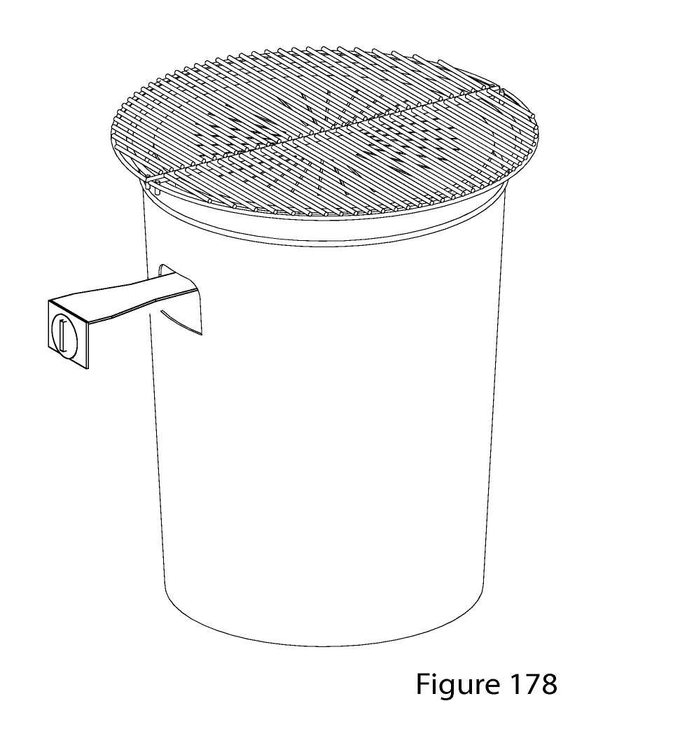

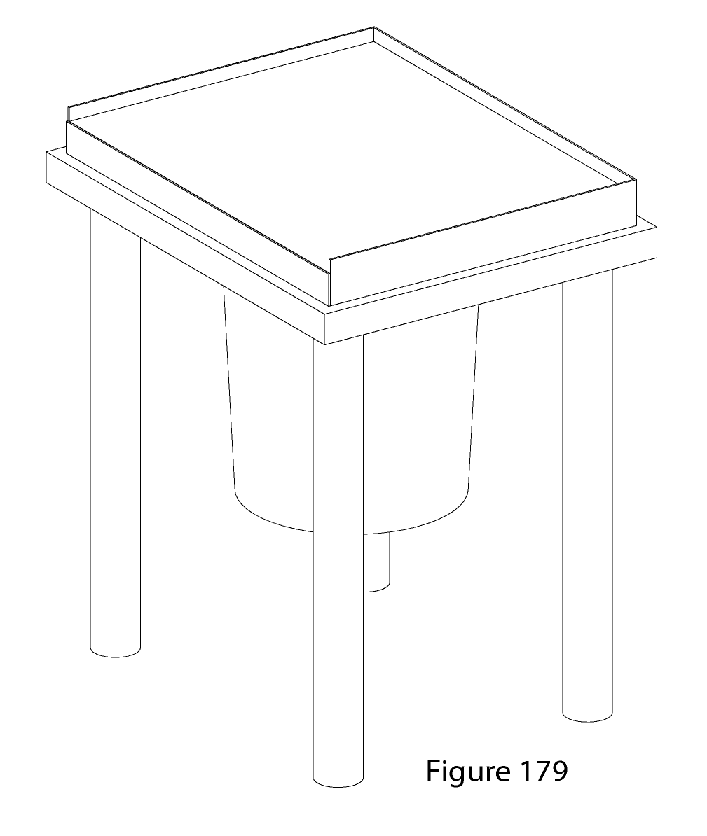

FIG. 176 is a perspective view of a single fast gas burner grill embodiment with a removable grill fire engine. FIG. 177 is an isolated view of the removable fire engine of the single fast gas burner grill embodiment. FIG. 178 is an isolated view of the removable fire engine with a split grill accessory 46. FIG. 179 is a perspective view showing the single fast gas burner grill embodiment configured for griddle cooking.

The various embodiments of the inventive multi-configurable outdoor cooking grill are capable of being configured for a wide range of cooking techniques. As a few examples, the cooking techniques and configurations can include Wok Cooking: Burner Assembly 20, Wok Ring Accessory 46, Wok Stand 48 and Wok Pan 50 (see, for example, FIG. 2); Dutch Oven: Burner Assembly 20, Wok Ring Accessory 46, Dutch Oven 50 (see, for example, FIGS. 4-5); Grill (even heat): Burner Assembly 20, Head Spreader/Sear Plate 52, Grill 50 (see, for example, FIGS. 12-13); Grill (smoking): Burner Assembly 20, Head Spreader/Sear Plate 52, Smoke Ring Insert 84, Grill 50, Lid 50(a) (see, for example, FIGS. 34-36); Grill (zoned heat): Burner Assembly 20, Grill 50; Flat Griddle (even heat): Burner Assembly 20, Head Spreader/Sear Plate 52, Flat Griddle 50; Flat Griddle (steamer): Burner Assembly 20, Head Spreader/Sear Plate 52, Flat Griddle 50, Wok as Lid 50(a); Flat Griddle (zoned heat): Burner Assembly 20, Flat Griddle 50; Sloped Griddle (even heat): Burner Assembly 20, Head Spreader/Sear Plate 52, Sloped Griddle 64; Sloped Griddle (zoned heat): Burner Assembly 20, Sloped Griddle 64; Sloped Griddle (steamer): Burner Assembly 20, Griddle 50, Wok as Lid 50(a); Sloped Griddle (raised steamer): Burner Assembly 20, Sloped Griddle 64, Grill 50, Wok as Lid 50(a); Retained Tall Pot/Turkey Fryer: Burner Assembly 20, Wok Ring Accessory, Head Spreader/Sear Plate 52, Tall Pot 50; and Retained Stock Pot/Lobster Pot: Burner Assembly 20, Head Spreader/Sear Plate 52, Wide Stock Pot 50.

The various elements making up each embodiment of the inventive multi-configurable outdoor cooking grill can be interchanged in a variety of iterations, not all of which are provided as specific embodiments or examples herein. For example, accessories, such as wok rings, heat spreader/sear plates, and riser rings, as well as cooking surfaces such as pots, pans, grills, smoke racks and others described in one embodiment may be employed, although not specifically described, in an alternative construction of another embodiment. Such iterations are specifically included within the scope of the inventions described herein.

With respect to the above description, it is realized that the optimum dimensional relationships for parts of the invention, including variations in size, materials, shape, form, function, and manner of operation, assembly and use, are deemed readily apparent and obvious to one skilled in the art. All equivalent relationships to those illustrated in the drawings and described in the specification are intended to be encompassed by the present invention.

Therefore, the foregoing is considered as illustrative only of the principles of the invention. Further, since numerous modifications and changes will readily occur to those skilled in the art, it is not desired to limit the invention to the exact construction and operation shown and described. Accordingly, all suitable modifications and equivalents may be resorted to, falling within the scope of the invention.

1-44. (canceled)

45. A cooking grill comprising: a burner assembly; an interchangeable cooking surface; a top defining a central cooking area and an outer cooking area; an accessory engagement structure associated with the top; and an accessory for engaging with the accessory engagement surface to configure the grill to change the cooking functionality of the cooking surface; wherein the burner assembly includes a separately controllable central burner for combusting a compressed flammable gas for selectively providing a relatively high BTU concentrated heat to the central cooking area, and a separately controllable outer burner for combusting the compressed flammable gas for selectively providing relatively low BTU distributed heat to the outer cooking area, and a heat containment structure for containing the heat energy from the central burner and the outer burner and directing the heat energy towards the cooking surface, the heat containment structure including an airflow ventilation system configured and dimensioned so that airflow needed for combusting the compressed flammable gas is effective for each cooking configuration of the cooking grill.

46. The cooking grill according to claim 45; wherein the airflow ventilation system includes controllable airflow restriction structures for controlling airflow depending on the cooking configuration

47. The cooking grill according to claim 45; wherein the cooking surface comprises a sloped griddle cooking implement, comprising an inner side portion including a central bowl area having a relatively steep sloped grade; and an outer side portion circumferentially encompassing the central bowl, the outer side portion including a sloped side area encompassing at least a portion of the central bowl area and having a relatively shallow slope grade effective to enable solid foods placed on the sloped side area to remain on the sloped side area during cooking and liquids in contact with the sloped side area to flow towards and into the central bowl area through the action of gravity.

48. The cooking grill according to claim 45; wherein the accessory engagement structure comprises a first accessory engaging structure for engaging with a first accessory and a second accessory engaging structure for engaging with a second accessory.

49. The cooking grill according to claim 48; wherein the first accessory comprises the cooking surface configured as one of a grill, a griddle and a baking stone, and the second accessory comprises a heat spreader/sear plate having vents configured and dimensioned to assist in spreading and evening out the heat from the burner unit reaching the interchangeable cooking surface.

50. The cooking grill according to claim 49; wherein the first accessory includes an accessory retention structure, and the heat spreader/sear plate includes an accessory retention mating structure.

51. The cooking grill according to claim 45; wherein the top, the accessory and the cooking surface are heated by the burner assembly.

52. The cooking grill according to claim 45; wherein the accessory comprises a heat spreader/sear plate having a searing surface configured and dimensioned to act as a sear plate for receiving food directly on the searing surface, the searing surface having searing elements for creating a predefined sear pattern on the food.

53. A multi-configurable cooking grill according to claim 45; wherein the accessory engagement structure comprises a drip catch channel comprising a top engagement surface for engaging with the top, an accessory engagement surface for engaging with and supporting the accessory; and a drip catch channel structure defined by the top engagement surface and the accessory engagement surface, the drip catch channel being configured and dimensioned so that a liquid coming from the interchangeable cooking surface is received in the drip catch channel and conveyed away from the interchangeable cooking surface.

54. A multi-configurable cooking grill according to claim 45; wherein the accessory comprises a heat spreader/sear plate in thermal communication with the first burner and the second burner for distributing the heat energy from the respective first and second burner into a predetermined pattern.

55. A cooking grill comprising: a burner assembly; an interchangeable cooking surface; a top for supporting the interchangeable cooking surface and defining an central cooking are and an outer cooking area; an accessory engagement structure associated with the top; and a cooking accessory for removably engaging with the accessory engagement surface to change the cooking functionality of the cooking grill; wherein the accessory engagement structure comprises a drip catch channel having a top engagement surface for engaging with the top and accessory engagement surface for removably supporting the interchangeable cooking surface, the drip catch channel being configured and dimensioned so that a liquid coming off from the interchangeable cooking surface is received in the drip catch channel and conveyed away from the interchangeable cooking surface.

56. A cooking grill according to claim 55; wherein the top encompasses the interchangeable cooking surface, and when heat is applied to the interchangeable cooking surface the top achieves a relatively lower temperature than the interchangeable cooking surface so that foods cooked on the interchangeable cooking surface at a relatively higher temperature can be moved to the top to be kept warm or continue cooking at the relatively lower temperature.

57. A cooking grill according to claim 55; wherein the burner assembly includes a separately controllable central burner for combusting a compressed flammable gas for selectively providing a relatively high BTU concentrated heat to the central cooking area, and a separately controllable outer burner for combusting the compressed flammable gas for selectively providing relatively low BTU distributed heat to the outer cooking area, and a heat containment structure for containing the heat energy from the first and the second burner and directing the heat energy towards the cooking surface, the heat containment structure including an airflow ventilation system configured and dimensioned so that airflow needed for combusting the compressed flammable gas is effective for each cooking configuration of the cooking grill.

58. A cooking grill according to claim 55; wherein the burner assembly includes a first burner and a second burner; and further comprising a heat spreader locatable between interchangeable cooking surface and the burner assembly for distributing the heat energy from the respective first and second burner to the interchangeable cooking surface in a predetermined pattern.

59. A cooking grill comprising: a burner assembly; an interchangeable cooking surface; a top defining a central cooking area and an outer cooking area; an accessory engagement structure associated with the top; and an accessory for engaging with the accessory engagement surface to configure the grill to change the cooking functionality of the cooking surface; wherein the burner assembly includes a separately controllable central burner for combusting a compressed flammable gas for selectively providing a relatively high BTU concentrated heat to the central cooking area, and a separately controllable outer burner for combusting the compressed flammable gas for selectively providing relatively low BTU distributed heat to the outer cooking area.

60. The cooking grill according to claim 59; wherein, the cooking surface comprises a sloped griddle cooking implement, comprising an inner side portion including a central bowl area having a relatively steep sloped grade; and an outer side portion circumferentially encompassing the central bowl, the outer side portion including a sloped side area encompassing at least a portion of the central bowl area and having a relatively shallow slope grade effective to enable solid foods placed on the sloped side area to remain on the sloped side area during cooking and liquids in contact with the sloped side area to flow towards and into the central bowl area through the action of gravity.

61. The cooking grill according to claim 59; wherein the burner assembly includes heat containment structure for containing the heat energy from the first and the second burner and directing the heat energy towards the cooking surface, the heat containment structure including an airflow ventilation system configured and dimensioned so that airflow needed for combusting the compressed flammable gas is effective for each cooking configuration of the cooking grill.

62. The cooking grill according to claim 61; wherein the airflow ventilation system includes controllable airflow restriction structures for controlling the airflow depending on the cooking configuration to improve the effectiveness of the combusting of the compressed flammable gas.

63. The cooking grill according to claim 59; wherein the burner assembly further includes a separately controllable inner burner disposed adjacent to the central burner for combusting a compressed flammable gas for selectively providing a relatively lower BTU to the central cooking area.

64. The cooking grill according to claim 59; wherein the cooking accessory comprises a riser ring supported by the top and forming a wall structure for containing heat generated by the burner assembly; and further comprising lid removably supported by the riser ring to define along with the riser ring cooking oven.
